(19) United States
(12) Patent Application Publication
(10) Pub. No.: US 2024/0270496 A1
(43) Pub. Date: Aug. 15, 2024

(54) METHOD AND SYSTEM FOR TRANSPORTING AND ORGANISING GOODS

(71) Applicant: Eiratech Robotics Ltd, Dublin 8 (IE)

(72) Inventors: Raymond Lloyd, Blanchardstown 15 Dublin (IE); Neal Farrell, Blanchardstown 15 Dublin (IE); Steven Carthy, Blanchardstown 15 Dublin (IE); Daraigh Eglington, Blanchardstown 15 Dublin (IE); Alexey Tabolkin, Blanchardstown 15 Dublin (IE); Stephen Killian, Blanchardstown 15 Dublin (IE)

(21) Appl. No.: 18/293,332

(22) PCT Filed: Jul. 29, 2022
(86) PCT No.: PCT/EP2022/071414

§ 371 Date: Jan. 29, 2024

(30) Foreign Application Priority Data
Jul. 29, 2021 (GB) 2110963.2

(51) Int. Cl. B65G 1/137; B65G 1/04

(52) U.S. Cl. CPC B65G 1/1373; B65G 1/0485

(57) ABSTRACT

A system for receiving and sorting items comprises: an input module; an identification module; a main support unit; an automated apparatus; and a control module. The input module comprises at least one input location arranged to receive a mobile support unit (for example a trolley) supporting a plurality of items (for example totes containing groceries). The identification module is operable to determine identification data from each item supported by a mobile support unit received by the input module. The main support unit comprises a plurality of storage positions, each of the plurality of storage positions being suitable for supporting an item. The automated apparatus is operable to move an item supported by a mobile support unit received by the input module to one of the plurality of storage positions of the main support unit. The control module is configured to receive the identification data from the identification module for a plurality of mobile support units received by the input module and to control the automated apparatus to move a plurality of items from each of the plurality of mobile support units received by the input module each to one of the plurality of storage positions of the main support unit. The control module is configured such that the storage position of each item is selected in dependence on the identification data determined from that item.

The present application relates to a system and associated method for receiving and sorting items. In particular, the present application relates to automated systems and associated methods. Such automated systems may comprise robotic systems. The system may have particular application in an online grocery shopping system.

Online shopping allows customers to order goods, which are collected, or picked, from a storage location and then sent to the customer. Where such orders include a number of different goods, such as an order of food shopping, an operator may need to collect goods from a range of different locations in order to obtain the various goods required to fulfil the order. Collecting goods from a range of different locations may be time consuming in that it takes time for the operator to travel to the different locations (such as different locations within a large warehouse, or shop floor).

In known arrangements, in order to improve the efficiency of the picking process orders are divided such that an operator collects, or picks, goods from a number of customer orders where the goods are located in relatively close proximity to one another. For example, an operator may pick all of the toiletries required to fulfil orders for several different customers. This process may be repeated, by the same operator or by a different operator, for the various different types of goods belonging to a range of different orders. The goods may be collected in totes, which may otherwise be referred to as crates.

When the various types of goods for a particular order have been collected, all of the totes for each customer are sent to that customer. For example, the totes may be placed in a van and driven to the customer. Alternatively, the totes may be placed in a designated location for collection by the customer.

It may be desirable to provide a novel system and associated method for use in an online shopping system that overcomes one or more disadvantages associated with existing systems, whether identified herein or otherwise.

According to a first aspect of the disclosure there is provided a system for receiving and sorting items, the system comprising: an input module comprising at least one input location arranged to receive a mobile support unit supporting a plurality of items; an identification module operable to determine identification data from each item supported by a mobile support unit received by the input module; a main support unit comprising a plurality of storage positions, each of the plurality of storage positions being suitable for supporting an item; automated apparatus operable to move an item supported by a mobile support unit received by the input module to one of the plurality of storage positions of the main support unit; and a control module configured to receive the identification data from the identification module for a plurality of mobile support units received by the input module and to control the automated apparatus to move a plurality of items from each of the plurality of mobile support units received by the input module each to one of the plurality of storage positions of the main support unit; wherein the control module is configured such that the storage position of each item is selected in dependence on the identification data determined from that item.

The system according to the first aspect is advantageous, as now discussed. The provision of the automated apparatus provides an arrangement for moving items received at the input module to the main support unit under the control of the control system. Since the storage position of each item is selected in dependence on the identification data determined from that item, advantageously, the items can be sorted according to the identification data. For example, it may be desirable to group items in a plurality of different groups (each group may, for example, relate to a different customer and/or a different delivery van). For this purpose, the identification data may include a group identifier and the storage position of each item may be selected in dependence on the group identifier for that item. Items with the same group identifier may, for example, be placed in one or more groups or clusters of adjacent storage positions in the main support unit.

This sorting and/or grouping of items is in contrast to known automated storage and retrieval systems (ASRS) wherein each item may be stored in any suitable vacant storage position for later individual retrieval. In contrast, the system according to the first aspect of the disclosure allows for items to be grouped together such that all items in a given group can be retrieved easily in a group (for example to be loaded onto the same delivery van).

The system may have application in an online grocery shopping system. For example, the items may comprise totes or tote boxes. The mobile support units that can be received by the input module may each comprise a trolley for supporting totes. These may be used by a user to manually select products from shelves. Once all of the products for each tote has been selected, the trolley can be wheeled into an input location of the input module. In general, the totes on each trolley may comprise totes for a plurality of different customer orders all containing goods that are located in relatively close proximity to one another. An order for a single customer may be distributed over a plurality of such trolleys (as this may improve the efficiency of the picking process). The system according to the first aspect of the present disclosure may receive a plurality of different trolleys, unload the totes from them and place them onto the main support unit such that they are now grouped in a way that is optimized for delivering the totes to their corresponding customers. For example, the totes may be placed onto the main support unit such that they are now grouped according to which delivery van will be used to transport them to the relevant customer.

Alternatively, the totes may each be placed onto the main support unit in a designated location for collection by a specific customer or for transfer by an operator to a customer collection area.

In general, any of the components of the system described below may comprise a transmitter and a receiver to allow it to exchange signals with the control module.

The control module may be configured such that the storage position of each item is selected such that the items are sorted or grouped according to the identification data in dependence on the identification data determined from that item.

The plurality of storage positions may comprise a plurality of different subsets of storage positions and the control module may be configured such that the subset of storage positions from which the storage position of each item is selected is selected in dependence on the identification data determined for that item.

For example, each subset of storage positions may comprise a block of adjacent storage positions. Each item may be placed by the system in a specific subset or block of storage positions based on the identification data determined for that item.

In some embodiments, the identification data includes a group identifier and at least one subgroup identifier. In one particular embodiment, each subset of positions is for support of a plurality of items that may be transferred from the main storage unit to a delivery van together (for example using a multi-tote picker, as discussed further below). To facilitate this, all of these items may be placed in a subset or block of adjacent, accessible storage positions (for example a two-dimensional block of storage positions at an outlet or pick-face of the main storage unit) by the control module. The control module may be operable to move items through a plurality of subsets or blocks of adjacent storage positions in sequence. In general, the sequencing may be performed so that the number of delivery vans that can be simultaneously loaded with items from the main storage unit is maximized for a given depth of the main storage unit.

The identification data may include at least one group identifier and the control module may be configured such that the storage position of each item is selected in dependence on the group identifier determined from that item.

The group identifier may, for example, indicate a delivery van associated with that item. Additionally or alternatively, the group identifier may, for example, indicate a customer associated with that item.

For example, the control module may be configured such that a subset of storage positions from which the storage position of each item is selected may be selected in dependence on the group identifier (for example a delivery van identifier) determined for that item.

The identification data may include at least one subgroup identifier and the control module may be configured such that the storage position of each item is selected in dependence on the subgroup identifier determined from that item.

The subgroup identifier may, for example, indicate a target position in a delivery van associated with that item.

For example, the control module may be configured such that a position within a selected subset of storage positions for each item may be selected in dependence on the subgroup identifier (for example a target position in a delivery van associated with that item) determined for that item.

In some embodiments, the identification data includes a group identifier and at least one subgroup identifier. In one particular embodiment, each subgroup comprises a plurality of items that may be transferred from the main storage unit to a delivery van together (for example using a multi-tote picker, as discussed further below). To facilitate this, all of the items in a subgroup may be placed in a block of adjacent, accessible storage positions (for example a two-dimensional block of storage positions at a pick-face of the main storage unit) by the control module. The control module may be operable to move each subgroup of items through a plurality of subsets or blocks of adjacent storage positions in sequence. In general, the sequencing may be performed so that the number of delivery vans that can be simultaneously loaded with items from the main storage unit is maximized for a given depth of the main storage unit.

The system may comprise at least two levels. The input module may be provided on a first level and the automated apparatus may be operable to move an item supported by a mobile support unit received by the input module to one of the plurality of storage positions of the main support unit via a second level.

Such a system allows the bulk of the transportation between the input module and the main support unit to be performed on the second level (where it will not interfere with the shop floor etc.). Advantageously, this allows the input module to be integrated with a shop floor. The main support unit may also be provided on the first level.

In some embodiments, the main storage unit may be a one-way storage unit.

Each of the plurality of storage positions may be provided with an inlet and a separate outlet and the automated apparatus may be operable to move an item to one of the plurality of storage positions of the main support unit via said inlet.

The outlets may be accessible by an operator or a robot such that items can be removed from the storage positions via the outlets by such an operator or a robot. For example, the main storage unit may comprise racks. The automated apparatus may be operable to insert items into the racks from one side. The items may subsequently be accessed by an operator or robot from an opposite side of the racks. The outlet side of the racks may be referred to as a “pick face”.

At least a subset of storage positions may comprise a common inlet and a common outlet. Such an arrangement is advantageous as it provides additional storage positions (that are not adjacent a common outlet) that provide a buffer for storage of items.

The system may be operable to move items into the common inlet, through the subset of storage positions to the common outlet for retrieval by an operator. The subset of storage positions may be arranged in a line and may be referred to as a line or row of storage positions.

For example, the main storage unit may comprise racks having a depth suitable for accommodating a plurality items. A first item may be inserted (by the automated apparatus) into a common inlet of the racks to a first storage position of a subset of storage positions. Subsequently, a second item may be inserted (by the automated apparatus) into the same common inlet of the racks to the same first storage position of the subset of storage positions. The automated apparatus may continue to insert items into the common inlet until an item is disposed at all of the storage positions of this subset of storage positions.

Once an item is disposed in the storage positions of this subset of storage positions that is closest to the common outlet, this item may be accessed by an operator from the “pick face”.

In some embodiments, the racks may be arranged such that support shelves or rails for the items are, in use, generally horizontal. With such an arrangement, when a second item is inserted (by the automated apparatus) into the same common inlet of the racks as a previously inserted first item, the second item may push the first item into the next storage position between the common inlet and the common outlet.

Alternatively, in some embodiments, the racks may be arranged so as to be gravity-fed.

That is, the support shelves or rails for the items may be inclined such that an item inserted into a common inlet falls or slides under the action of gravity to the common outlet.

In use, the or each inlet may be disposed at a higher position than the or each associated outlet and the or each outlet may be provided with a latch mechanism, the latch mechanism arrangeable in a closed configuration in which an item disposed adjacent the outlet is prevented from passing through the outlet; and an open position in which an item disposed adjacent the outlet is allowed to pass through the outlet.

For example, the main storage unit may comprise a racking system that is generally of the form of a first in, first out (FIFO) racking system. Advantageously, this allows items to be accessed from the outlet (or common outlets) without having to wait until all of the storage positions between the inlet and the outlet are occupied by items.

For embodiments wherein system comprises at least two levels the main support unit may be disposed at the first level.

The identification module may comprise at least one identification submodule, the or each submodule comprising: an imaging system operable to form an image of a visual marker on an item supported at an identification location; and a processor operable to determine the identification data from said image.

For example, the imaging system may comprise a camera operable to from an image of a marker on the item. The processor may be operable to execute suitable recognition software to identify a code from the image. Alternatively, any suitable form of identification module may be used, using, for example, bar codes, QR codes or the like.

One or more such identification submodules may be provided at the or each input location and may be operable to determine the identification data for each item supported by a mobile support unit at that input location.

The input module may comprise a plurality of input locations, each of the plurality of input locations being arranged to receive a mobile support unit supporting a plurality of items.

Each of the plurality of input locations may comprise an identification sub-module operable to determine identification data from each item supported by a mobile support unit received in that input location. Alternatively, in some other embodiments, the items may be moved to an identification data retrieval location. The identification module may be operable to determine identification data from each item supported by a mobile support unit disposed at the identification data retrieval location.

The provision of an input module comprising a plurality of input locations advantageously provides a buffer for the input of mobile support units. For example, two or more mobile support units can be provided to the input module at substantially the same time and the automated apparatus can move items from each of these mobile support units in parallel. This avoids having to wait for a first one of the mobile support units to be unloaded before a second mobile support unit can be received by the input module.

The or each input location may comprise an indicator operable to display a status of the input location.

For example, this may be a visual indicator and may comprise a red light (indicating that the input location is unavailable) and a green light (indicating that the input location is available). Alternatively, the indicator may comprise a display screen or the like operable to display information indicating whether or not that the input location is unavailable.

The or each input location may comprise an access door movable between: an open position in which a mobile support unit supporting a plurality of items can be inserted into or removed from the input location; and a closed position in which access to the input location is restricted.

A nominal or default position of door may be the closed position. The door may be moved (under control of the control module) to an open position to allow mobile support unit supporting a plurality of items to be placed into the input location. Once a mobile support unit supporting a plurality of items has been placed into the input location, the door may be moved (under control of the control module) to a closed position, preventing an operator from accessing the mobile support unit. Advantageously, such an access door provides a safety feature since it can prevent operators from being harmed by the operation of the automated apparatus.

Alternatively, in some embodiments, the or each input location and the mobile support unit may be arranged such that when the mobile support unit is disposed in the input location, the input location is inaccessible by a user. For example, the mobile support unit may comprise a barrier that may form a close fit with an aperture of the input location so as to close access to the input location. For such embodiments, the or each input location may comprise an engagement mechanism that may be operable (for example under the control of the control module) to releasably engage a mobile support unit when disposed in the input location so as to releasably lock it in position.

The access door may further comprise a user controllable actuator mechanism operable, in response to an input from a user, to move the door from the closed position to the open position.

For example, the user controllable actuator mechanism may comprise a lock, for example a remote keyless lock, and the input from the user may be sent using a keyfob or access ID card of the like. Alternatively, the user controllable actuator mechanism a keypad and the input from the user may be provided by inputting an access code.

The or each input location may comprise an alignment structure arranged to aid the placement of a mobile support unit in an alignment position.

The or each input location may comprise a guide structure arranged to help guide a mobile support unit to an alignment position.

The or each input location may comprise two side structures which define between them a volume for receipt of a mobile support unit.

The side structures may be shaped such that a volume defined between them is smaller in a central region than at each end of the input location. Advantageously, the central region may constrain the mobile support unit in an alignment position while the other regions help the insertion of the mobile support unit into the input location from either side.

The identification module may comprise one or more sensors supported by the side structures of the input location.

The or each input location may comprise a base structure comprising at least one pair of guide rails for receipt of at least one wheel of a mobile support unit.

Each pair of guide rails may be shaped such that a distance between the pair of rails is smaller in a central region than at each end of the input location. Advantageously, the central regions of the pairs of guide rails may constrain the mobile support unit in an alignment position while the tapered or flared end portions help the insertion of the mobile support unit into the input location from either side.

The system may further comprise at least one buffer support unit comprising a plurality of buffer storage positions suitable for supporting an item and the automated apparatus may be operable to move an item supported by a mobile support unit received by the input module to one of the plurality of storage positions of the main support unit via at least one of said plurality of buffer storage positions.

The provision of at least one buffer support unit advantageously provides an additional buffer storage for the system. Advantageously, this allows greater flexibility to sort the items such that they are placed into the main support unit at storage positions selected in dependence on the identification data determined from that item. As explained above, the system may have application in an online grocery shopping system. For example, the items may comprise totes or tote boxes and the mobile support units that can be received by the input module may each comprise a trolley for supporting totes. In general, the totes on each trolley comprise totes for a plurality of different customer orders all containing goods that are located in relatively close proximity to one another. An order for a single customer may be distributed over a plurality of such trolleys (as this may improve the efficiency of the picking process). The system may receive a plurality of different trolleys, unload the totes from them and place them onto the main support unit such that they are now grouped according to which delivery van will be used to transport them to the relevant customer. It will be appreciated that each of the plurality of different trolleys used to pick the goods that will be transported in a given delivery van journey will, in general, arrive at the input module at different times. The at least one buffer support unit may, for example, allow part of a van load to be temporarily stored in the system while the system awaits the arrival of the remainder of the van load.

The provision of at least one buffer support unit may be particularly beneficial for embodiments wherein the main storage unit is a one-way storage unit (for example a first in, first out rack) since for such embodiments it may be desirable to put the items into the input of the main storage unit in a particular order.

Furthermore, a buffer support unit can allow greater freedom to optimize the movement of items through the system (and can, for example, allow some items to be prioritized while other items remain in one or more buffer support units for longer).

For embodiments wherein the system comprises at least two levels, the at least one buffer support unit may be disposed at the second level.

The system may comprise at least one input buffer support unit comprising a plurality of input buffer storage positions suitable for supporting an item that is associated with an input location and the automated apparatus may be operable to move an item supported by a mobile support unit received by the input module to one of the plurality of input buffer storage positions.

In some embodiments, once unloaded from a mobile support unit by an unload apparatus, each item may be moved through the system by a plurality of robots. An input buffer support unit associated with at an input location allows items unloaded from a mobile support unit by an unload apparatus to be temporarily stored for later retrieval by such a robot. Advantageously, this removes the need for a robot to be waiting for items as they are unloaded. Rather, the items can be unloaded to the input buffer support unit and collected by the robots when convenient. Advantageously, this reduces downtime of the robots, increasing the throughput of the system for a given number of robots. Furthermore, this input buffer support unit can allow greater freedom to optimize the movement of items through the system (and can, for example, allow some items to be prioritized while other items remain in the input buffer support unit for longer).

The system may comprise at least one output buffer support unit comprising a plurality of output buffer storage positions suitable for supporting an item that is associated with the main support unit and the automated apparatus may be operable to move an item supported by the at least one output buffer support to one of the plurality of storage positions of the main support unit.

In some embodiments, once unloaded from a mobile support unit by an unload apparatus, each item may be moved through the system by a plurality of robots to be loaded into the main support unit by load apparatus. An output buffer support unit associated with the main support unit allows items transported by a robot to be temporarily stored for later transfer to the main support unit by the load apparatus. Advantageously, this removes the need for a robot to be waiting for the load apparatus to be free to transfer items therefrom. Rather, the items can be unloaded from the robot to the output buffer support unit and collected by the load apparatus when convenient. Advantageously, this reduces downtime of the robots, increasing the throughput of the system for a given number of robots. Furthermore, this output buffer support unit can allow greater freedom to optimize the movement of items through the system (and can, for example, allow some items to be prioritized while other items remain in the output buffer support unit for longer).

At least some of the plurality of buffer storage positions may be provided with an inlet and a separate outlet.

At least a subset of the buffer storage positions may comprise a common inlet and a common outlet.

In use, the or each inlet may be disposed at a higher position than the or each associated outlet and the or each outlet may be provided with a latch mechanism, the latch mechanism arrangeable in a closed configuration in which an item disposed adjacent the outlet is prevented from passing through the outlet; and an open position in which an item disposed adjacent the outlet is allowed to pass through the outlet.

The system may comprise at least one intermediate buffer support unit comprising a plurality of intermediate buffer storage positions suitable for supporting an item.

At least one of the plurality of intermediate buffer storage positions suitable for supporting an item may be provided with a common inlet and outlet.

For example, at least some of the plurality of intermediate buffer storage positions may be of the form of a shelf or rack that items can be placed onto from one side and subsequently removed from the same side.

The shelf or rack may therefore have a depth suitable to accommodate only one item.

At least one of the plurality of intermediate buffer storage positions suitable for supporting an item may have a depth that is less than a depth of the items to be received and sorted by the system.

For example, some of the intermediate buffer storage positions may have a depth that is greater than half a depth of the items to be received and sorted by the system. Advantageously, this may simplify the functionality of automated apparatus (for example a robot) that is operable to place an item in such an intermediate buffer storage position and/or to remove an item from such an intermediate buffer storage position. As previously discussed, the items to be received and sorted by the system may comprise totes.

At least one of the plurality of intermediate buffer storage positions may be provided with an actuator operable to push an item supported by that intermediate buffer storage position out of the common inlet and outlet.

For example, an automated apparatus (for example a robot) may be operable to place an item in such an intermediate buffer storage position. For subsequent retrieval of the item, an automated apparatus (for example a robot) may be operable move adjacent to the intermediate buffer storage position and the actuator may be used to push the item onto the automated apparatus.

At least one of the plurality of intermediate buffer storage positions suitable for supporting an item may be provided with an inlet and a separate outlet and, in use, the or each inlet may be disposed at a higher position than the or each associated outlet and wherein the or each outlet is provided with a latch mechanism, the latch mechanism arrangeable in a closed configuration in which an item disposed adjacent the outlet is prevented from passing through the outlet; and an open position in which an item disposed adjacent the outlet is allowed to pass through the outlet.

Advantageously, such intermediate buffer storage positions allow a height of an item to be changed. For example, items may be placed into and removed from intermediate buffer storage positions by a robot that may be operable to carry a plurality of items (for example two) at different heights. Intermediate buffer storage positions allow a height of an item to be changed may allow items to be moved, under the action of gravity from one height to another.

The automated apparatus may comprise at least one unload apparatus operable to remove items supported by a mobile support unit received by the input module.

In some embodiments, one such unload apparatus may be provided to remove items supported by a mobile support unit received by any one of a plurality of input locations of the input module.

The automated apparatus may comprises an unload apparatus associated with each of the plurality of input locations of the input module and may be operable to remove items supported by a mobile support unit received by the associated input location.

Alternatively, one such unload apparatus may be provided at each input location of the input module to remove items supported by a mobile support unit received by that input location.

For embodiments wherein the system comprises at least two levels, the or each unload apparatus may be operable to move items from a mobile support unit disposed on the first level to a first location on the second level.

That is, the unload apparatus may be generally of the form of a lift. Items may be transferred directly from the unload apparatus onto another robot (a transport robot) operable to move the items to a second location on the second level. Alternatively, items may be transferred from the unload apparatus an input buffer support unit for subsequent collection by another robot (a transport robot) operable to move the items to a second location on the second level. The first location may be adjacent an input of the input buffer support unit.

The or each unload apparatus may comprise: a main support; at least one shelf supported by the main support and suitable for supporting an item; and transfer apparatus operable to transfer items to and from the at least one shelf.

Transfer apparatus may comprise apparatus separate from the shelf and operable to push or pull items onto the shelf.

The transfer apparatus may comprise a manipulator disposed adjacent to an input location, the manipulator comprising a plurality of movable manipulators that are operable to transfer items from a mobile support unit disposed in the input location and an adjacent position at which the at least one shelf is positionable.

Alternatively, the transfer apparatus may comprise apparatus provided on the shelf and operable to push or pull items onto the shelf or to assist in pushing or pulling items onto the shelf.

The at least one shelf may comprise a conveyor module operable to move items on to or off of the at least one shelf.

With such an arrangement, the conveyor can move an item between the or each shelf and an adjacent position. It will be appreciated that in order to move an item using such a conveyor the item may be at least partially disposed on the conveyor in order for the conveyor to engage with it.

The at least one shelf may comprise a movable member, the movable member movable relative to the shelf between a retracted position in which the movable member overlies the shelf and an extended position wherein the movable member extends away from the shelf so as to overlie an adjacent position, the movable member operable to releasably engage an item.

With such an arrangement, the movable member can releasable engage an item such that as it moves between the retracted and extended positions said member moves with it. In this way, the movable member can drag an item between the shelf and an adjacent position.

Each moveable member may be generally of the form of an extendable, nestable, collapsible, or telescopic arm or panel that is supported by the main support.

Each shelf may be of the form of a roller shelf, comprising a plurality of rollers aligned generally in a direction generally perpendicular to a movement direction of the moveable member.

The at least one shelf may be movable relative to the main support in a first direction so as to be positionable adjacent a plurality of different items supported by a mobile support unit received by the input module.

For example, for embodiments wherein the system comprises at least two levels the first direction may be a direction in which separates the two levels.

The main support may be movable between at least the first position and a second position.

The automated apparatus may comprise at least one load apparatus operable to move items to the main support unit.

For embodiments wherein the system comprises at least two levels, the load apparatus may be operable to move items from a location on the second level to the main support unit disposed on the first level.

That is, the load apparatus may be generally of the form of a lift. Items may be transferred directly to the load apparatus from another robot (a transport robot) operable to move the items on the second level. Alternatively, items may be transferred to the load apparatus from an output buffer support unit, having been previously deposited on the output buffer support unit by another robot (a transport robot) operable to move the items to on the second level.

The load apparatus may comprise: a main support; at least one shelf supported by the main support and suitable for supporting an item; and transfer apparatus operable to transfer items to and from the at least one shelf.

The transfer apparatus may comprise apparatus provided on the shelf and operable to push or pull items onto the shelf or to assist in pushing or pulling items onto the shelf.

The at least one shelf may comprise a conveyor module operable to move items on to or off of the at least one shelf.

With such an arrangement, the conveyor can move an item between the or each shelf and an adjacent position. It will be appreciated that in order to move an item using such a conveyor the item may be at least partially disposed on the conveyor.

The at least one shelf may comprise a movable member, the movable member movable relative to the shelf between a retracted position in which the movable member overlies the shelf and an extended position wherein the movable member extends away from the shelf so as to overlie an adjacent position, the movable member operable to releasably engage an item.

With such an arrangement, the movable member can releasable engage an item such that as it moves between the retracted and extended positions said member moves with it. In this way, the movable member can drag an item between the shelf and an adjacent position.

Each moveable member may be generally of the form of an extendable, nestable, collapsible, or telescopic arm or panel that is supported by the main support.

Each shelf may be of the form of a roller shelf. Such a roller shelf may comprise a plurality of rollers aligned generally in a direction generally perpendicular to a movement direction of the moveable member. Alternatively, the roller shelf may comprise a belt or a cleated belt or the like.

The at least one shelf may be movable relative to the main support in a first direction so as to be positionable adjacent a plurality of different storage positions of the main support unit.

For example, for embodiments wherein the system comprises at least two levels the first direction may be a direction in which separates the two levels.

The main support may be movable between at least the first position and a second position.

For example, the main support may be movable in a direction that is generally perpendicular to the first direction. For example, for embodiments wherein the system comprises at least two levels the main support may be movable in a direction that is generally parallel to two levels.

The automated apparatus may comprise at least one transport robot operable to remove items supported by a supply apparatus and to deliver said items to a receiver apparatus.

Such transport robots may transport items between any two apparatus within the system, generally on the same level of the system. For example, the transport robots may be operable to transport items from an unload apparatus to a load apparatus. The transport robots may be operable to remove items directly from the unload apparatus or, alternatively, from an input buffer support unit. The transport robots may be operable to deliver items directly to the load apparatus or, alternatively, to an output buffer support unit. The transport robots may be operable to transport items from an unload apparatus to a load apparatus via any the buffer support unit.

Movement of the transport robot(s) may be controlled by the control module. The transport robot(s) may follow any suitable route, which may be determined by the control module.

For embodiments wherein the system comprises at least two levels, the or each transport robot may be operable to move items between two locations on the second level.

That is, transport robots operable to move the items on the second level. Items may be transferred to the second level by the unload apparatus and may be returned to the first level by the load apparatus.

The or each transport robot may comprise: a main body; a drive mechanism operable to move the main body relative to a support substrate; at least one shelf supported by the main body and suitable for supporting an item; and transfer apparatus operable to transfer items to and from the at least one shelf.

The main body may be supported by a plurality of wheels and the drive mechanism may be operable to control said plurality of wheels to move the main body relative to a support substrate (for example a floor). As used here, control of the wheels may include actuation of the wheels (i.e. spinning the wheels about their axes) and/or changing a direction of the wheels (i.e. rotating the wheels about an axis perpendicular to their axes). The drive mechanism may comprise: one or more motors; a power supply (such as a battery or the like); and an autonomous control system (which may control the one or more motors in response to signals received from the main control module of the system).

The transfer apparatus may comprise apparatus provided on the shelf and operable to push or pull items onto the shelf or to assist in pushing or pulling items onto the shelf.

The at least one shelf may comprise a conveyor module operable to move items on to or off of the at least one shelf.

With such an arrangement, the conveyor can move an item between the or each shelf and an adjacent position. It will be appreciated that in order to move an item the using such a conveyor the item may be at least partially disposed on the conveyor.

The transport robot may comprise a latch actuator operable to transition the latch mechanism of another component of the system between its closed and open configurations.

Advantageously, this may allow the transport robot to operate the latch mechanism of other components of the system so as to extract items. For example, upon arrival at another component of the system (for example a buffer storage unit) the transport robot may be disposed such that the or each shelf of the transport robot is adjacent an outlet of said other component of the system. The transport robot may then use its latch actuator to transition the latch mechanism of that component of the system from its closed configuration to its open configuration, which may allow an item to transition partially from the outlet of that component onto one of the shelves of the transport robot. A conveyor module of the transport robot may then pull the item fully onto the shelf. The latch mechanism of the other component of the system may automatically transition back from its open configuration to its closed configuration. Alternatively the latch actuator of the transport robot may transition the latch mechanism of the other component of the system back from its open configuration to its closed configuration.

It will be appreciated that as used here latch actuator is intended to cover anything that is operable to transition the latch mechanism of another component of the system between its closed and open configurations. For mechanical embodiments, the latch actuator may comprise an active actuator, which may be operable to move relative to transport robot to actuate the latch mechanism. Alternatively, the latch actuator may comprise a passive actuator, which may comprise a protrusion from a body of the transport robot, and which can actuate the latch mechanism by controlling the transport robot to drive the protrusion into the latch mechanism.

Alternatively, the latch actuator may be controlled by the control module (for example upon receipt of a signal from the transport robot indicating that it is in position adjacent the other component of the system).

The or each transport robot may comprise a latch actuator operable to transition the latch mechanism of any outlet of any buffer storage unit of the system between its closed and open configurations.

The automated apparatus may comprise at least one mobile support unit transporter operable to move a mobile support unit between the or each input location of the input module and one or more unloading positions.

Advantageously, such an arrangement may allow a plurality of input locations to share unload apparatus. This may allow the system to enjoy the benefits of a plurality of input locations whilst reducing a cost and/or complexity of the system. Such embodiments may have particular application for arrangements having lower throughput or volume if items.

The or each mobile support unit transporter may comprise a movable body and a height adjustment mechanism for adjusting a height of said body.

Such a mobile support unit transporter may be operable to move beneath a mobile support unit, lift the mobile support unit from below and then move the mobile support unit to another location.

At least one of the at least one unload apparatus may be provided or positionable at each of the one or more unloading positions.

The system may further comprise a return item input module arranged to receive at least one return item and the automated apparatus may be further operable to move a return item received by the return item input module to a mobile support unit received by the input module.

The control module may be configured to replace each item removed from mobile support units received by the input module with a return item received by the return item input module.

That is, once a mobile support unit has been unloaded (i.e. full totes have been removed from a trolley), the mobile support unit is automatically replenished with, for example, empty totes. Advantageously, the mobile support unit is then ready for an operator to use for another picking process. For example, new identification data may be provided (for example a new label) for each of the empty totes and the trolley may be used to fill the totes so as to at least partially fulfill a customer order.

For embodiments wherein the system comprises at least two levels, the return item input module may be disposed at the first level and the automated apparatus may be operable to move a return item received by the return item input module to a mobile support unit received by the input module via the second level.

In some embodiments, the return item input module may be configured to receive a stack of items (for example a stack of empty totes).

The automated apparatus may further comprise a de-stacker arranged to receive a stack of return items from the return item input module and to output a plurality of individual return items.

De-stackers for de-stacking a stack of totes are known and commercially available.

For embodiments wherein the system comprises at least two levels, the automated apparatus may comprise lift apparatus operable to move return items received from the return item input module to the second level.

The lift apparatus may receive return items from a de-stacker.

The system may further comprise at least one return item buffer support unit comprising a plurality of return item buffer storage positions suitable for supporting a return item and the automated apparatus may be operable to move a return item received by the return item input module to a mobile support unit received by the input module via at least one of said plurality of return item buffer storage positions.

For embodiments wherein the system comprises at least two levels, the at least one return item buffer support unit may be disposed at the second level.

The system may comprise at least one input return item buffer support unit comprising a plurality of input return item buffer storage positions suitable for supporting a return item that is associated with the return item input module and the automated apparatus may be operable to move a return item received by the return item input module to one of the plurality of input return item buffer storage positions.

In some embodiments, once lifted to the second level by lift apparatus, each return item may be moved through the system by a plurality of robots. An input return item buffer support unit associated with the input module allows items lifted to the second level by the lift apparatus to be temporarily stored for later retrieval by such a robot.

Advantageously, this removes the need for a robot to be waiting for return items as they arrive at the second level. Rather, the return items can be placed in the input return item buffer support unit and collected by the robots when convenient.

Advantageously, this reduces downtime of the robots, increasing the throughput of the system for a given number of robots.

The system may comprise at least one output return item buffer support unit comprising a plurality of output return item buffer storage positions suitable for supporting a return item and associated with at least one of the or each input location and the automated apparatus may be operable to move a return item supported by the at least one output return item buffer support to a mobile support unit received at the associated input location.

At least some of the plurality of return item buffer storage positions may be provided with an inlet and a separate outlet.

At least a subset of the return item buffer storage positions may comprise a common inlet and a common outlet.

In use, the or each inlet may be disposed at a higher position than the or each associated outlet and the or each outlet may be provided with a latch mechanism, the latch mechanism arrangeable in a closed configuration in which an item disposed adjacent the outlet is prevented from passing through the outlet; and an open position in which an item disposed adjacent the outlet is allowed to pass through the outlet.

The at least one unload apparatus may be further operable to replace items removed from the mobile support unit with return items.

According to a second aspect of the disclosure there is provided a method for receiving and sorting items, the method comprising: receiving a plurality of mobile support units, each supporting a plurality of items; determining identification data from each item supported by each of the plurality of mobile support units; determining an output storage position for each of the plurality of items from each of the plurality of mobile support units; and using automated apparatus to move each of the plurality of items from each of the plurality of mobile support units to its determined output storage position; wherein the determined output storage position of each item is selected in dependence on the identification data determined from that item.

The method according to the second aspect may be implemented by the system according to the first aspect of the invention. Where compatible, the method according to the second aspect may comprise any of the features of the system according to the first aspect of the invention.

Since the output storage position of each item is selected in dependence on the identification data determined from that item, advantageously, the items can be sorted according to the identification data. For example, it may be desirable to group items in a plurality of different groups (each group may, for example, relate to a different customer and/or a different delivery van). For this purpose, the identification data may include a group identifier and the storage position of each item may be selected in dependence on the group identifier for that item. Items with the same group identifier may, for example, be placed in one or more groups or clusters of adjacent output storage positions in the main support unit.

The output storage position of each item may be selected such that the items are sorted or grouped according to the identification data in dependence on the identification data determined from that item.

The plurality of output storage positions may comprise a plurality of different subsets of output storage positions and wherein the subset of output storage positions from which the determined output storage position for each of the plurality of items from each of the plurality of mobile support units is selected, is selected in dependence on the identification data determined for that item.

For example, each subset of storage positions may comprise a block of adjacent storage positions. As a non-limiting example, each subset of storage positions may comprise a 2×4 array of adjacent output positions (for example two columns of four rows). Each item may be placed by the system in a specific subset or block of storage positions based on the identification data determined for that item.

The identification data may include at least one group identifier and the output storage position of each item may be selected in dependence on the group identifier determined from that item.

The group identifier may, for example, indicate a delivery van associated with that item. Additionally or alternatively, the group identifier may, for example, indicate a customer associated with that item.

For example, the control module may be configured such that a subset of storage positions from which the storage position of each item is selected to be is selected in dependence on the group identifier (for example a delivery van identifier) determined for that item.

The identification data may include at least one subgroup identifier and the output storage position of each item may be selected in dependence on the subgroup identifier determined from that item.

The subgroup identifier may, for example, indicate a target position in a delivery van associated with that item.

For example, the control module may be configured such that a position within a selected subset of storage positions for each item may be selected in dependence on the subgroup identifier (for example a target position in a delivery van associated with that item) determined for that item.

Determining identification data from each item supported by each of the plurality of mobile support units may comprise: determining a unique identifier from each item; and determining the identification data for each item from lookup data using the unique identifier determined from it.

Using automated apparatus to move each of the plurality of items from each of the plurality of mobile support units to its determined output storage position may comprise: moving each item from a mobile support unit on a first level to a first position on a second level; moving each an item from the first position on the second level to a second position on the second level; and moving each item from the second position on the second level to the output storage position.

Such a method allows the bulk of the transportation between the input and the output storage position to be performed on the second level. The main support unit may also be provided on the first level.

Using automated apparatus to move each of the plurality of items from each of the plurality of mobile support units to its determined output storage position may comprise: moving at least some of the items from a mobile support unit to at least one intermediate storage position; and subsequently moving those items from their at least one intermediate storage position to their output storage positions.

Such an at least one intermediate storage position may provide a buffer for the process. Advantageously, this allows greater flexibility to sort the items such that they are placed into the output storage positions selected in dependence on the identification data determined from that item. As explained above, the method may have application in an online grocery shopping system. For example, the items may comprise totes or tote boxes and the mobile support units that can be received by the input module may each comprise a trolley for supporting totes. In general, the totes on each trolley comprise totes for a plurality of different customer orders all containing goods that are located in relatively close proximity to one another. An order for a single customer may be distributed over a plurality of such trolleys (as this may improve the efficiency of the picking process). The method may comprise receiving a plurality of different trolleys, unloading the totes from them and placing them into the output storage positions such that they are now grouped according to which delivery van will be used to transport them to the relevant customer. It will be appreciated that each of the plurality of different trolleys used to pick the goods that will be transported in a given delivery van journey will, in general, be received at different times. The at least one intermediate storage position may, for example, allow part of a van load to be temporarily stored in while awaiting the arrival of the remainder of the van load.

At least some of the at least one intermediate storage positions may share a common rack system with the output storage positions. Additionally or alternatively, at least some of the at least one intermediate storage positions may be provided on a separate rack system to the output storage positions.

The at least one intermediate storage position may allow greater freedom to optimize the movement of items during execution of the method (and can, for example, allow the movement of some items to their output storage positions to be prioritized while other items remain in the at least one intermediate storage position for longer).

Using automated apparatus to move each of the plurality of items from each of the plurality of mobile support units to its determined output storage position may comprise: removing items supported by each of the plurality of received mobile support units.

Using automated apparatus to move each of the plurality of items from each of the plurality of mobile support units to its determined output storage position may comprise: placing items into a main support unit comprising the output storage position.

Using automated apparatus to move each of the plurality of items from each of the plurality of mobile support units to its determined output storage position may comprise: using at least one transport robot to remove items supported by a supply apparatus and to deliver said items to a receiver apparatus.

Using automated apparatus to move each of the plurality of items from each of the plurality of mobile support units to its determined output storage position may comprise: moving at least one of the plurality of mobile support units to at least one unloading position; and removing items supported by each such mobile support unit when disposed in one of the at least one unloading position.

The method may further comprise: receiving at least one return item; and using the automated apparatus to move the at least one return item to a received mobile support unit.

The method may further comprise: replacing each of the plurality of items removed from each of the plurality of mobile storage units with a return item from a return item storage position.

At least some of the return items may be moved to a received mobile support unit via at least one intermediate storage position

The method may further comprise: placing at least one object into each of the items supported by each of the plurality of mobile support units before said plurality of mobile support units are received.

The method may further comprise: removing a plurality of items from a subset of storage positions and transferring the plurality of removed items to another location.

For example a plurality of items may be removed together from a subset of adjacent storage positions. The other location may comprise a delivery vehicle. The plurality of items may be removed from an outlet of each of the subset storage positions.

According to a third aspect of the disclosure there is provided an input module for use in a system for receiving and sorting items, the input module comprising at least one input location arranged to receive a mobile support unit supporting a plurality of items.

The input module may have any of the features of the input module of the system according to the first aspect of the disclosure.

The input module may further comprising the unload apparatus of the system according to the first aspect of the disclosure.

The input module may further comprise at least one buffer support unit of the system according to the first aspect of the disclosure.

According to a fourth aspect of the disclosure there is provided a main support unit for use in a system for receiving and sorting items, the main support unit comprising a plurality of storage positions, each of the plurality of storage positions being suitable for supporting an item. The main storage unit may have any of the features of the main storage unit of the system according to the first aspect of the disclosure.

The main support unit may further comprise the load apparatus of the system according to the first aspect of the disclosure.

The main support unit may further comprise at least one buffer support unit according to the system according to the first aspect of the disclosure.

According to a fifth aspect of the disclosure there is provided an input module suitable for use in the system of the first aspect of the disclosure, the input module comprising an input location arranged to receive a mobile support unit supporting a plurality of items.

The input module according to the fifth aspect of the disclosure may comprise any features of the system of the first aspect of the disclosure as desired or appropriate.

The input module may comprise an indicator operable to display a status of the input location.

The input location may comprise an access door movable between: an open position in which a mobile support unit supporting a plurality of items can be inserted into or removed from the input location; and a closed position in which access to the input location is restricted.

The access door may further comprise a user controllable actuator mechanism operable, in response to an input from a user, to move the door from the closed position to the open position.

The input location may comprise an alignment structure arranged to aid the placement of a mobile support unit in an alignment position.

The input location may comprise a guide structure arranged to help guide a mobile support unit to an alignment position.

The input location may comprise two side structures which define between them a volume for receipt of a mobile support unit.

The input location may comprise a base structure comprising at least one pair of guide rails for receipt of at least one wheel of a mobile support unit.

The input module may further comprise an unload apparatus operable to remove items supported by a mobile support unit received by the input location.

The unload apparatus may be operable to move items from a mobile support unit disposed on a first level to a location on a second level.

The unload apparatus may comprise: a main support; at least one shelf supported by the main support and suitable for supporting an item; and transfer apparatus operable to transfer items to and from the at least one shelf.

The transfer apparatus may comprise a manipulator comprising a plurality of movable manipulators that are operable to transfer items between a mobile support unit disposed in the input location and an adjacent position at which the at least one shelf is positionable.

The at least one shelf may comprise a conveyor module operable to move items on to or off of the at least one shelf.

The at least one shelf may comprise a movable member, the movable member movable relative to shelf between a retracted position in which the movable member overlies the shelf and an extended position wherein the movable member extends away from the shelf so as to overlie an adjacent position, the movable member operable to releasably engage an item.

The at least one shelf may be movable relative to the main support in a first direction so as to be positionable adjacent a plurality of different items supported by a mobile support unit received by the input location.

The main support may be movable between at least the first position and a second position.

The input module may further comprise at least one buffer support unit comprising a plurality of buffer storage positions suitable for supporting an item.

The unload apparatus may be operable to move an item between a mobile support unit received by the input location and one of the plurality of buffer storage positions.

The plurality of buffer storage positions may comprise a plurality of input buffer storage positions and a plurality of output return item buffer storage positions.

According to a sixth aspect of the disclosure there is provided an automated apparatus comprising at least one load apparatus operable to move items to a main support unit.

The automated apparatus according to the sixth aspect of the disclosure may comprise any features of the system of the first aspect of the disclosure as desired or appropriate.

The load apparatus may be operable to move items from a location on a second level to the main support unit disposed on a first level.

The load apparatus may comprise: a main support; at least one shelf supported by the main support and suitable for supporting an item; and transfer apparatus operable to transfer items to and from the at least one shelf.

The at least one shelf may comprise a conveyor module operable to move items on to or off of the at least one shelf.

The at least one shelf may comprise a movable member, the movable member movable relative to shelf between a retracted position in which the movable member overlies the shelf and an extended position wherein the movable member extends away from the shelf so as to overlie an adjacent position, the movable member operable to releasably engage an item.

The at least one shelf may be movable relative to the main support in a first direction so as to be positionable adjacent a plurality of different storage positions of the main support unit.

The main support may be movable between at least the first position and a second position.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

Specific embodiments of the present invention will now be described, by way of example only, with reference to the accompanying drawings in which:

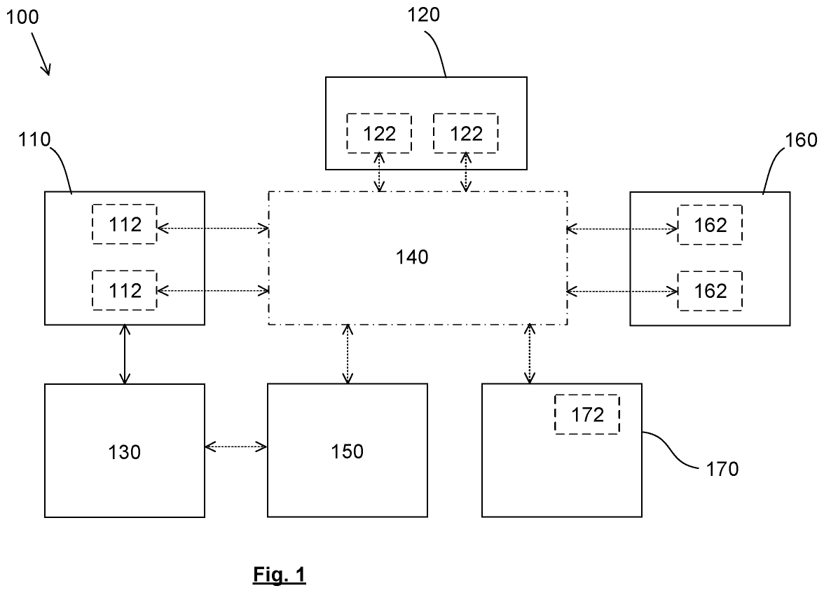

FIG. 1 is a schematic representation of a system for receiving and sorting items according to an embodiment of the present invention;

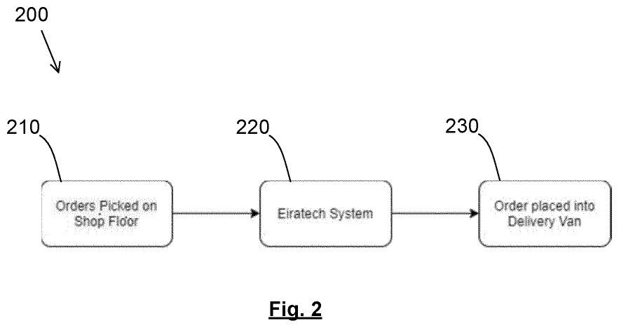

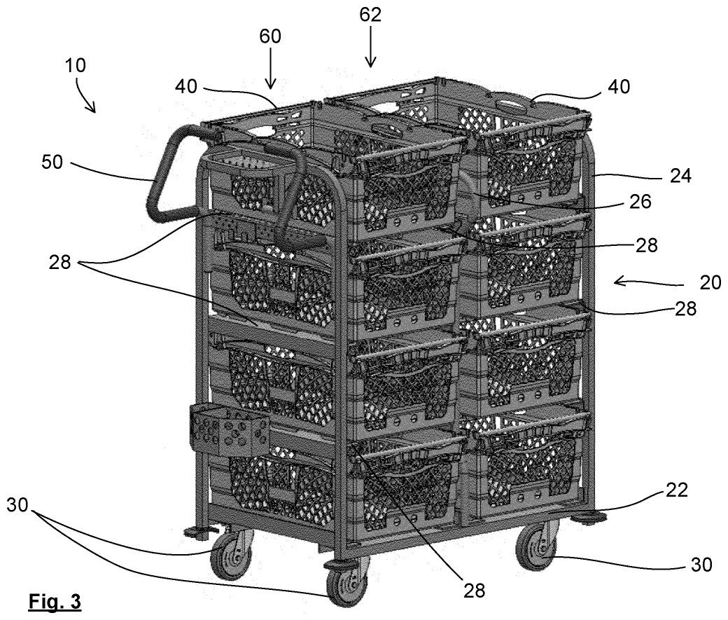

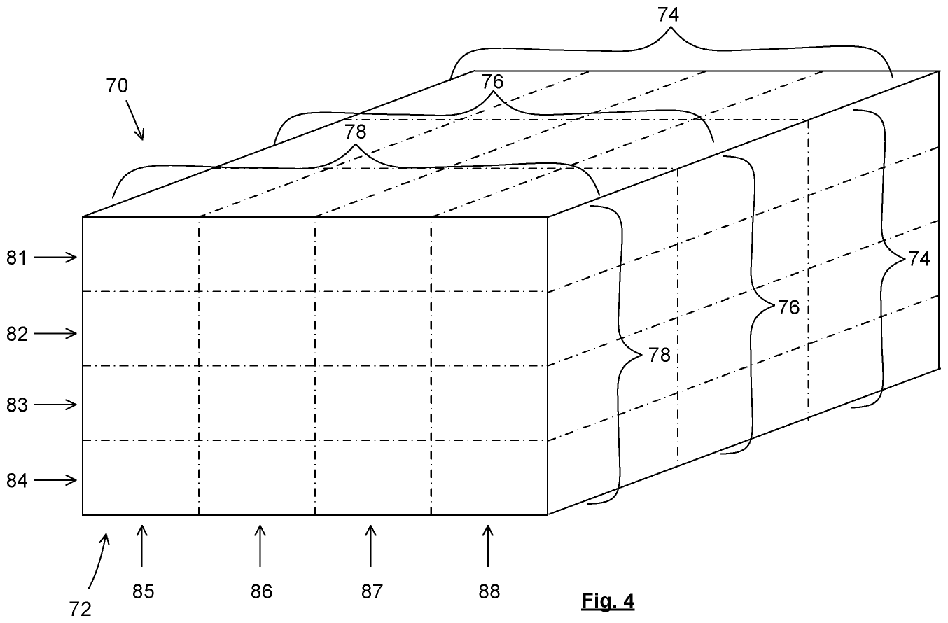

FIG. 2 shows a flow diagram for a general process for picking groceries and delivering them to customers, which uses the system shown in FIG. 1;

FIG. 3 shows an example mobile support unit for use with the system shown in FIG. 1;

FIG. 4 shows a schematic representation of the storage positions in a delivery van, which may be loaded with items which have been received and sorted by the system shown in FIG. 1;

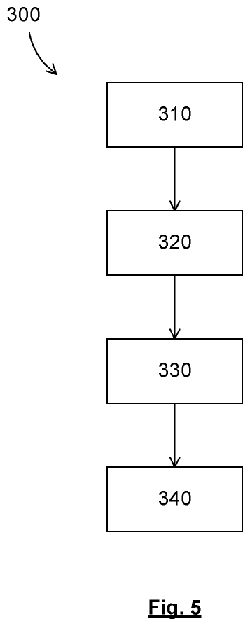

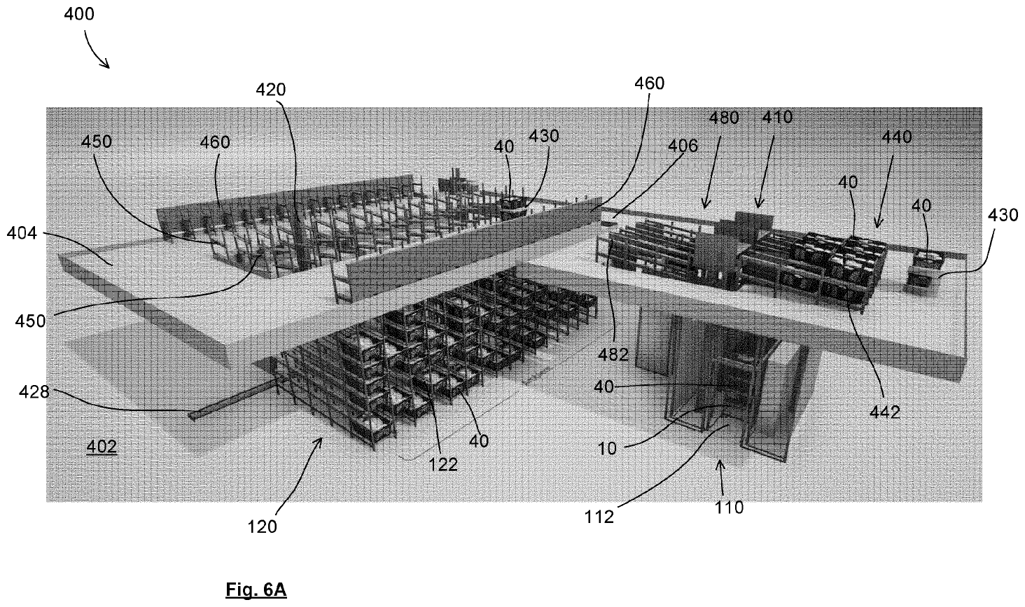

FIG. 5 is a schematic representation of a method for receiving and sorting items according to an embodiment of the present invention (which may be implemented by the system shown in FIG. 1);

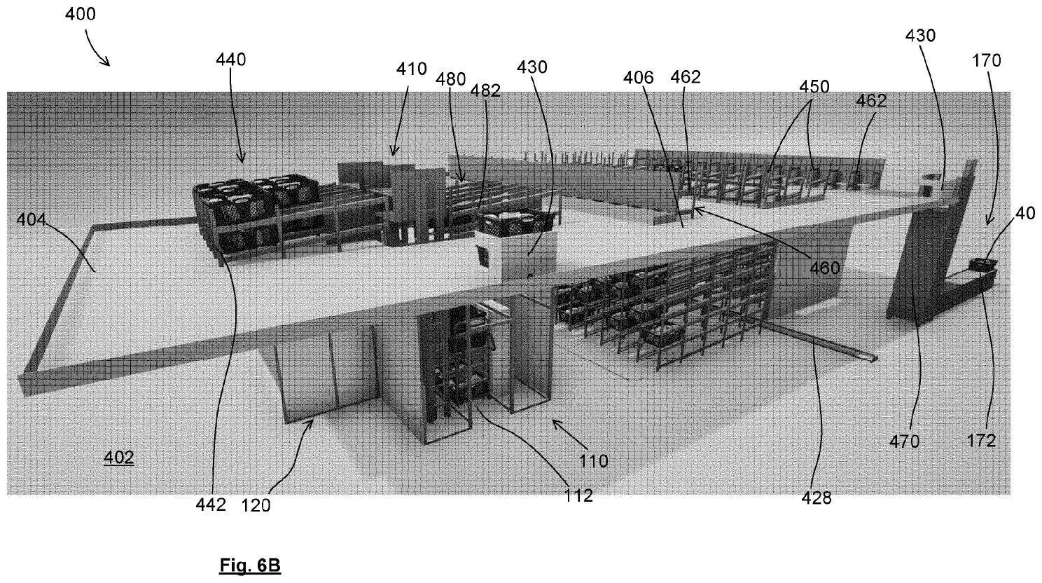

FIG. 6A is a first perspective view of parts of a first embodiment of the system for receiving and sorting items shown in FIG. 1;

FIG. 6B is a second perspective view of parts of the first embodiment of the system for receiving and sorting items shown in FIG. 1;

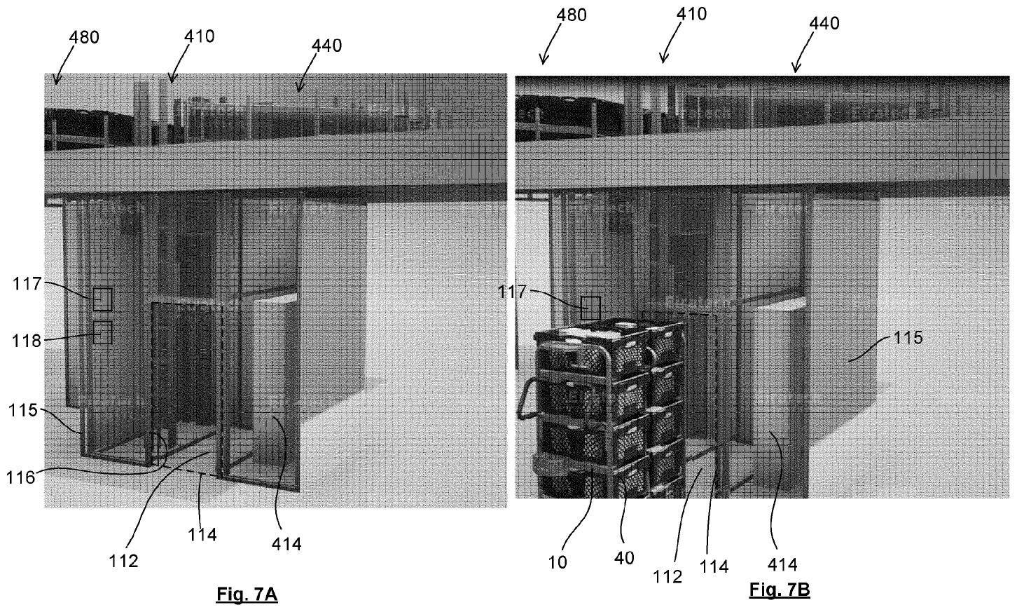

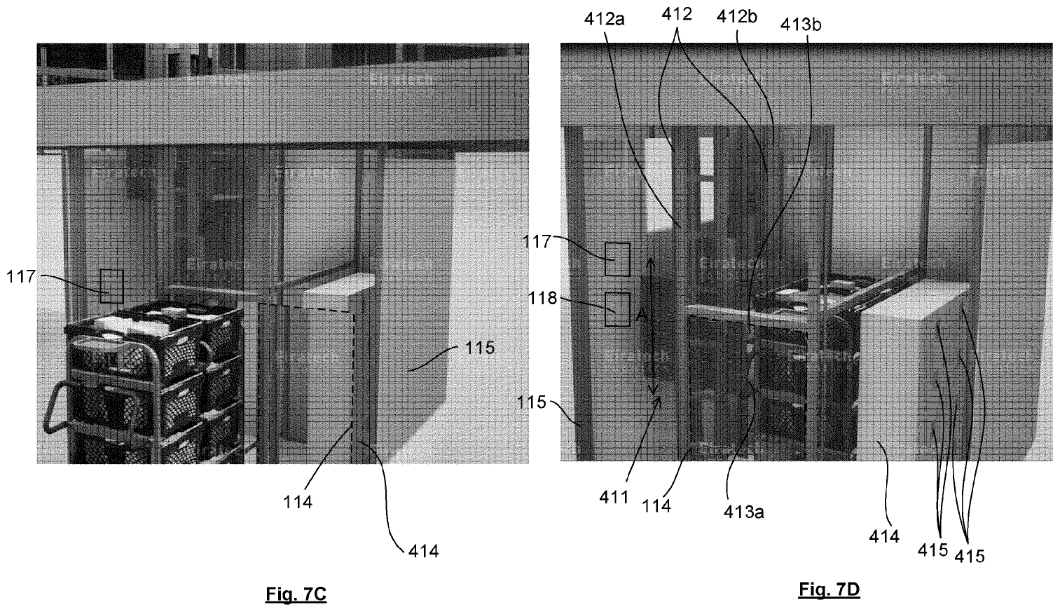

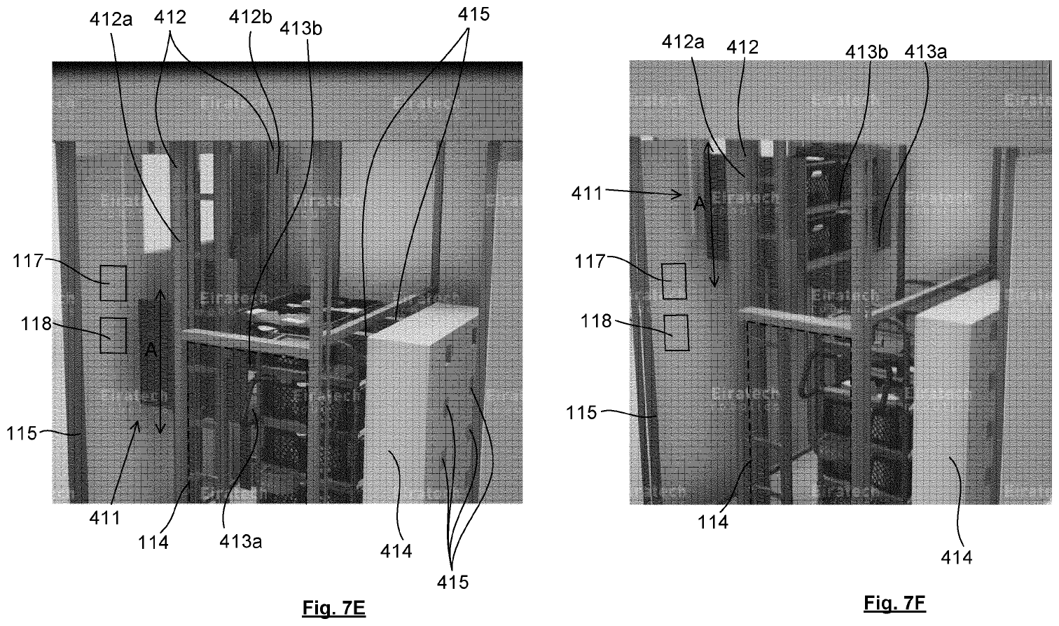

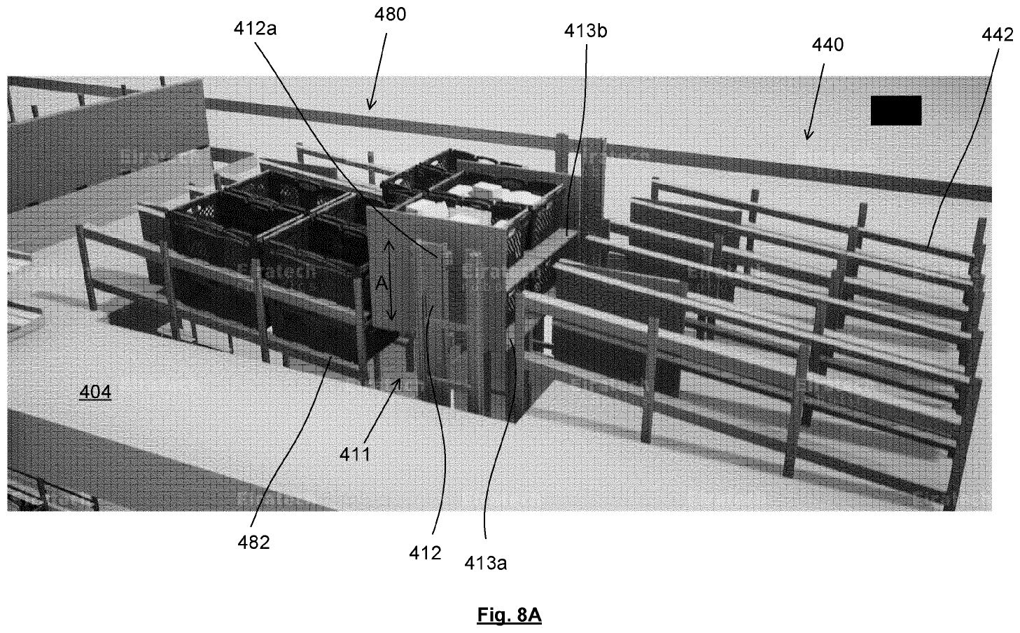

FIGS. 7A to 7E show an input location of the input module of the system shown in FIGS. 6A and 6B that is suitable for receiving a mobile support unit and associated unload apparatus which is operable to remove items supported by a mobile support unit received by the input location, the unload apparatus being used to remove items supported by a mobile support unit received by the input location;

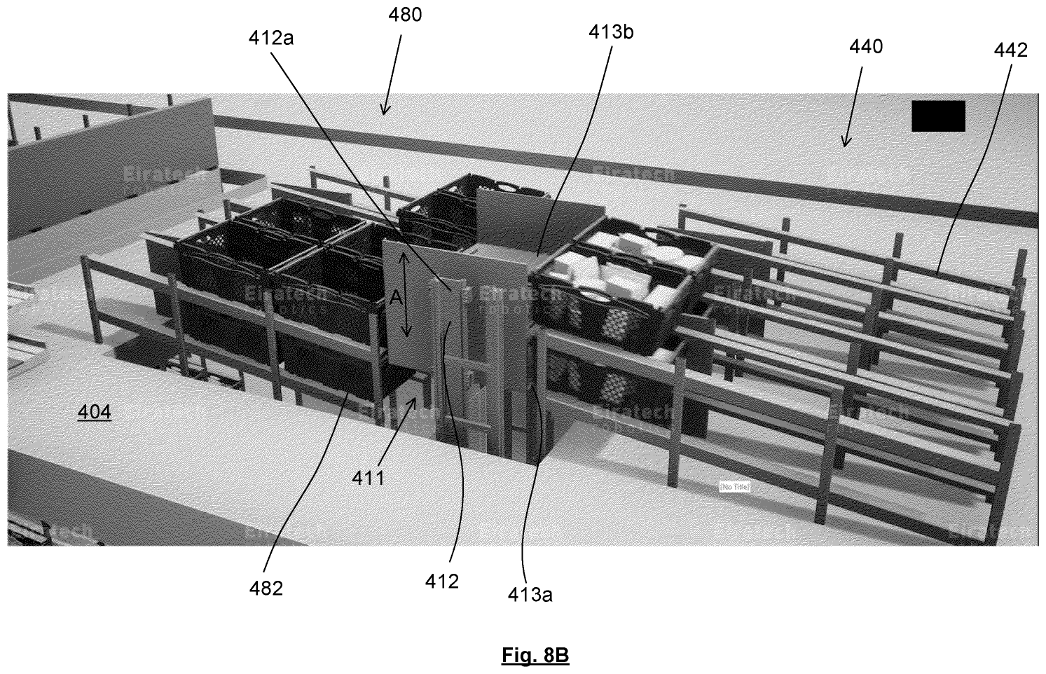

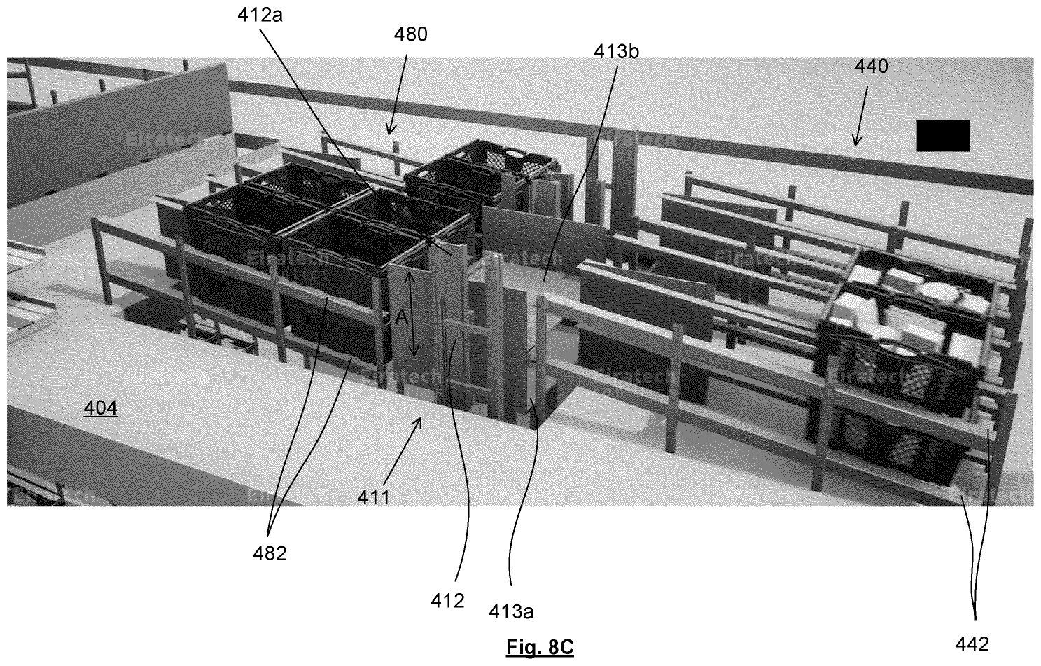

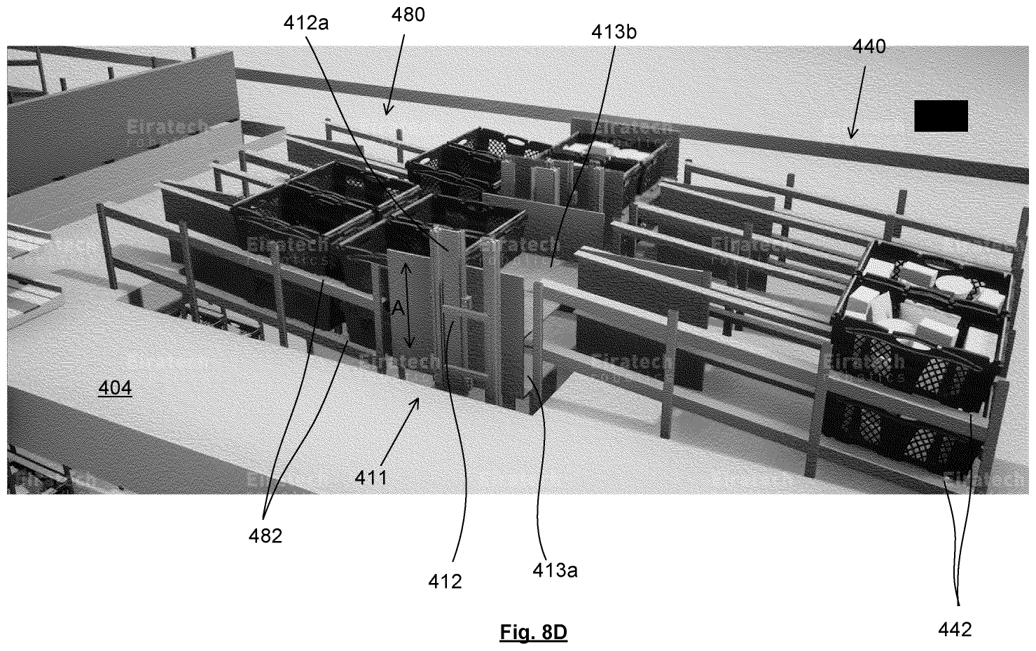

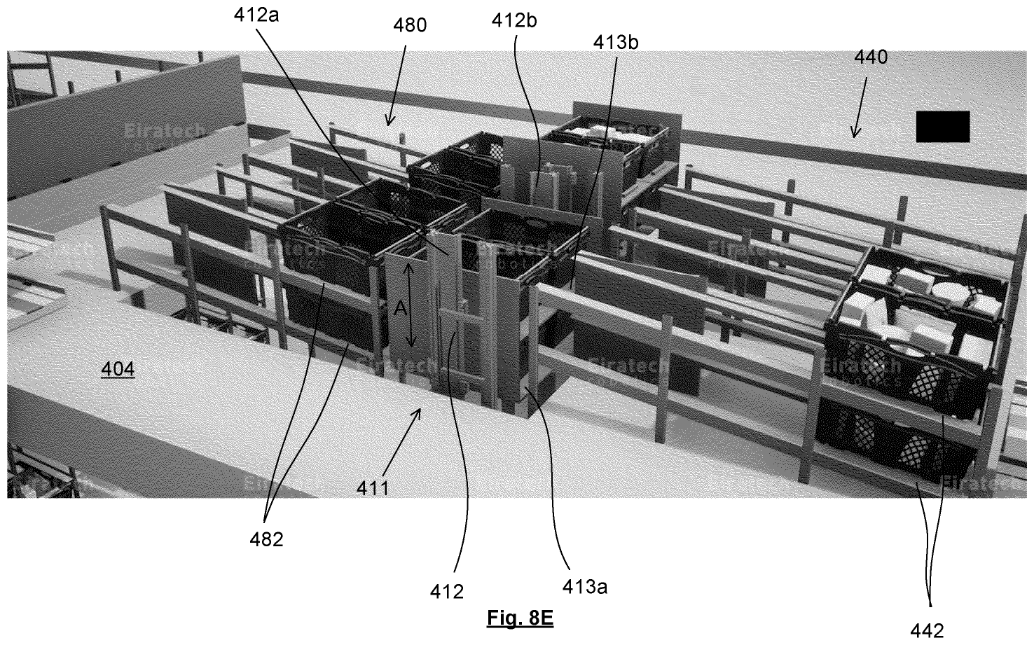

FIGS. 8A to 8E show part of the unload apparatus shown in FIGS. 7A to 7E and an input buffer support unit and an output return item buffer support unit of the system shown in FIGS. 6A and 6B which is associated with the input location shown in FIGS. 7A to 7E;

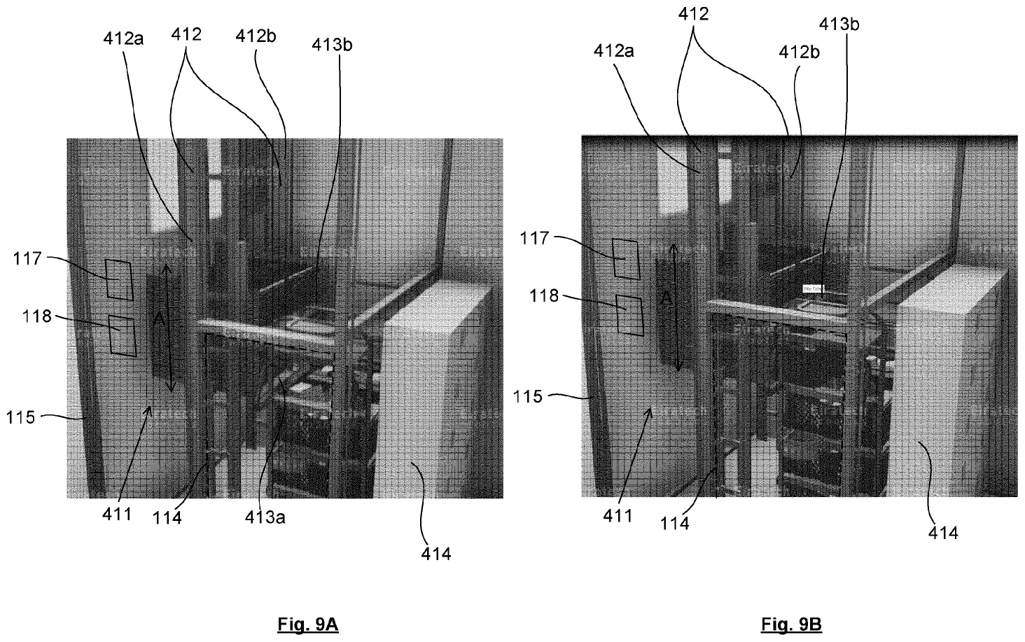

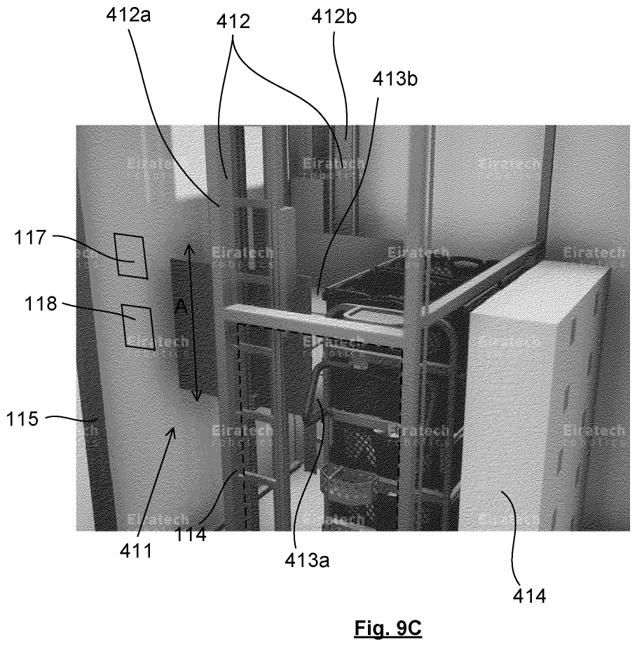

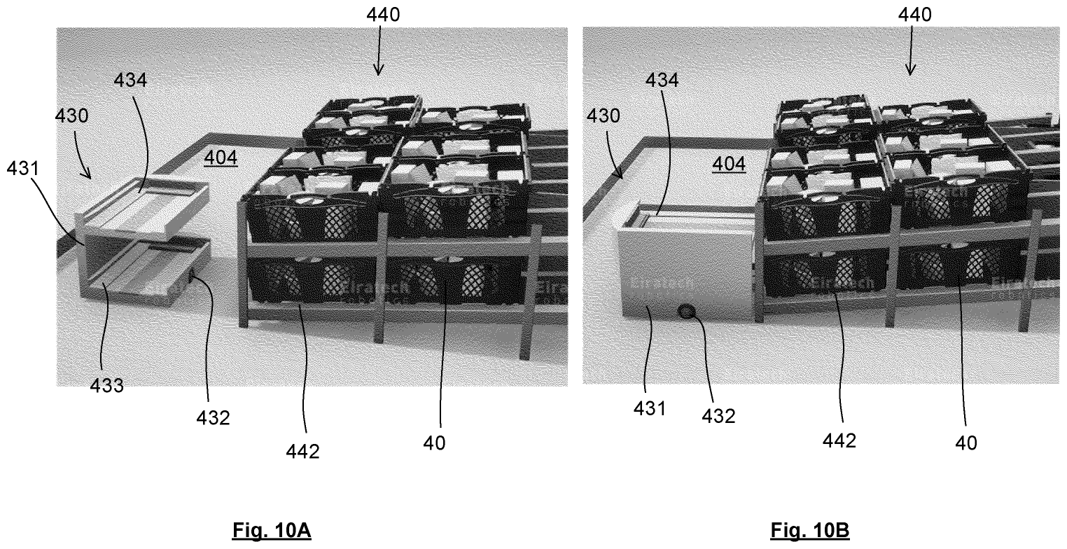

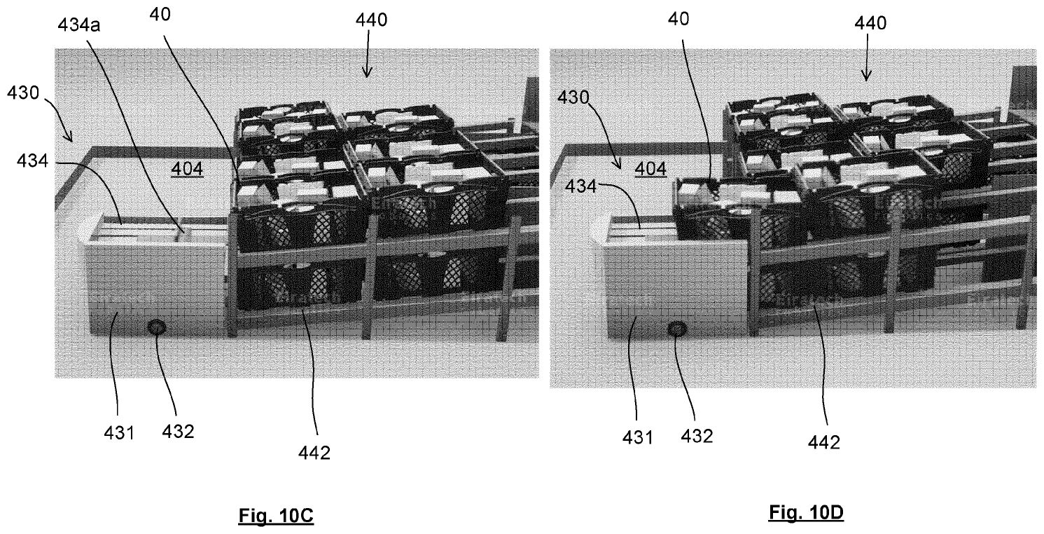

FIGS. 9A to 9C show the input location associated unload apparatus shown in FIGS. 7A to 7E, the unload apparatus being used to replace items (full totes) removed from a mobile support unit received by the input location with return items (empty totes);

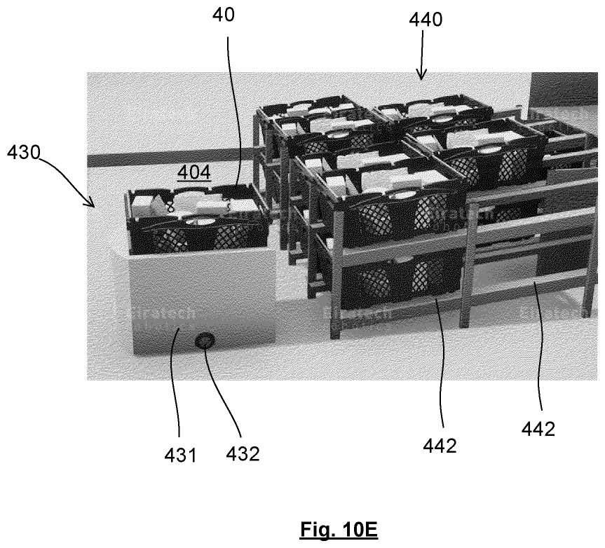

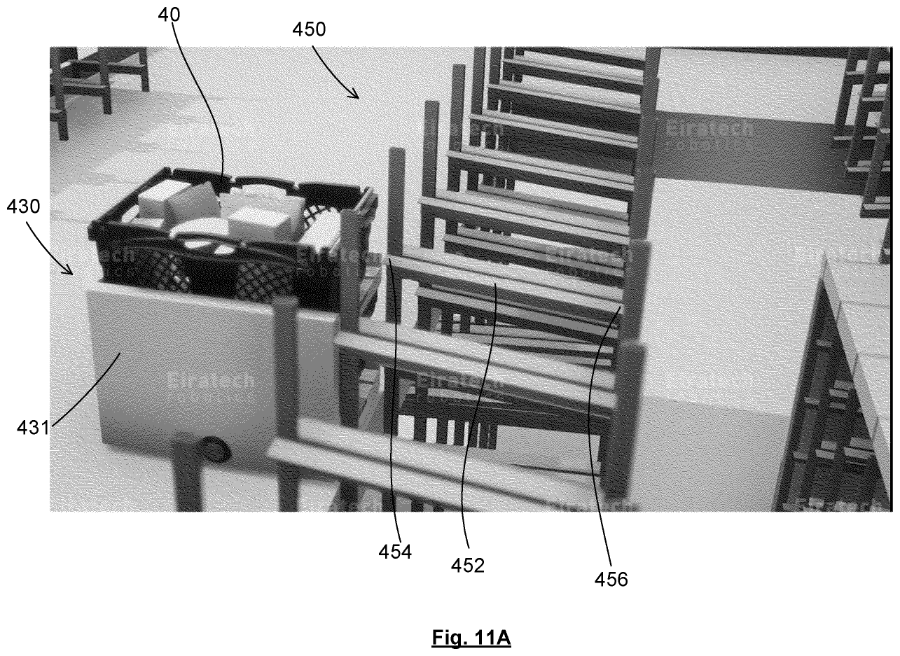

FIGS. 10A to 10E show the input buffer support unit shown in FIGS. 8A to 8E and a transport robot of the system shown in FIGS. 6A and 6B, the transport robot being used to remove items from the input buffer support unit;

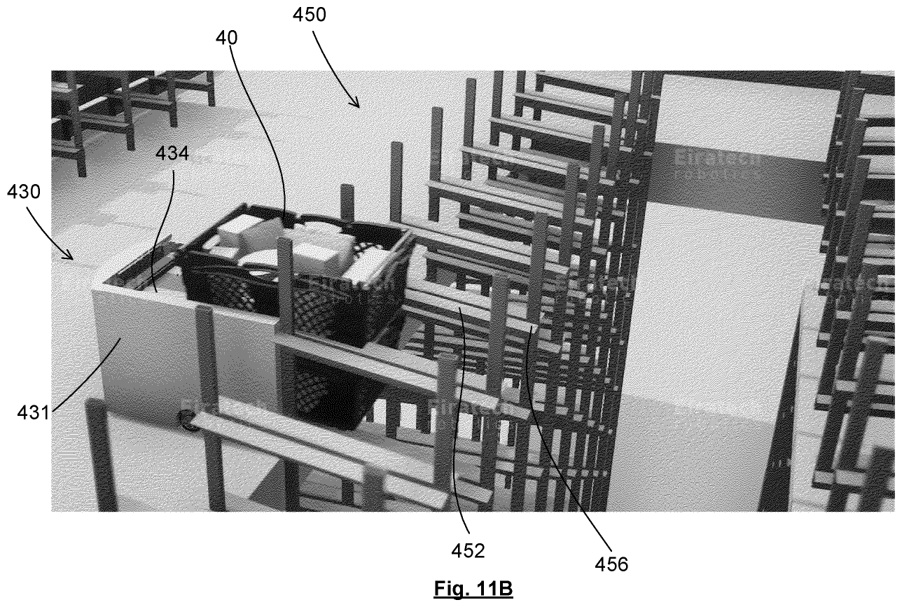

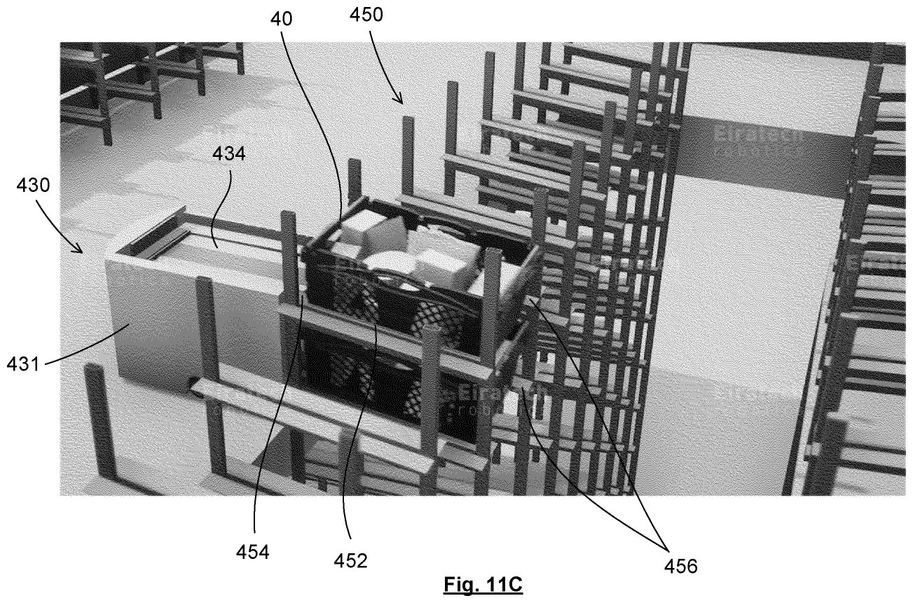

FIGS. 11A to 11C show an output buffer support unit of the system shown in FIGS. 6A and 6B and the transport robot shown in FIGS. 10A to 10E, the transport robot being used to place the items removed from the input buffer support unit on the output buffer support unit;

FIGS. 11D to 11G show the output buffer support unit shown in FIGS. 11A to 11C and an associated load apparatus of the system shown in FIGS. 6A and 6B which is operable to remove items supported by the output buffer support unit, the load apparatus being used to remove items supported by the output buffer support unit;

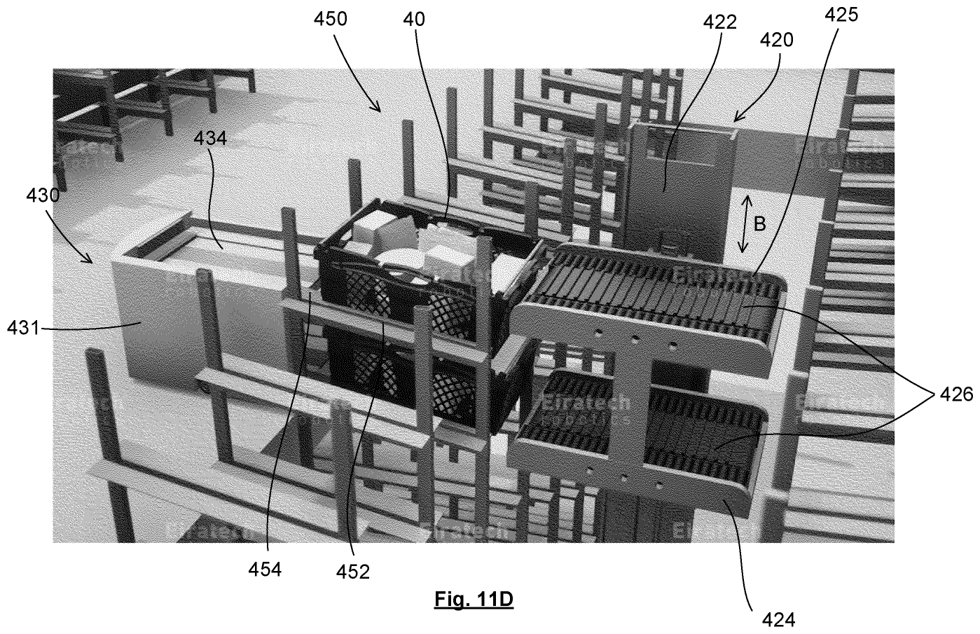

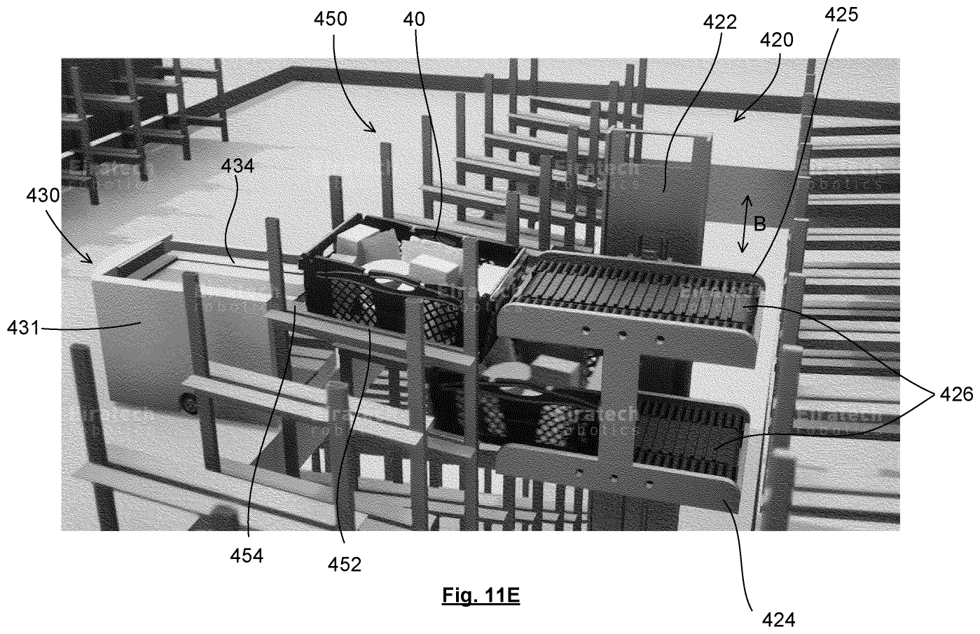

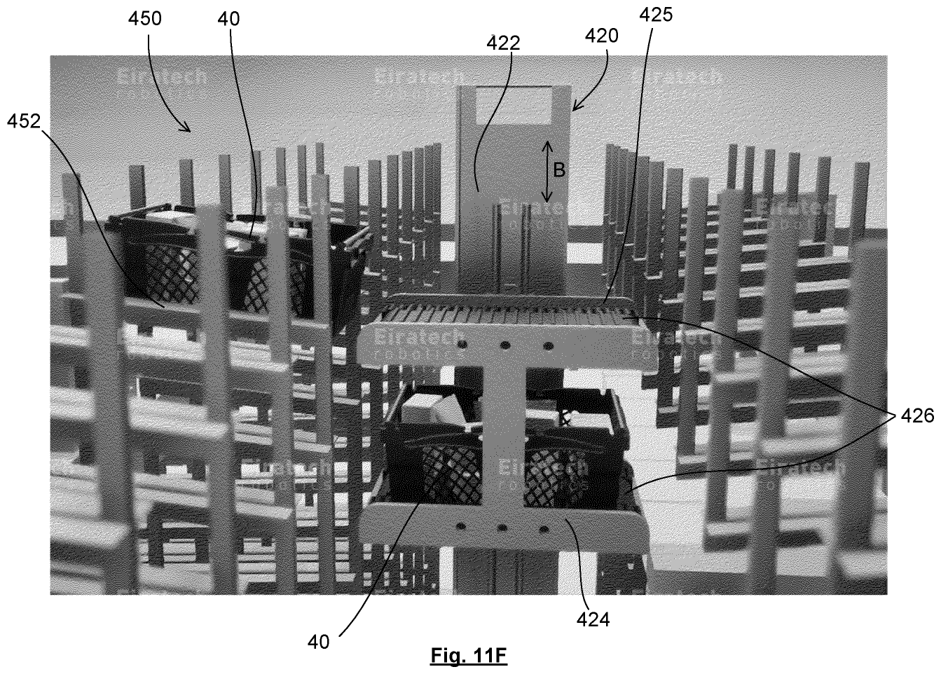

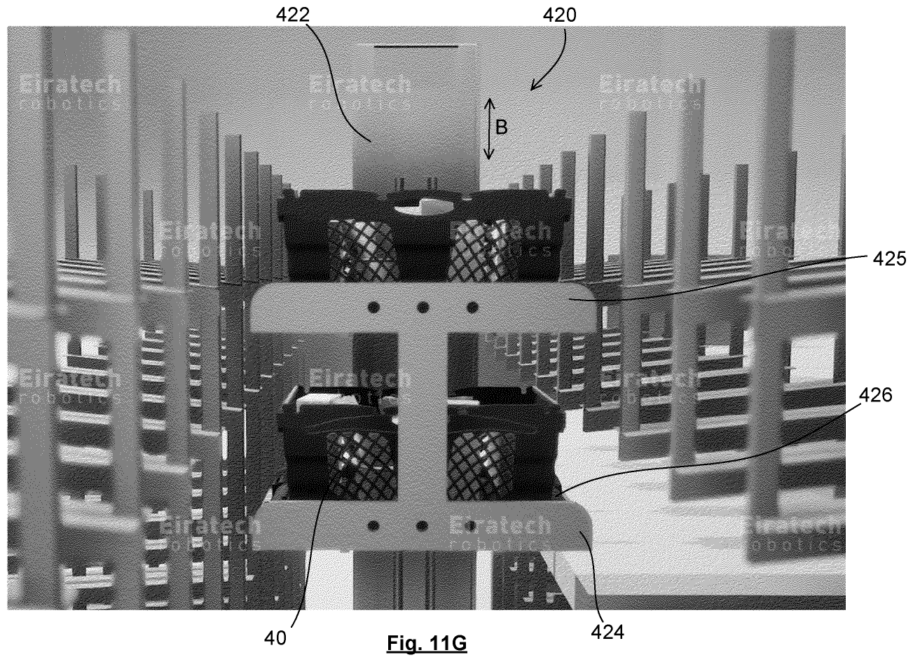

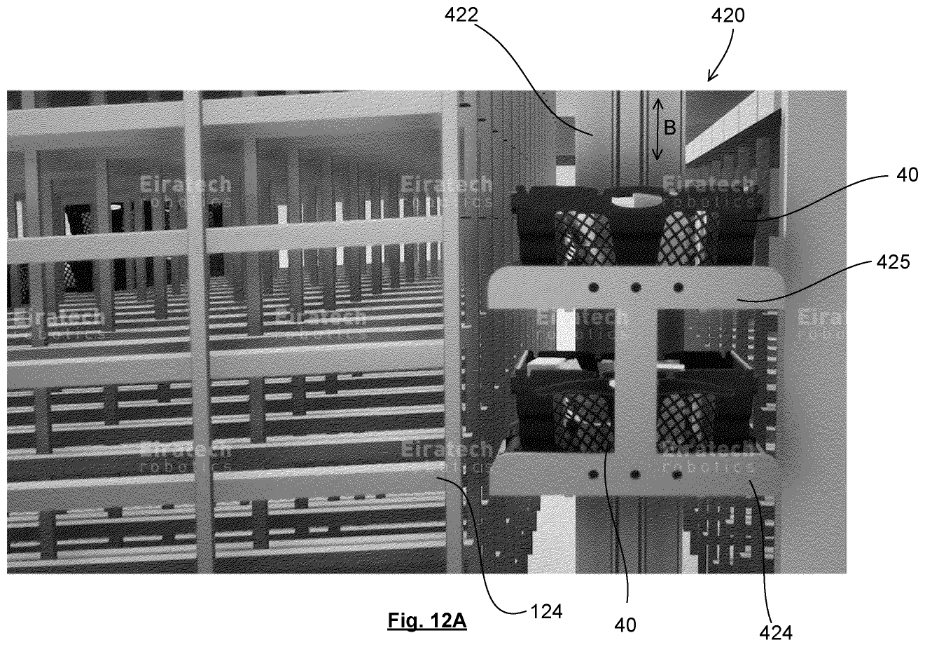

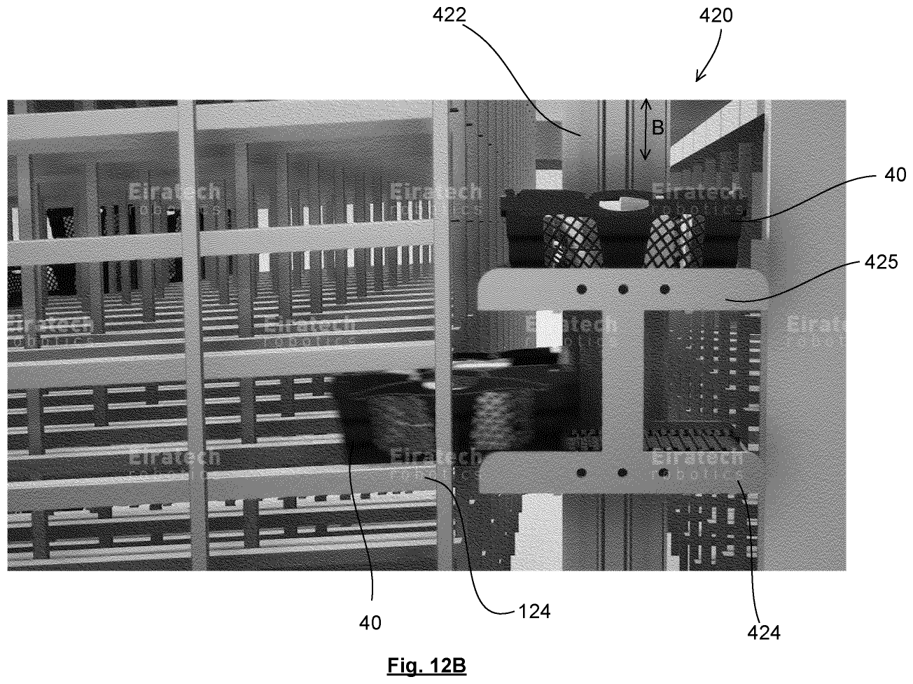

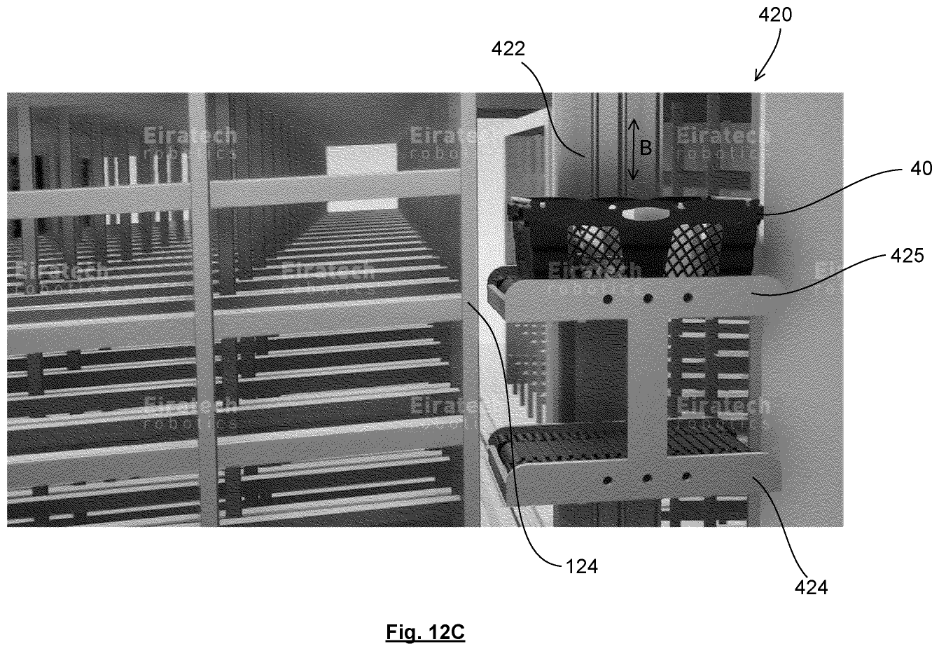

FIGS. 12A to 12D show the load apparatus shown in FIGS. 11D to 11G and a main support unit of the system shown in FIGS. 6A and 6B, the load apparatus being used to place items removed from the output buffer support unit in the main support unit;

FIGS. 13A and 13B both show two different perspective views of the main support unit, the output buffer support unit and the load apparatus of the system shown in FIGS. 6A and 6B, with all other components of the system (including the second level) removed;

FIGS. 14A to 14C show lift apparatus and an input conveyor of the system shown in FIGS. 6A and 6B, the lift apparatus receiving return items from the input conveyor;

FIGS. 14D and 14C show the lift apparatus shown in FIGS. 14A to 14C and a transport robot of the system shown in FIGS. 6A and 6B, the transport robot being used to remove items from the lift apparatus;

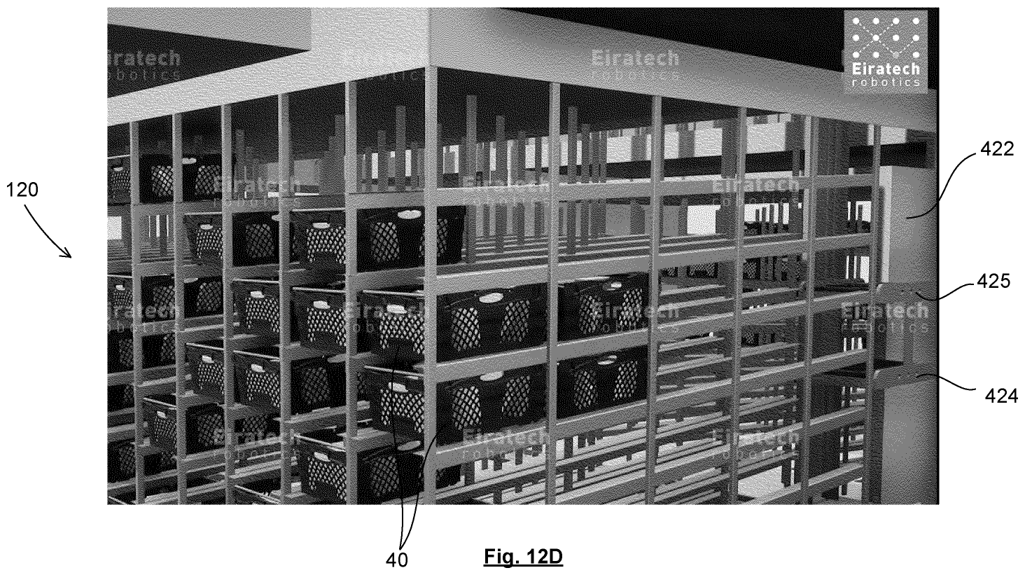

FIG. 15 shows a flow diagram for a general process for picking groceries and delivering them to customers of the type shown in FIG. 2 and which uses the system shown in FIGS. 6A to 14E;

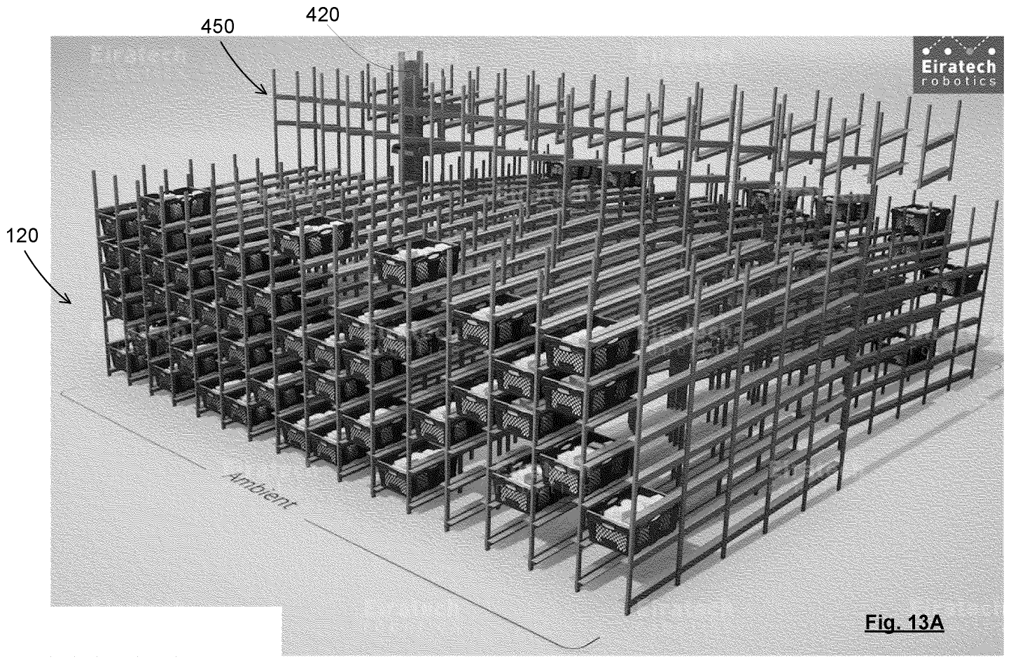

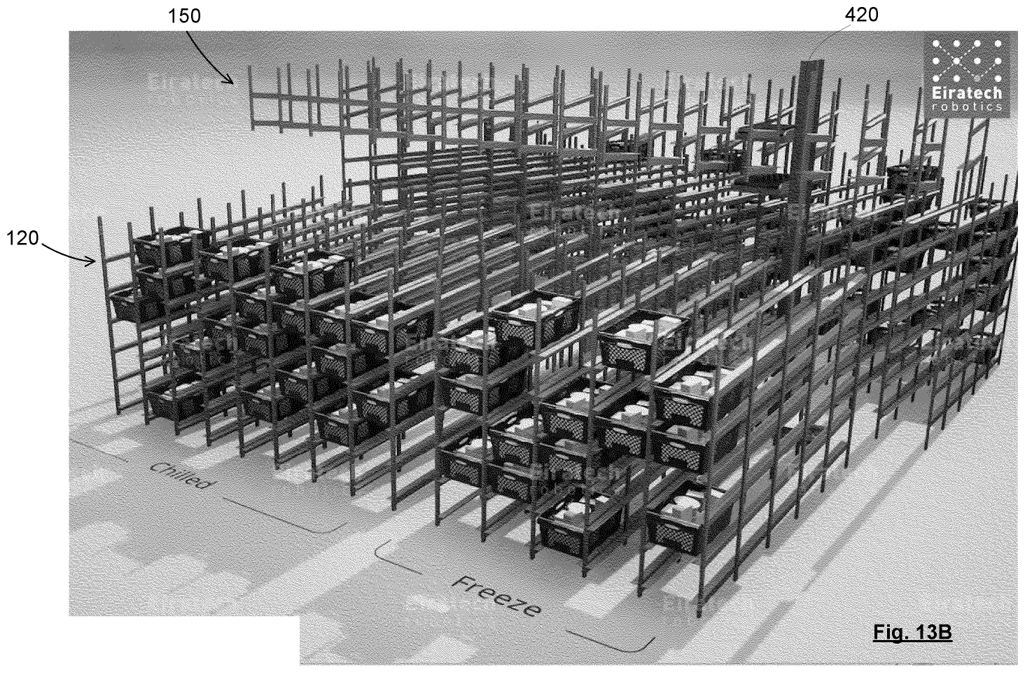

FIG. 16 is a schematic representation of a second embodiment of the system for receiving and sorting items shown in FIG. 1;

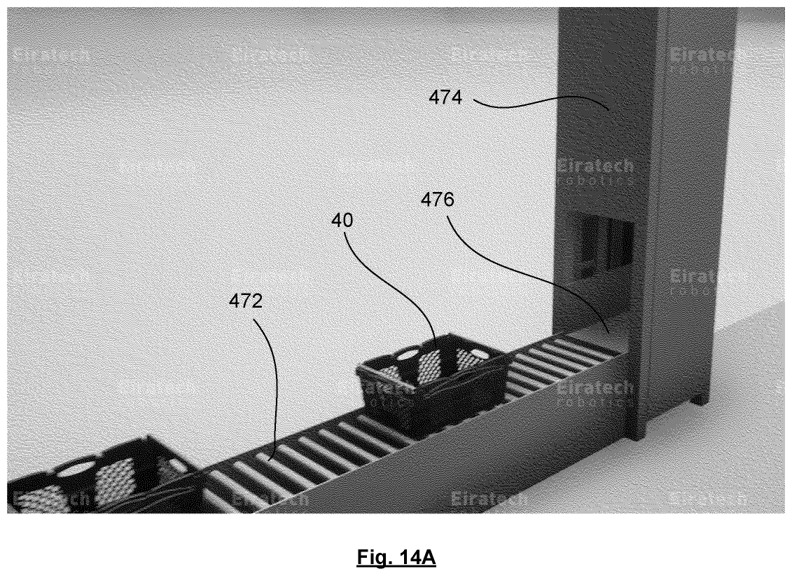

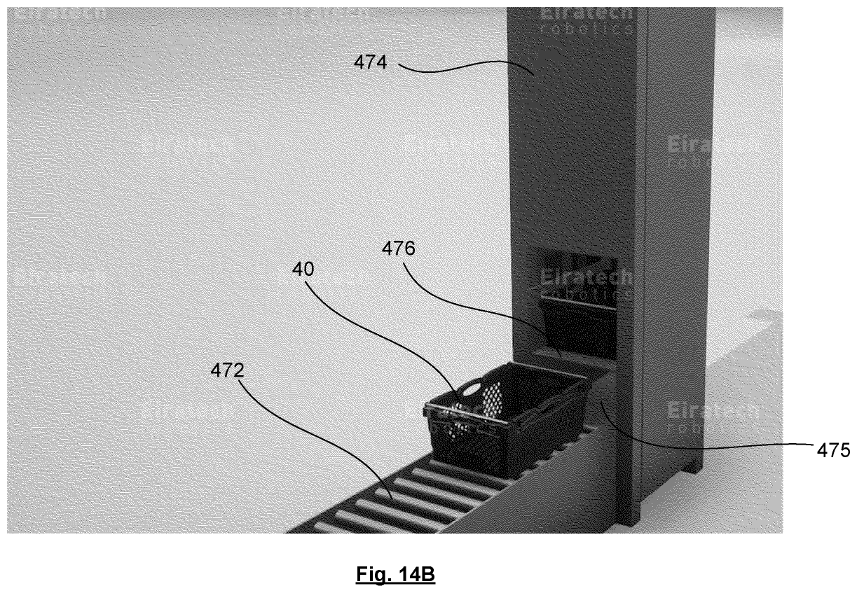

FIG. 17 is a schematic plan view of parts of a second embodiment of the system for receiving and sorting items shown in FIG. 16;

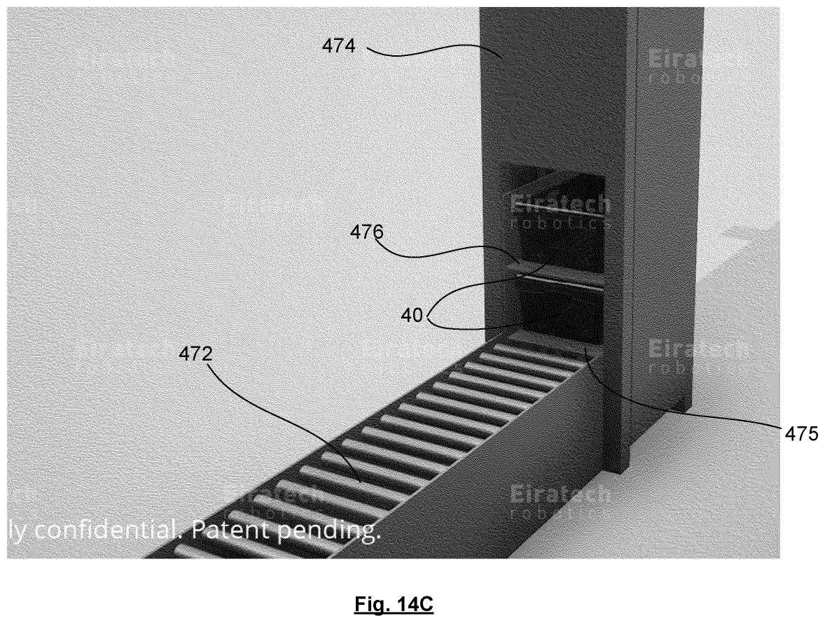

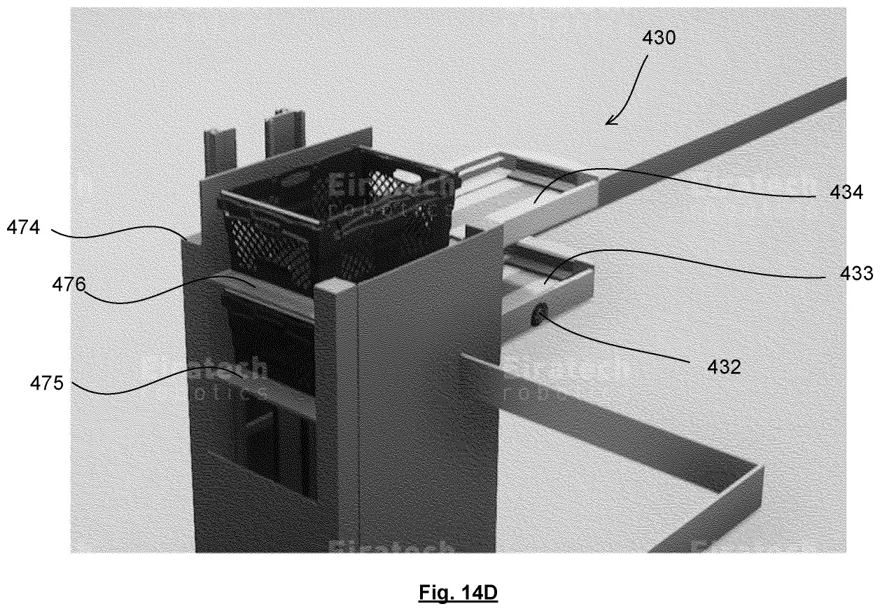

FIG. 18 is a schematic perspective views of parts of the second embodiment of the system for receiving and sorting items shown in FIG. 16;

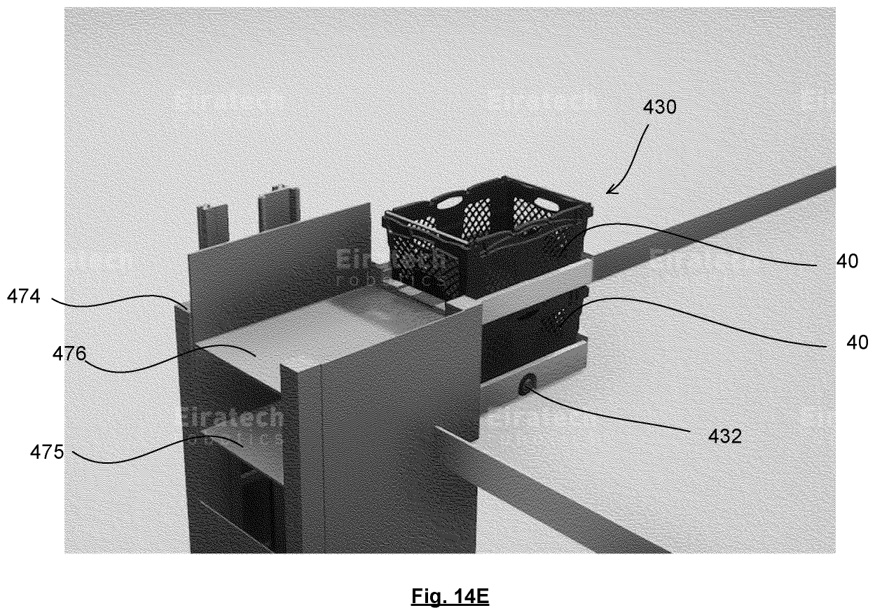

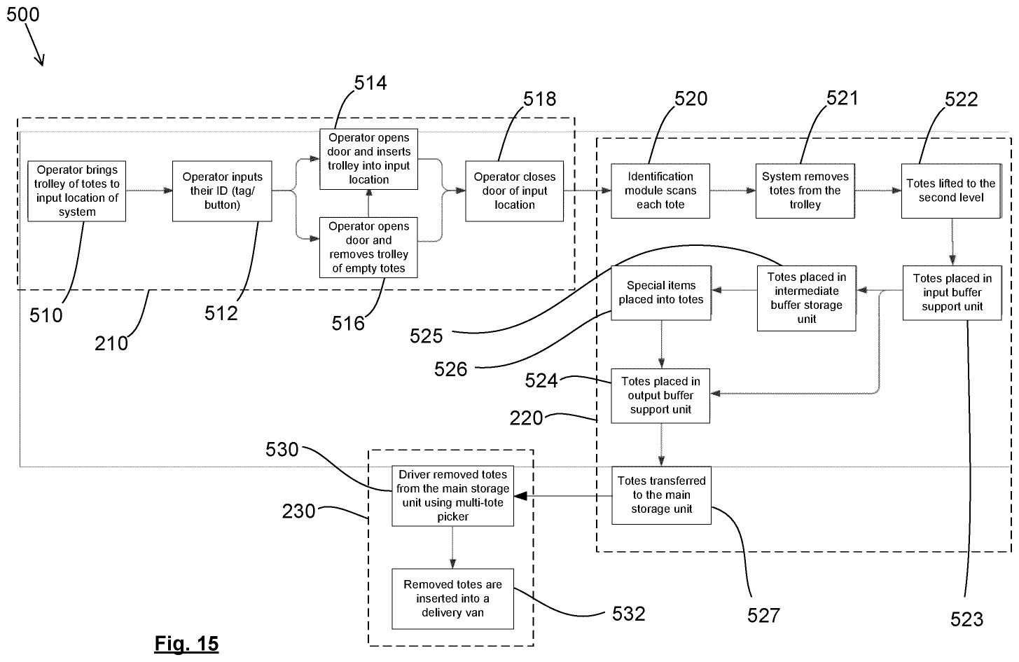

FIG. 19 is an enlarged perspective view of the input module of the system shown in FIGS. 17 and 19;

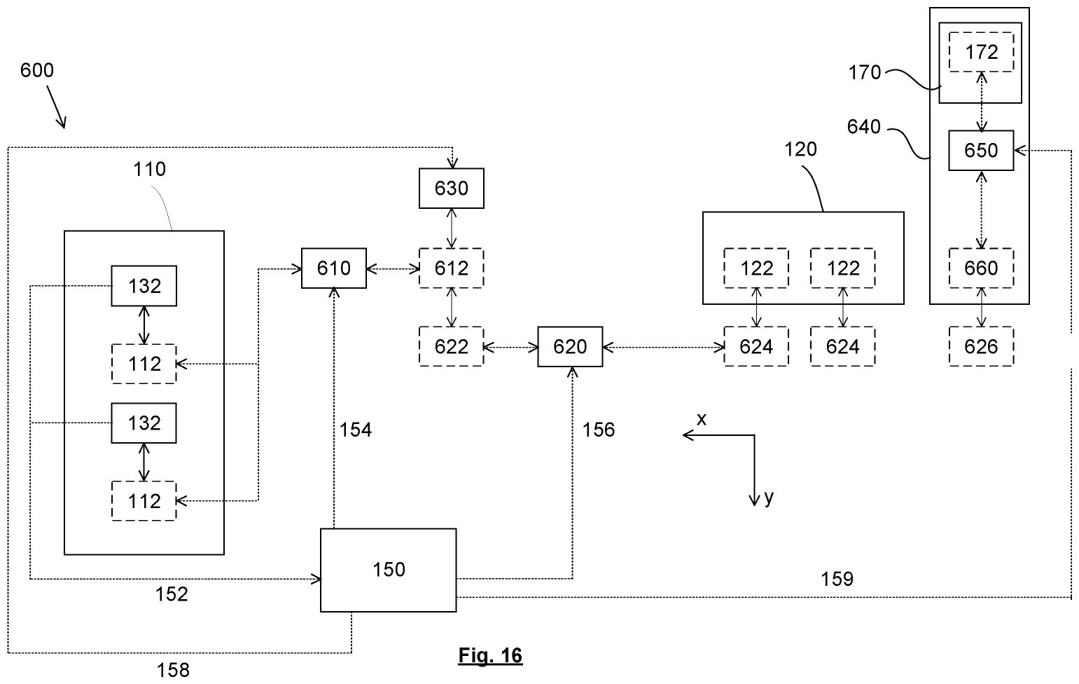

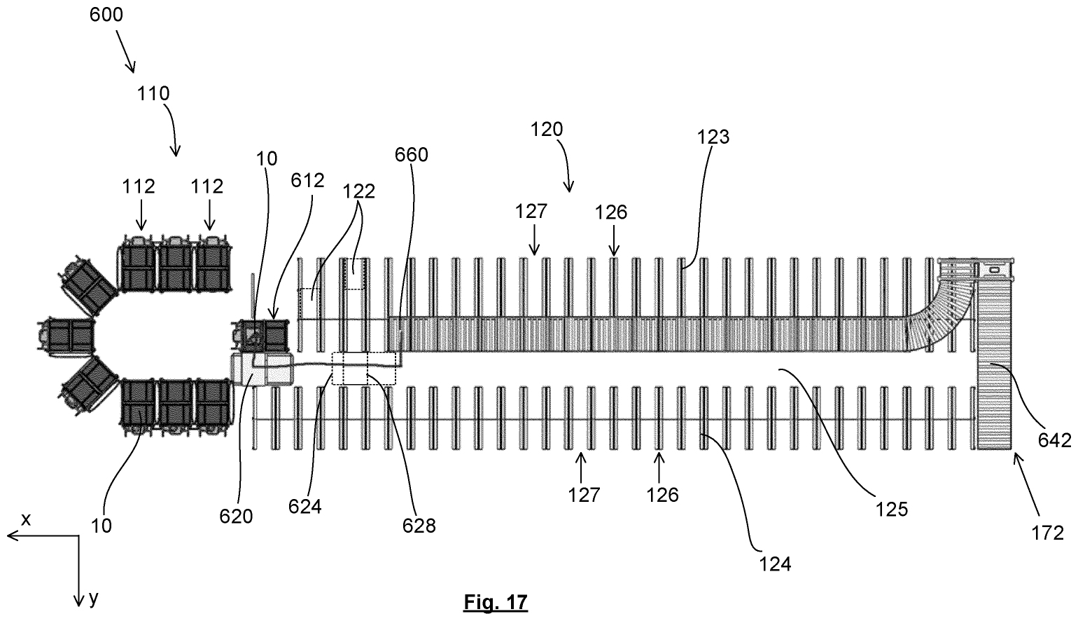

FIG. 20 is an enlarged perspective view of an empty input location of the input module of the system shown in FIGS. 17 and 18;

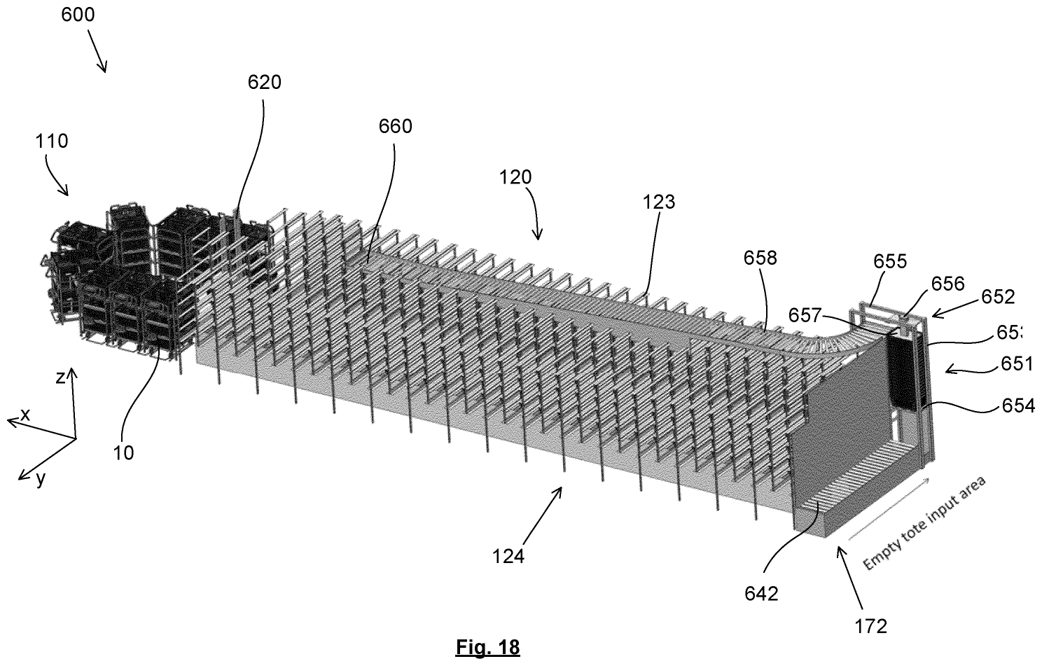

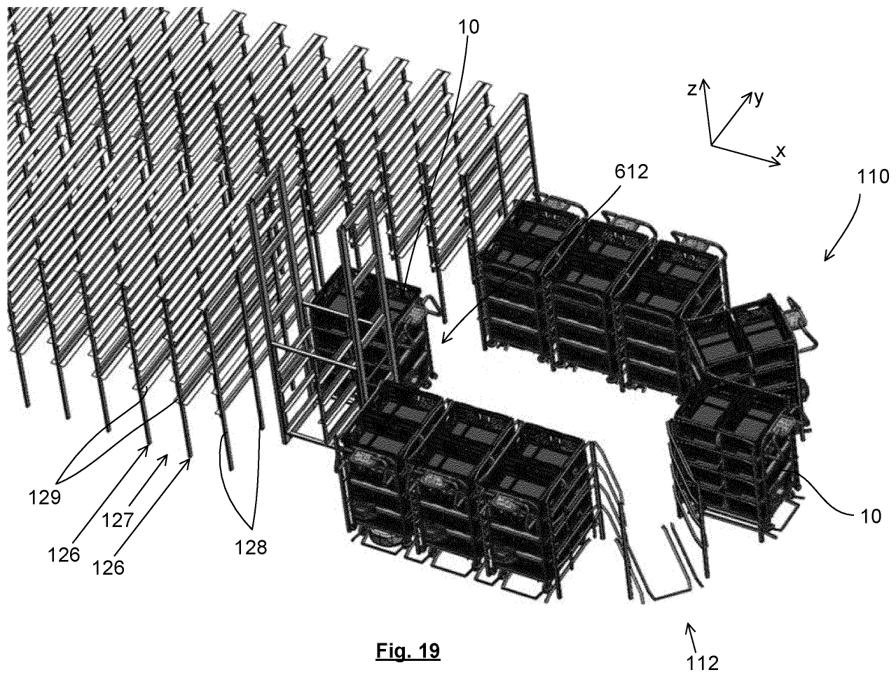

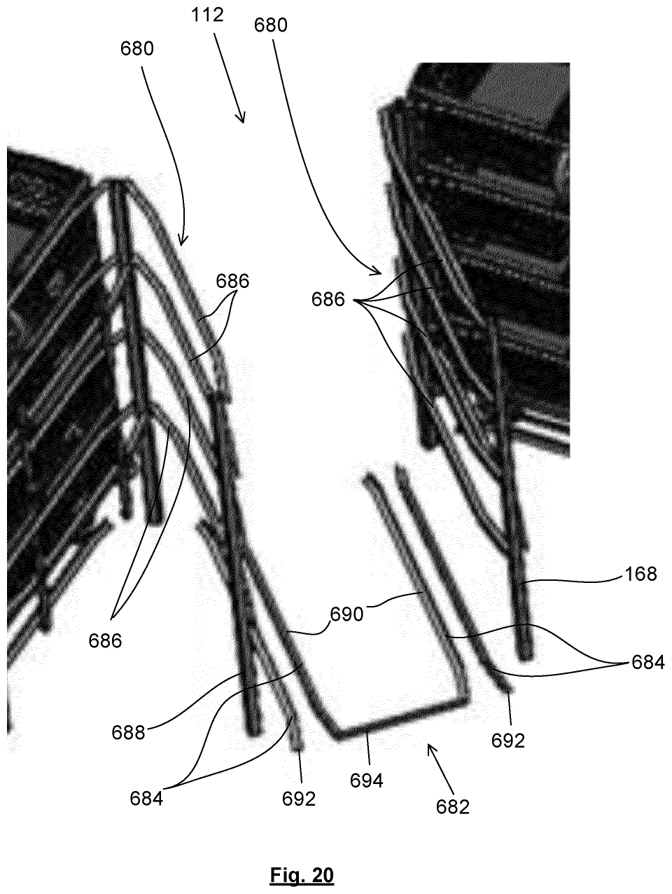

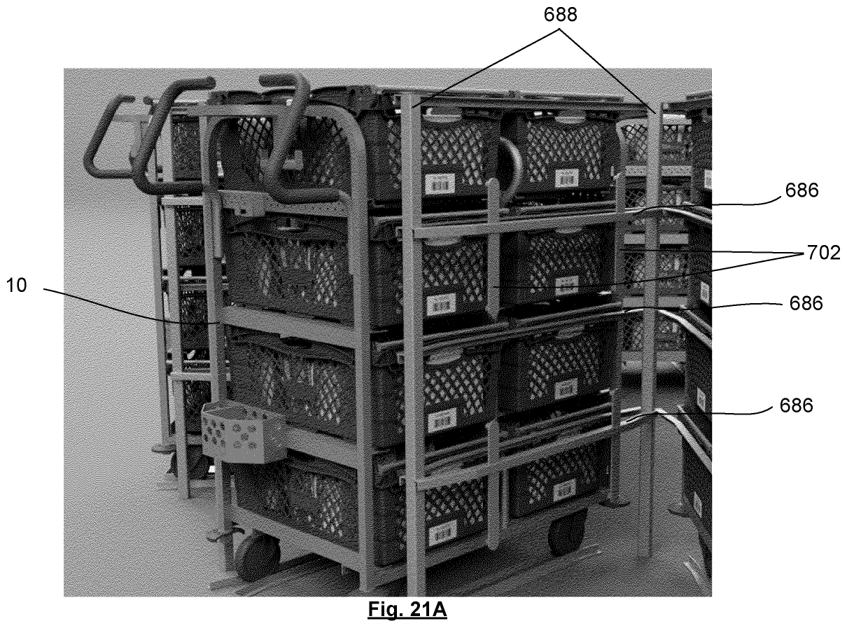

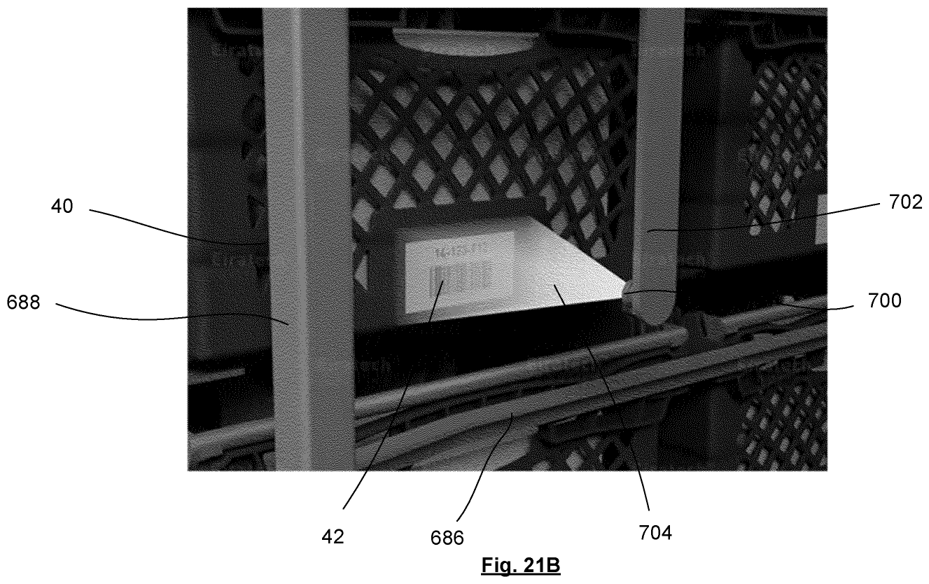

FIG. 21A shows an example mobile support unit disposed in an input module of the type shown in FIGS. 17 to 20, the input module having an identification submodule;

FIG. 21B shows an enlarged view of the identification submodule shown in FIG. 21A;

FIG. 22 shows an embodiment of a first automated device for use in the system shown in FIGS. 17 to 20;

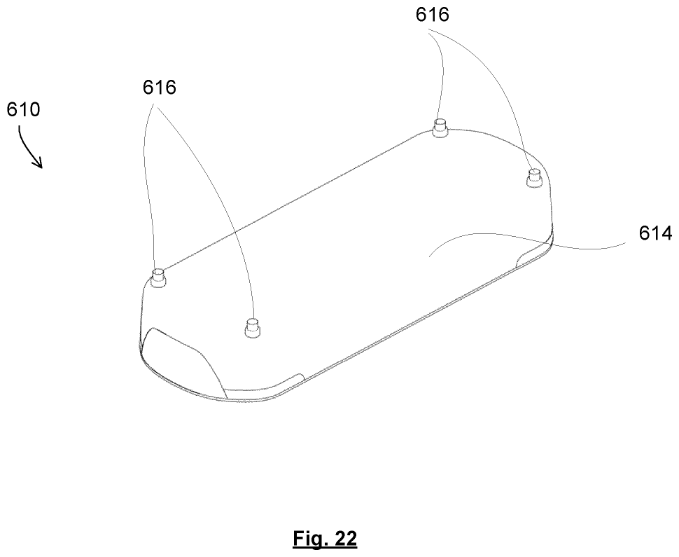

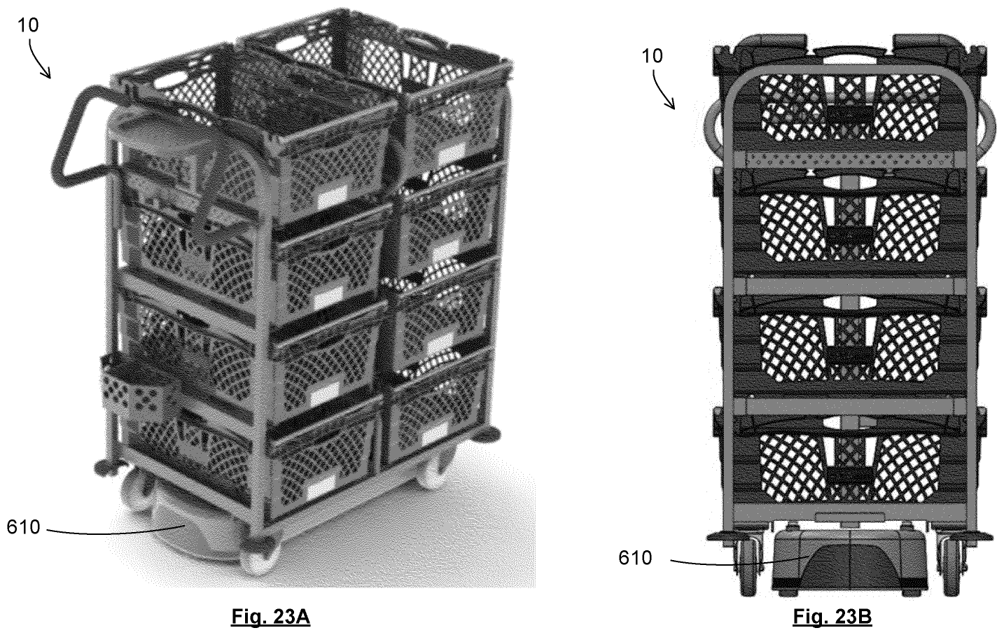

FIG. 23A is a perspective view of the first automated device shown in FIG. 22 supporting the example mobile support unit shown in FIG. 3;

FIG. 23B is a side view of the first automated device shown in FIG. 22 supporting the example mobile support unit shown in FIG. 3;

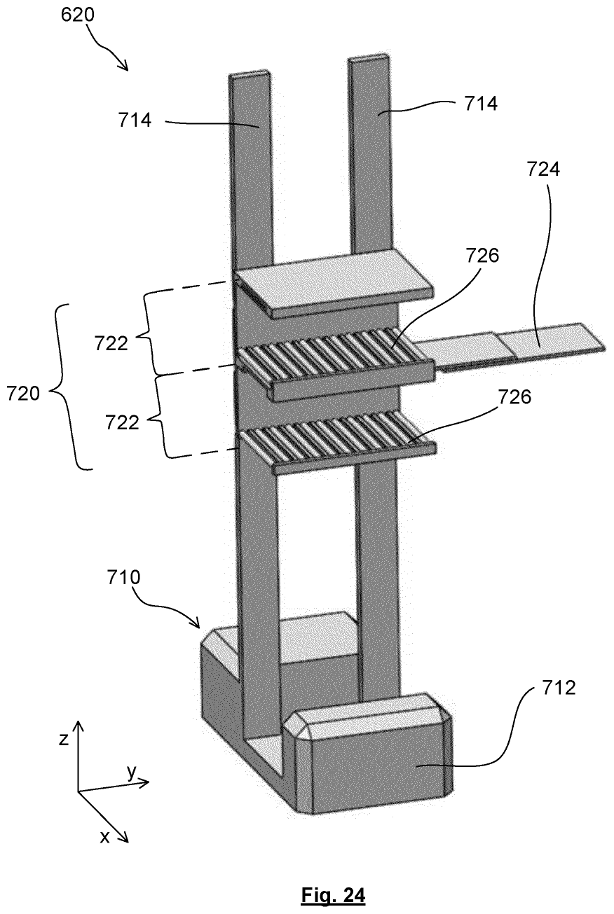

FIG. 24 shows an embodiment of a second automated device for use in the system shown in FIGS. 17 to 20;

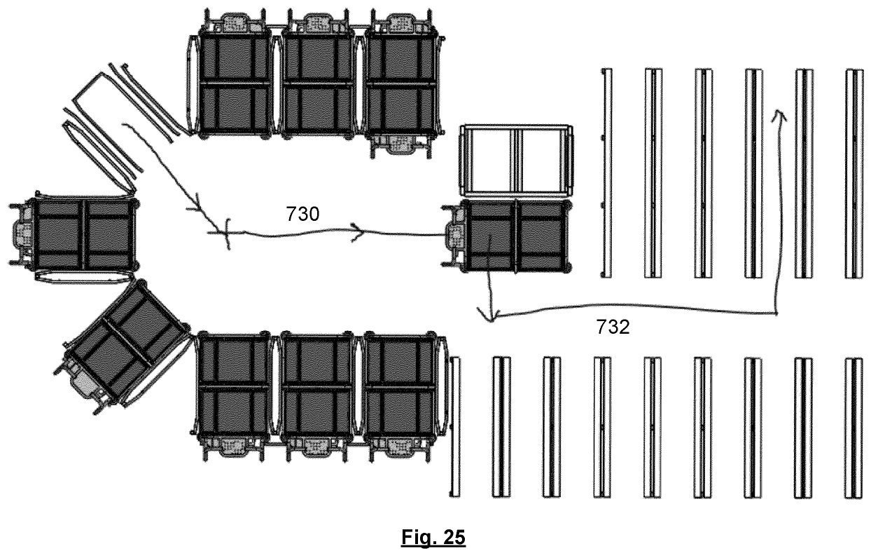

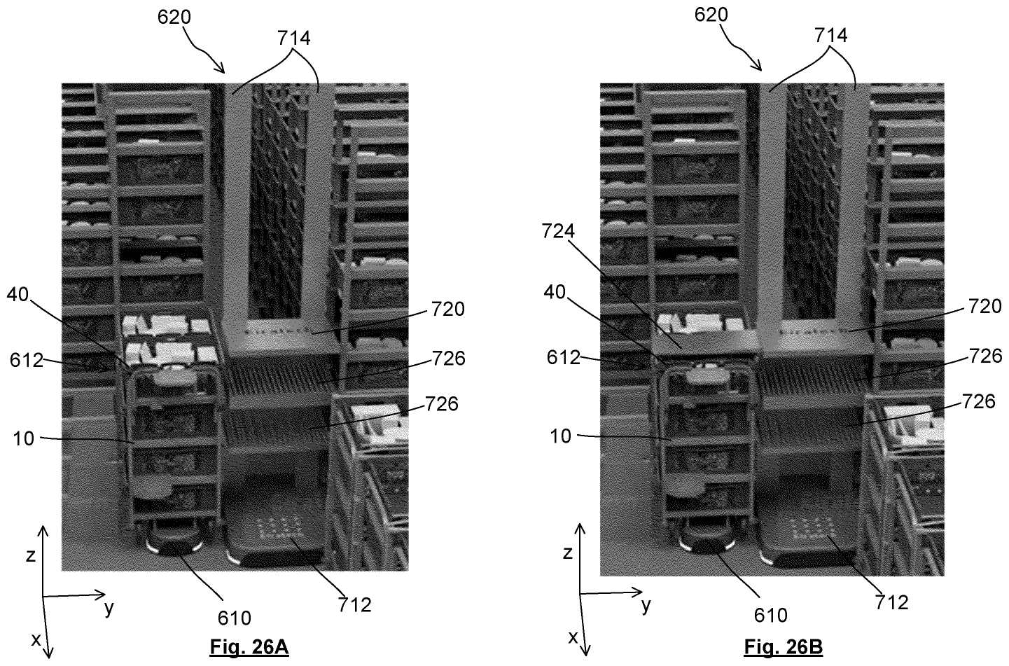

FIG. 25 is an enlarged portion of the embodiment of the system for receiving and sorting items shown in FIG. 17, indicating example movements of items within the system;

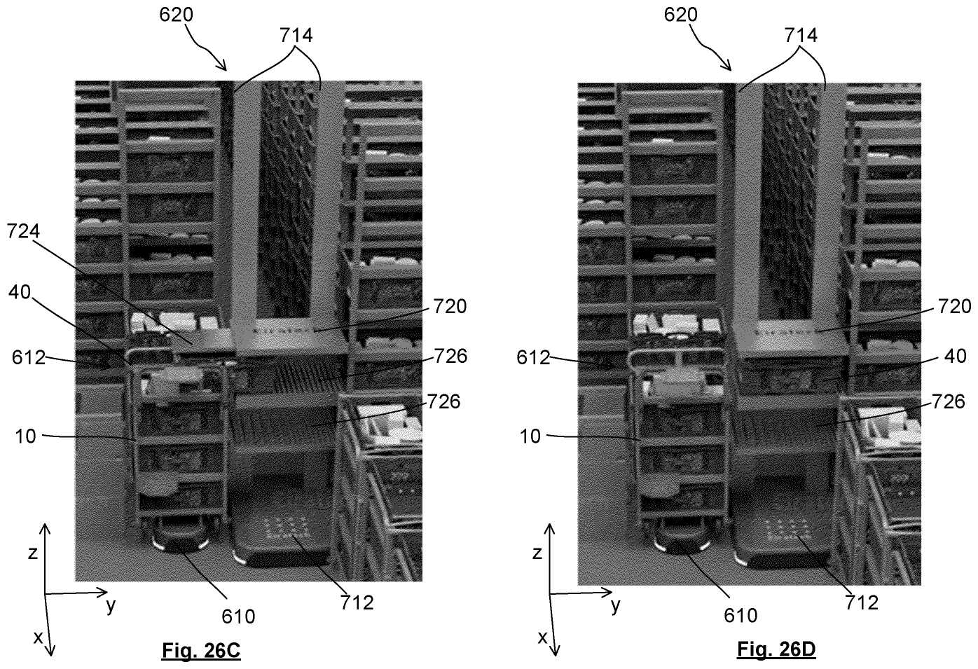

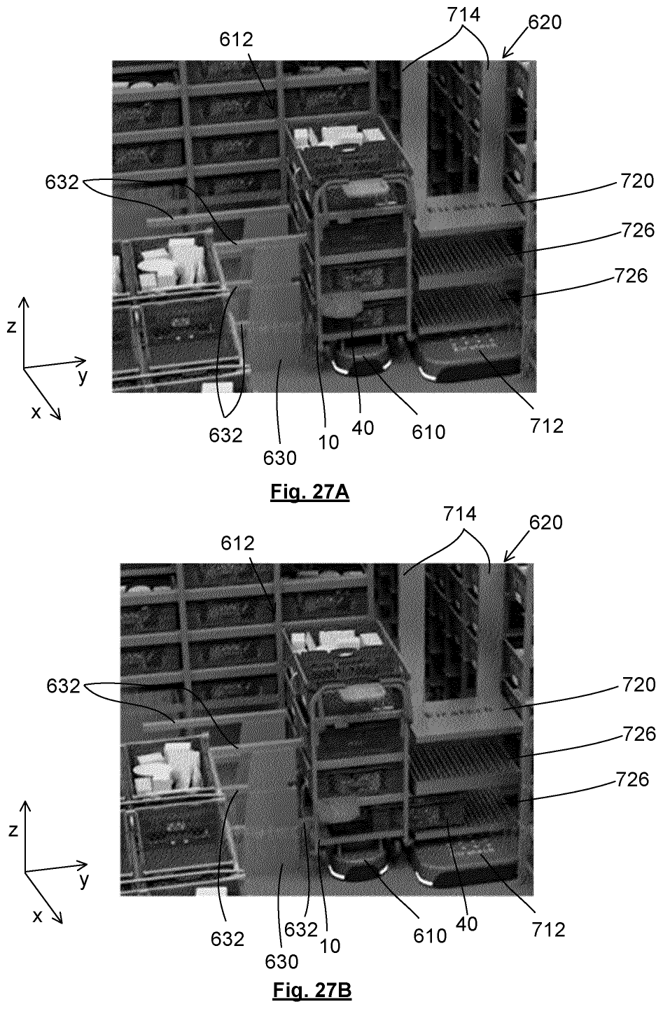

FIGS. 26A to 26D show sequential steps in the transfer of an item from a mobile support unit to the second automated device shown in FIG. 24;

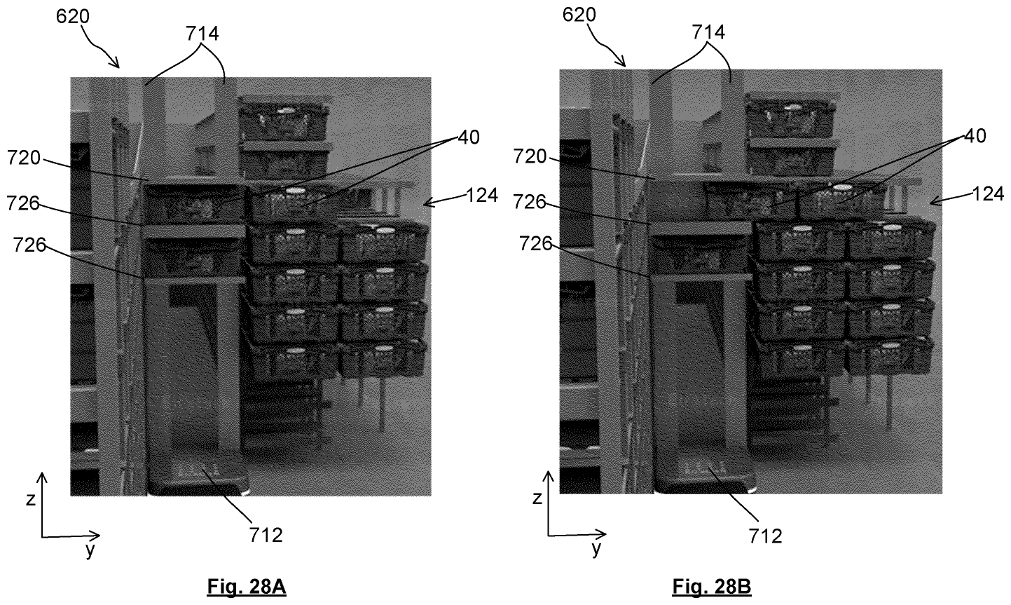

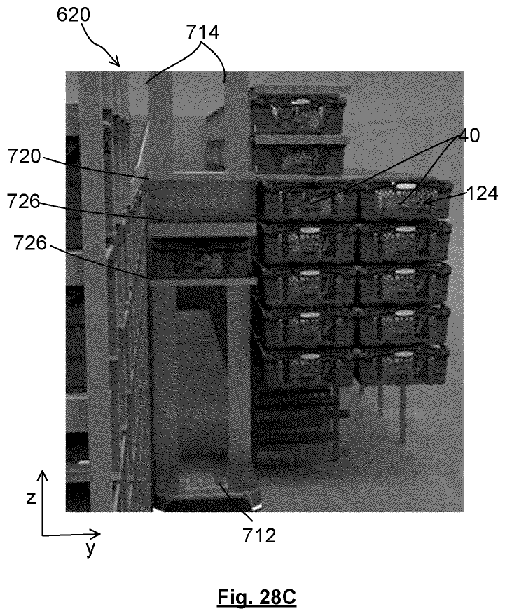

FIGS. 27A to 27B show sequential steps in an alternative transfer of an item from a mobile support unit to the second automated device shown in FIG. 24;

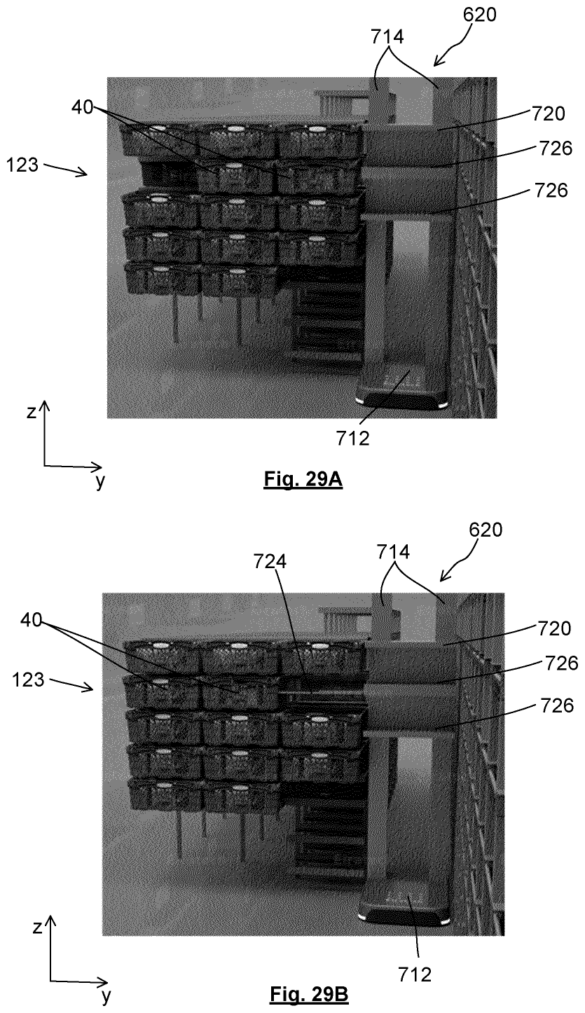

FIGS. 28A to 28C show sequential steps in the transfer of an item from the second automated device shown in FIG. 24 to a storage position of the main support unit;

FIGS. 29A to 29B show schematically how a movable member of the second automated device shown in FIG. 24 can be used to move an item from one storage position of the main support unit to another;

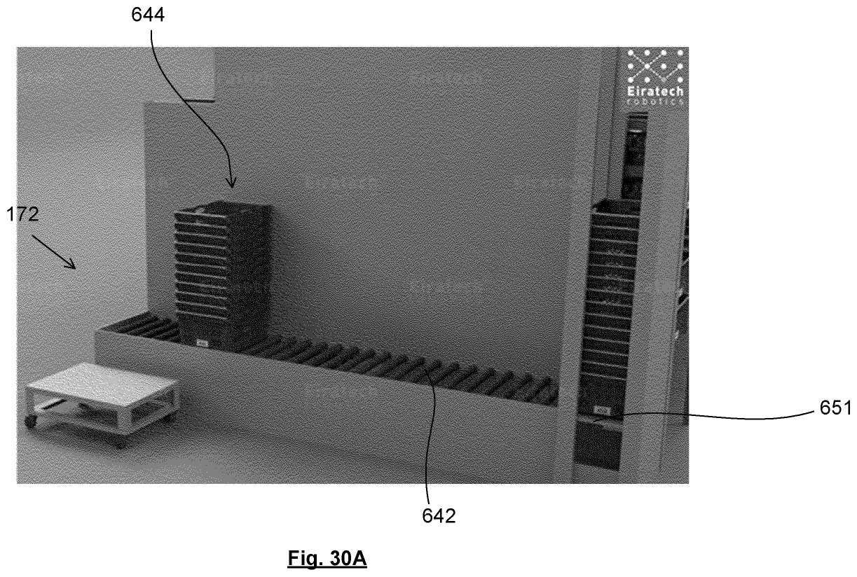

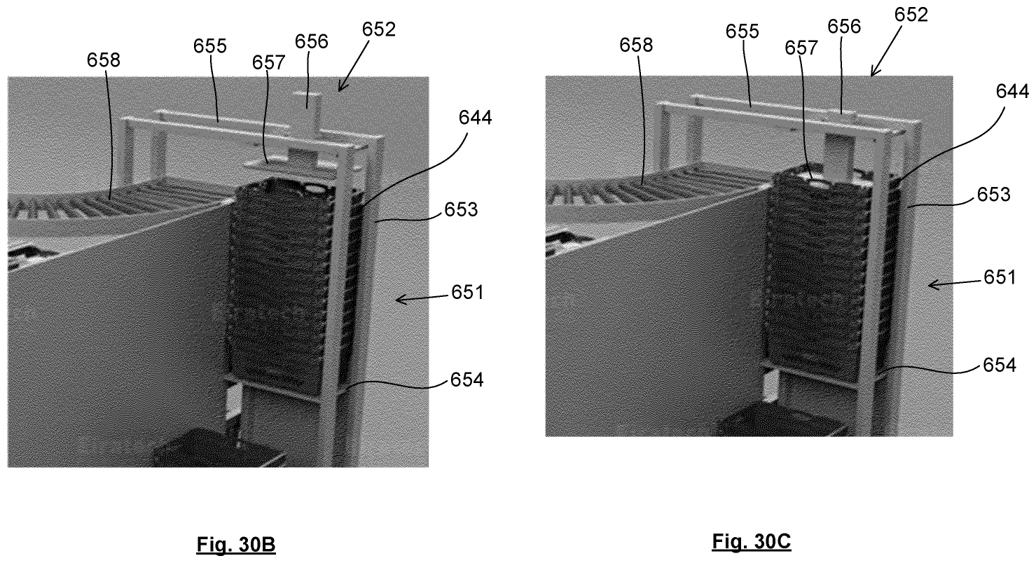

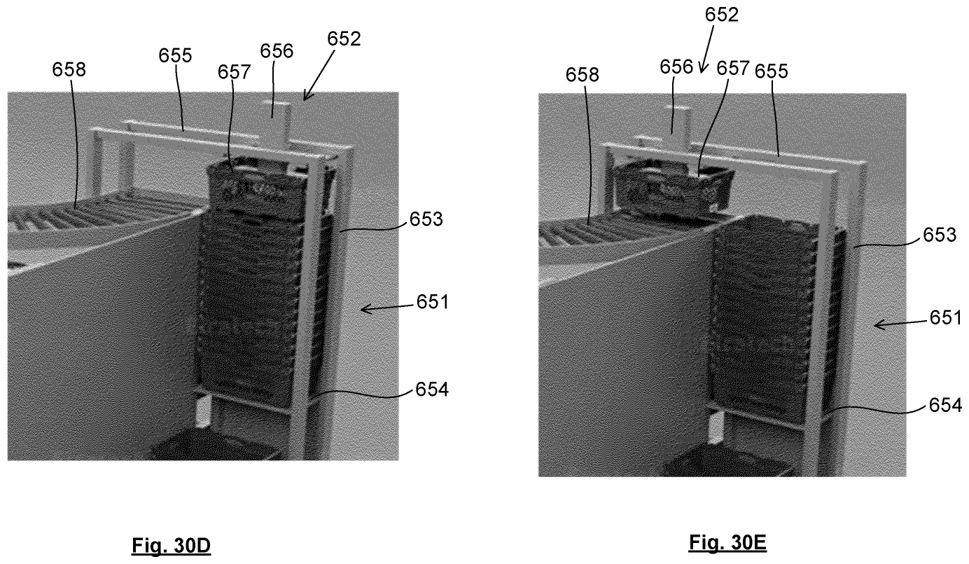

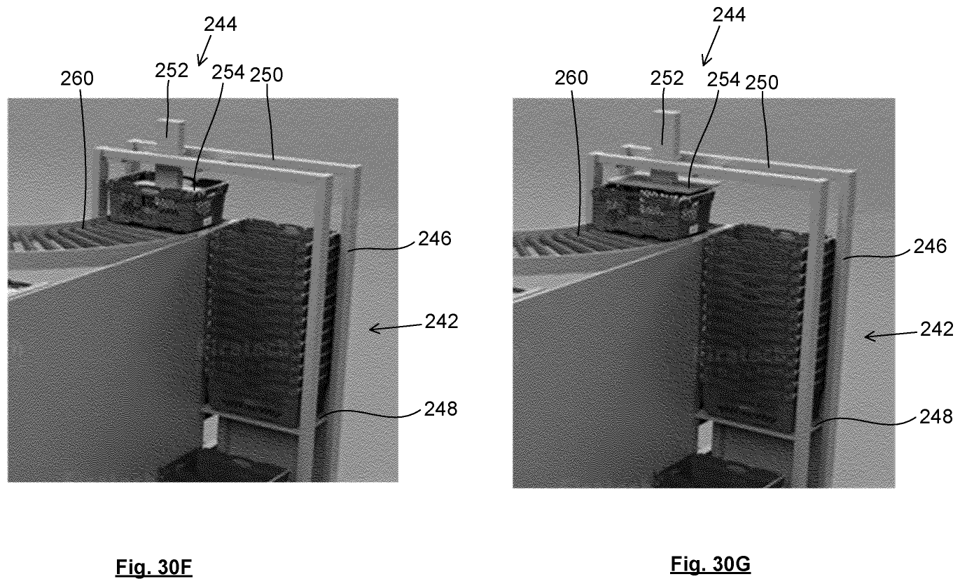

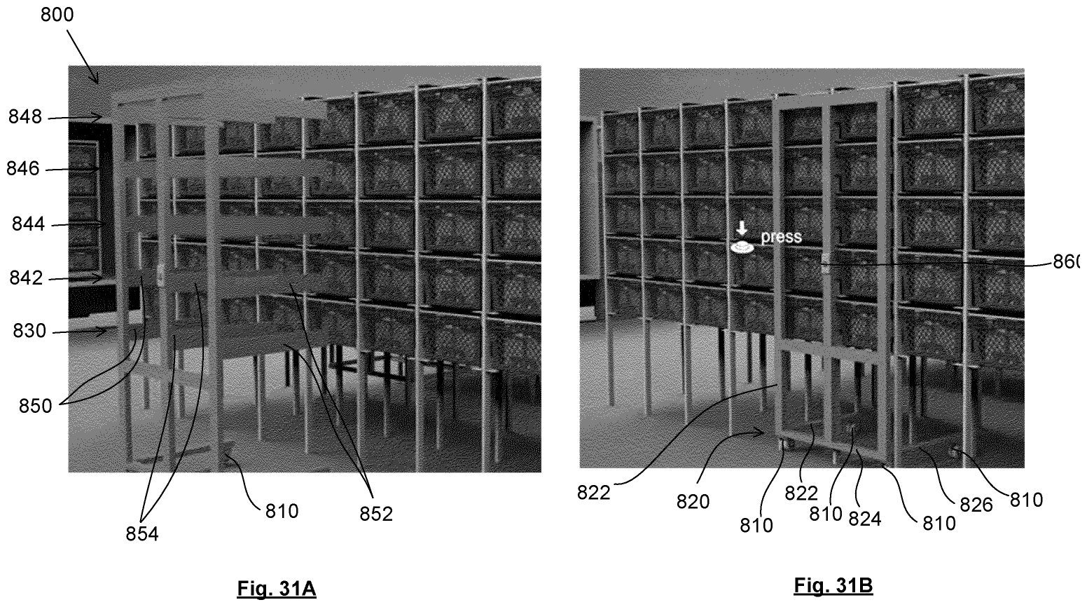

FIGS. 30A to 30G show sequential steps in the operation of a return system of the system shown in FIGS. 17 to 20; and

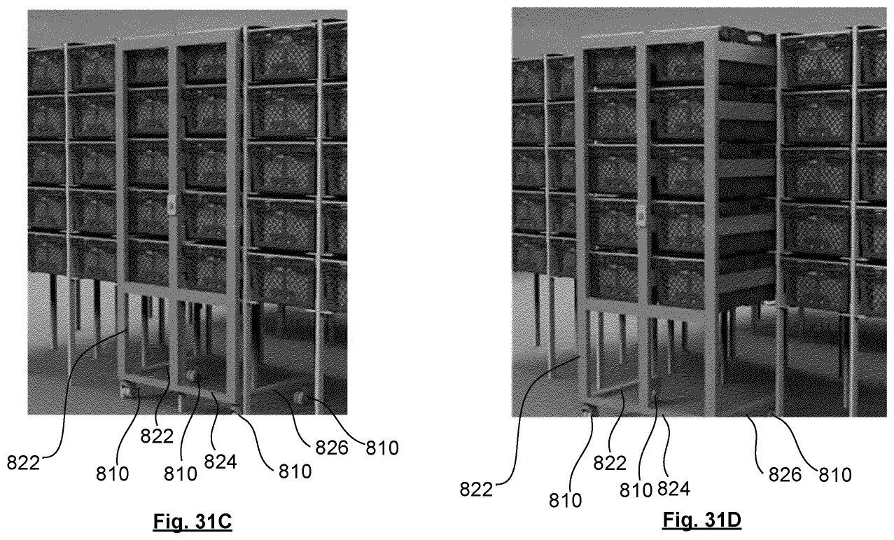

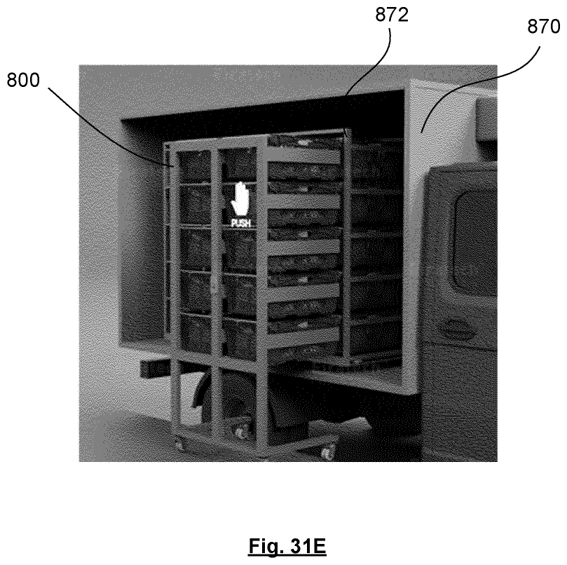

FIGS. 31A-31E show sequential steps in the transfer to items from the main support unit of the system shown in FIGS. 17 to 20 to a delivery vehicle.

FIG. 1 is a schematic representation of a system 100 for receiving and sorting items according to an embodiment of the present invention. The system 100 comprises: an input module 110; a main support unit 120; an identification module 130; automated apparatus 140; and a control module 150.

The input module 110 comprises at least one input location 112 arranged to receive a mobile support unit (for example a trolley) supporting a plurality of items (for example totes containing groceries).

The main support unit 120 comprises a plurality of storage positions 122. Each of the plurality of storage positions 122 is suitable for supporting an item (for example totes containing groceries).

The identification module 130 is operable to determine identification data from each item supported by a mobile support unit received by the input module 120. The identification module 130 may, for example, comprise at least one identification submodule, each such submodule comprising: an imaging system operable to form an image of a visual marker on an item supported at an identification location; and a processor operable to determine the identification data from said image. A common processor may be shared by a plurality of different imaging systems.

For example, the imaging system may comprise a camera operable to form an image of a marker on the item. The processor may be operable to execute suitable recognition software to identify a code from the image. Alternatively, any suitable form of identification module may be used, using, for example, bar codes, QR codes or the like.

Optionally, the input module 110 may comprise a plurality of input locations 112, each of the plurality of input locations 112 being arranged to receive a mobile support unit supporting a plurality of items. For such embodiments, the one or more identification submodules of the identification module 130 may be provided at each input location 112 and may be operable to determine the identification data for each item supported by a mobile support unit at that input location 112.

The automated apparatus 140 is operable to move an item (for example totes containing groceries) supported by a mobile support unit (for example a trolley) received by the input module 110 to one of the plurality of storage positions 122 of the main support unit 120. In will be appreciated that the automated apparatus 140 may comprise a plurality of automated submodules or robots for this purpose. In general, the automated apparatus 140 may comprise any combination of automated submodules or robots for this purpose.

In general, the automated apparatus 140 may comprise: (a) at least one unload apparatus operable to remove items supported by a mobile support unit received by the input module; (b) at least one load apparatus operable to move items to the main support unit; and (c) at least one transport robot operable to remove items supported by a supply apparatus and to deliver said items to a receiver apparatus. In some embodiments of the system 100, the automated apparatus 140 may comprise separate unload apparatus; load apparatus; and transport robot(s). This may be appropriate for embodiments wherein the system 100 receives and sorts a high volume or high throughput of items (for example totes containing groceries). In some embodiments of the system 100, the functionality of unload apparatus; the load apparatus; and the transport robot may be provided by a single apparatus or robot. This may be appropriate for embodiments wherein the system 100 receives and sorts lower volumes or lower throughputs of items (for example totes containing groceries).

In some embodiments, one unload apparatus may be provided to remove items supported by a mobile support unit received by any one of a plurality of input locations 112 of the input module 110. For such embodiments, the automated apparatus 140 may comprise at least one mobile support unit transporter operable to move a mobile support unit (for example a trolley loaded with totes) between the input locations 112 of the input module 110 and one or more unloading positions. Advantageously, such an arrangement may allow a plurality of input locations 112 to share unload apparatus.

This may allow the system 100 to enjoy the benefits of a plurality of input locations 112 whilst reducing a cost and/or complexity of the system 100. Such embodiments may have particular application for systems 100 having lower throughput or volume if items. The control module 150 is configured to receive the identification data from the identification module 130 for a plurality of mobile support units (for example trolleys) received by the input module 110. The plurality of mobile support units (for example trolleys) may in general be received by the input module 110 at different times. The control module 150 is further configured to control the automated apparatus 140 to move a plurality of items from each of the plurality of mobile support units received by the input module 110 each to one of the plurality of storage positions 122 of the main support unit 120. In particular, the control module is configured such that the storage position 122 of each item is selected in dependence on the identification data determined from that item by the identification module 130.

The control module 150 acts as a server operable to receive signals from the other parts of the system 100 and to send control signals to the other parts of the system 100. In general, any of the components of the system 100 may comprise a transmitter and a receiver to allow it to exchange signals with the control module 150.

The system 100 shown in FIG. 1 is advantageous, as now discussed. The provision of the automated apparatus 140 provides an arrangement for moving items (for example totes containing groceries) received at the input module 110 to the main support unit 120 under the control of the control system 140. Since the storage position 122 of each item is selected in dependence on the identification data determined from that item, advantageously, the items can be sorted according to the identification data. For example, it may be desirable to group items in a plurality of different groups in the main support unit 120 (each group may, for example, relate to a different customer and/or a different delivery van). For this purpose, the identification data may include a group identifier. Alternatively, the identification data may include a unique identifier for each item and the control module 150 may be operable to determine a group identifier from said unique identifier, for example using lookup data.

The storage position 122 of each item may be selected in dependence on the group identifier for that item.

Items with the same group identifier may, for example, be placed in one or more groups or clusters of adjacent storage positions 122 in the main support unit 120.

This sorting and/or grouping of items is in contrast to known automated storage and retrieval systems (ASRS) wherein each item may be stored in any suitable vacant storage position for later individual retrieval. In contrast, the system 100 of FIG. 1 allows for items to be grouped together such that all items in a given group can be retrieved easily in a group (for example to be loaded onto the same delivery van).

Further, the system 100 of FIG. 1 has separate and distinct input and output routes for items (via the input module 110 and the main support unit 120 respectively).

In some embodiments, the main storage unit 120 may be a one-way storage unit, as now discussed.

In some embodiments, each of the plurality of storage positions 122 is provided with an inlet and a separate outlet and the automated apparatus 140 is operable to move an item to one of the plurality of storage positions 122 of the main support unit 120 via said inlet. The outlets may be accessible by an operator or a robot such that items can be removed from the storage positions 122 via the outlets by such an operator or robot.

For example, the main storage unit 120 may comprise racks. The automated apparatus 140 may be operable to insert items into the racks from one side. The items may subsequently be accessed by an operator or robot from an opposite side of the racks. The outlet side of the racks may be referred to as a “pick face”.

In some embodiments, at least a subset of storage positions 122 comprise a common inlet and a common outlet. Such an arrangement is advantageous as it provides additional storage positions (that are not adjacent a common outlet) that provide a buffer for storage of items.

The system 100 may be operable to move items into the common inlet, through the subset of storage positions 122 to the common outlet for retrieval by an operator or robot. The subset of storage positions 122 may be arranged in a line and may be referred to as a line or row of storage positions.

For example, the main storage unit 120 may comprise racks having a depth suitable for accommodating a plurality items. A first item may be inserted (by the automated apparatus 140) into a common inlet of the racks to a first storage position of a subset of storage positions 122. Subsequently, a second item may be inserted (by the automated apparatus 140) into the same common inlet of the racks to the same first storage position of the subset of storage positions 122. The automated apparatus may continue to insert items into the common inlet until an item is disposed at all of the storage positions 122 of this subset of storage positions 122.

Once an item is disposed in the storage positions 122 of this subset of storage positions that is closest to the common outlet, this item may be accessed by an operator or robot from the “pick face”.

In some embodiments, the racks may be arranged such that support shelves or rails for the items are, in use, generally horizontal. With such an arrangement, when a second item is inserted (by the automated apparatus) into the same common inlet of the racks as a previously inserted first item, the second item may push the first item into the next storage position 122 between the common inlet and the common outlet.

Alternatively, in some embodiments, the racks may be arranged so as to be gravity-fed.

That is, the support shelves or rails for the items may be inclined such that an item inserted into a common inlet falls or slides under the action of gravity to the common outlet. For example, in use, the or each inlet may be disposed at a higher position than the or each associated outlet and the or each outlet may be provided with a latch mechanism. The latch mechanism may be arrangeable in a closed configuration in which an item disposed adjacent the outlet is prevented from passing through the outlet; and an open position in which an item disposed adjacent the outlet is allowed to pass through the outlet. For example, the main storage unit may comprise a racking system that is generally of the form of a first in, first out (FIFO) racking system.

Advantageously, this allows items to be accessed from the outlet (or common outlets) without having to wait until all of the storage positions 122 between the inlet and the outlet are occupied by items.

The control module 150 may be configured such that the storage position 122 of each item is selected such that the items are sorted or grouped according to the identification data in dependence on the identification data determined from that item (by the identification module 130).

In some embodiments, the plurality of storage positions 122 comprises a plurality of different subsets of storage positions and the control module 150 may be configured such that the subset of storage positions from which the storage position 122 of each item is selected to be is selected in dependence on the identification data determined for that item. For example, each subset of storage positions 122 may comprise a block of adjacent storage positions 122. As discussed further below, as used here, adjacent storage positions 122 is intended to mean adjacent in any direction. Each item may be placed by the system 100 in a specific subset or block of storage positions based on the identification data determined for that item (for example, based on which delivery van these totes will be placed in and where in the delivery van they are to be placed).

In some embodiments, the identification data includes at least one group identifier. The control module 150 may be configured such that the storage position 122 of each item is selected in dependence on the group identifier determined from that item. The group identifier may, for example, indicate a delivery van associated with that item. Additionally or alternatively, the group identifier may, for example, indicate a customer associated with that item. For example, the control module 150 may be configured such that a subset of storage positions 122 from which the storage position 122 of each item is selected to be is selected in dependence on the group identifier (for example a delivery van identifier) determined for that item.

In some embodiments, the identification data includes at least one subgroup identifier. The control module 150 may be configured such that the storage position 122 of each item is selected in dependence on the subgroup identifier determined from that item. The subgroup identifier 122 may, for example, indicate a target position in a delivery van associated with that item. For example, the control module 150 may be configured such that a position within a selected subset of storage positions 122 for each item is selected in dependence on the subgroup identifier (for example a target position in a delivery van associated with that item) determined for that item.

In some embodiments, the identification data includes a group identifier and at least one subgroup identifier. In one particular embodiment, each subgroup comprises a plurality of items that may be transferred from the main storage unit 120 to a delivery van together (for example using a multi-tote picker, as discussed further below). To facilitate this, all of the items in a subgroup may be placed in a block of adjacent, accessible storage positions 122 (for example a two-dimensional block of storage positions 122 at a pick-face of the main storage unit 120) by the control module 150.

Other subgroups within the same group may also be placed in a block of adjacent, accessible storage positions 122 (for example a two-dimensional block of storage positions 122 at a pick-face of the main storage unit 120) by the control module 150 either at the same time (for example using a different part of the pick-face), or at a different time (for example using the same part of the pick-face), as now discussed.

In a first example, each subgroup may be placed by the system such that each subgroup occupies a different block of adjacent, accessible storage positions 122 (for example a two-dimensional block of storage positions 122 at a pick-face of the main storage unit 120). Advantageously, a delivery van driver may extract each subgroup of items from the main storage unit 120 and transfer them to a delivery van in a desired sequence. However, such an embodiment would mean than all of the items for a single delivery van cover a larger portion of the pick-face of the storage unit 120. Consequently, this may limit the number of delivery vans than can be loaded with items simultaneously.

In a second example, each subgroup may be placed by the system such that a first subgroup occupies a single block of adjacent, accessible storage positions 122 (for example a two-dimensional block of storage positions 122 at a pick-face of the main storage unit 120) and all of the other subgroups are disposed behind the first subgroup. A delivery van driver may extract the first subgroup of items from the main storage unit 120 and transfer them it to a delivery van. Once the first subgroup of items has been removed from the single block of adjacent, accessible storage positions 122 of the main storage unit 120, a second subgroup of items may be moved into the single block of adjacent, accessible storage positions 122 of the main storage unit 120 (either under control of the control module 150 or under gravity). The subgroups may be arranged or sequenced in the main storage unit 120 according to where in the delivery van they are to be placed. For example, earlier subgroups may be items that are to be placed into the delivery van earlier (for example at the back of the delivery van) and later subgroups may be items that are to be placed into the delivery van later (for example at the front of the delivery van near the door). Advantageously, such an embodiment would mean than all of the items for a single delivery van cover a smaller portion of the pick-face of the storage unit 120. Consequently, this may maximize the number of delivery vans than can be loaded with items simultaneously. However, such an embodiment may mean that a depth of the main storage unit 120 needs to be sufficient to accommodate all of the items for a single delivery van.

It will be appreciated that other embodiments may be a combination the first example (where each subgroup is placed by the system such that each subgroup occupies a different block of adjacent, accessible storage positions 122) and the second example (where each subgroup is placed sequentially by the system such that it occupies a single block of adjacent, accessible storage positions 122). In general, the sequencing may be performed so that the number of delivery vans that can be simultaneously loaded with items from the main storage unit 120 is maximized for a given depth of the main storage unit 120.

In some embodiments, the system 100 comprises at least two levels with the input locations 112 of the input module 110 being provided on a first level and the automated apparatus 140 being operable to move an item supported by a mobile support unit received by the input module 110 to one of the plurality of storage positions 122 of the main support unit 120 via a second level.

Advantageously, such a system 100 may allow the input module 110 to be integrated with a shop floor (on the first level) whilst the bulk of the transportation of items between the input module 110 and the main support unit 120 to be performed on the second level (where it will not interfere with the shop floor).

For embodiments wherein the system 100 comprises at least two levels, the or each unload apparatus of the automated apparatus 140 may be operable to move items from a mobile support unit disposed on the first level to a first location on the second level. That is, the unload apparatus may be generally of the form of a lift. Items may be transferred directly from the unload apparatus onto another robot (for example a transport robot) operable to move the items to a second location on the second level.

Alternatively, items may be transferred from the unload apparatus to an input buffer support unit for subsequent collection by another robot (for example a transport robot) operable to move the items to a second location on the second level. The first location may be adjacent an input of the input buffer support unit.

For embodiments wherein the system 100 comprises at least two levels, the load apparatus of the automated apparatus 140 may be operable to move items from a location on the second level to the main support unit disposed on the first level.

That is, the load apparatus may be generally of the form of a lift. Items may be transferred directly to the load apparatus from another robot (for example a transport robot) operable to move the items on the second level. Alternatively, items may be transferred to the load apparatus from an output buffer support unit, having been previously deposited on the output buffer support unit by another robot (for example a transport robot) operable to move the items to on the second level.

For embodiments wherein the system 100 comprises at least two levels, the or each transport robot may be operable to move items between two locations on the second level. That is, transport robots may be operable to move the items on the second level.

Items may be transferred to the second level by the unload apparatus and may be returned to the first level by the load apparatus.

For embodiments wherein the system 100 comprises at least two levels, the main support unit 120 may be disposed at the first level.

The input location 112 or, where there is a plurality of input locations 112, each input location may comprise various optional features. For example, each input location 112 may comprises an indicator operable to display a status of the input location, which may allow an operator to determine whether or not that the input location 112 is available.

In some embodiments, each input location 112 may comprise an access door that can be opened for a mobile support unit supporting a plurality of items to be inserted into the input location 112; and a closed position in which access to the input location is restricted. The door may be disposed in an open position when the input location is available to allow mobile support unit supporting a plurality of items to be placed into the input location. Once a mobile support unit supporting a plurality of items has been placed into the input location, the door may be moved (for example under control of the control module 150) to a closed position, preventing an operator from accessing the mobile support unit. Advantageously, such an access door provides a safety feature since it can prevent operators from being harmed by the operation of the automated apparatus.

Alternatively, in some embodiments, the or each input location and the mobile support unit may be arranged such that when the mobile support unit is disposed in the input location 112, the input location 112 is inaccessible by a user. For example, the mobile support unit may comprise a barrier that may form a close fit with an aperture of the input location 112 so as to close access to the input location 112. For such embodiments, the or each input location 112 may comprise an engagement mechanism that may be operable (for example under the control of the control module 150) to releasably engage a mobile support unit when disposed in the input location so as to releasably lock it in position.

In some embodiments, each input location 112 may comprise a user controllable actuator mechanism operable, in response to an input from a user, to move the door from the closed position to the open position. For example, the user controllable actuator mechanism may comprise a lock, for example a remote keyless lock, and the input from the user may be sent using a keyfob or access ID card of the like.

Alternatively, the user controllable actuator mechanism a keypad and the input from the user may be provided by inputting an access code.

In some embodiments, each input location 112 may comprise an alignment structure arranged to aid the placement of a mobile support unit in an alignment position. In some embodiments, each input location 112 may comprise a guide structure arranged to help guide a mobile support unit to an alignment position. In some embodiments, each input location 112 may comprise an engagement mechanism arranged to secure a mobile support unit in an alignment position.

In some embodiments, each input location 112 may comprise two side structures which define between them a volume for receipt of a mobile support unit. For such embodiments, the identification module 130 may comprise one or more sensors supported by the side structures of the input location 112.

In some embodiments, each input location 112 may comprise a base structure comprising at least one pair of guide rails for receipt of at least one wheel of a mobile support unit. Each pair of guide rails may be shaped such that a distance between the pair of rails is smaller in a central region than at each end of the input location 112. Advantageously, the central regions of the pairs of guide rails may constrain the mobile support unit in an alignment position while the tapered or flared end portions help the insertion of the mobile support unit into the input location 112 from either side.

Optionally, the system 100 may further comprise at least one buffer support unit 160 comprising a plurality of buffer storage positions 162 suitable for supporting an item (for example a tote). The automated apparatus 140 may be operable to move an item supported by a mobile support unit received by the input module 110 to one of the plurality of storage positions 122 of the main support unit 120 via at least one of said plurality of buffer storage positions 162.

The provision of at least one buffer support unit 160 advantageously provides an additional buffer storage for the system 100. Advantageously, this allows greater flexibility to sort the items such that they are placed into the main support unit 120 at storage positions selected 122 in dependence on the identification data determined from that item. As explained above, the system 100 may have application in an online grocery shopping system. For example, the items may comprise totes or tote boxes and the mobile support units that can be received by the input module may each comprise a trolley for supporting totes. In general, the totes on each trolley comprise totes for a plurality of different customer orders all containing goods that are located in relatively close proximity to one another. An order for a single customer may be distributed over a plurality of such trolleys (as this may improve the efficiency of the picking process). The system 100 may receive a plurality of different trolleys, unload the totes from them and place them onto the main support unit 120 such that they are now grouped according to which delivery van will be used to transport them to the relevant customer. It will be appreciated that each of the plurality of different trolleys used to pick the goods that will be transported in a given delivery van journey will, in general, arrive at the input module 110 at different times (and may, in general, arrive at different input locations 112). The at least one buffer support unit 160 may, for example, allow part of a van load to be temporarily stored in the system 100 while the system awaits the arrival of the remainder of the van load.

The provision of at least one buffer support unit 160 may be particularly beneficial for embodiments wherein the main storage unit 120 may is a one-way storage unit (for example a first in, first out rack) since for such embodiments it may be desirable to put the items into the input of the main storage unit 120 in a particular order.

Furthermore, a buffer support unit 160 can allow greater freedom to optimize the movement of items through the system 100 (and can, for example, allow some items to be prioritized while other items remain in one or more buffer support units for longer).

Optionally, the system 100 may further comprise a return item input module 170 arranged to receive at least one return item at an input location 172. The automated apparatus 140 may be further operable to move a return item received by the return item input module 170 to a mobile support unit received by the input module 110. For example, the control module 150 may be configured to replace each item removed from mobile support units received by the input module 110 with a return item received by the return item input module 110. That is, once a mobile support unit has been unloaded (i.e. full totes have been removed from a trolley), the mobile support unit is automatically replenished with, for example, empty totes. Advantageously, the mobile support unit is then ready for an operator to use for another picking process. For example, new identification data may be provided (for example a new label) for each of the empty totes and the trolley may be used to fill the totes so as to at least partially fulfill a customer order.

For embodiments wherein the system 100 comprises at least two levels, the return item input module 170 may be disposed at the first level and the automated apparatus 140 may be operable to move a return item received by the return item input module 170 to a mobile support unit received by the input module 110 via the second level. In some embodiments, the return item input module 170 may be configured to receive a stack of items (for example a stack of empty totes).

The system 100 may have application in an online grocery shopping system, as now discussed with reference to FIG. 2. FIG. 2 shows a flow diagram 200 for a general process for picking groceries and delivering them to customers.

It will be appreciated that as used for an online grocery shopping system the items may comprise totes or tote boxes. Furthermore, the mobile support units that can be received by the input module 110 may each comprise a trolley for supporting totes.

At a first step 210 in the process orders are picked, for example from a shop floor. A trolley loaded with empty totes is used by a user to manually select products from shelves. In general, the totes on each trolley may comprise totes for a plurality of different customer orders all containing goods that are located in relatively close proximity to one another (for example in the same aisle). An order for a single customer may be distributed over a plurality of such trolleys (as this may improve the efficiency of the picking process).

Next, the trolley loaded with totes containing products ordered by customers is input into the system 100 shown in FIG. 1. Once all of the products for each tote have been selected, the trolley can be wheeled into an input location 112 of the input module 110.

The next step 220 is for the system 100 to sort the totes. The system 100 may receive a plurality of different trolleys, unload the totes from them and place them onto the main support unit 120 such that they are now grouped in a way that is optimized for delivering the totes to their corresponding customers. For example, the totes may be placed onto the main support unit 120 such that they are now grouped according to which delivery van will be used to transport them to the relevant customer and where in that delivery van they will be placed. Alternatively, the totes may each be placed onto the main support unit 120 in a designated location for collection by a specific customer or by an operator for transfer to a customer collection location.

In some embodiments, the main support unit 120 may comprise two separate parts (each of which may, in turn, comprise any number of supports or racks). A first part may be accessible by an operator for unloading items and transferring them to a delivery van. A second part may be accessible by a customer, or by an operator for transfer to a customer collection location. The first part may be for use for customers who have selected home delivery (via a delivery van) and the second part may be for use for customers who have selected a click and collect service. It will be appreciated that the first and second parts may be arranged in different locations.

Once a trolley has been placed into an input location 112 of the input module 110, a signal may be sent from that into input location 112 to the control module 150 to notify it of this.

The identification module 130 then determines identification data for each tote disposed on that trolley. This may be in response to a sensor or the like at the input location 112 determining the presence of a trolley. Alternatively, this may be in response to a signal sent to the identification module 130 by the control module 150 (for example in response to a signal received by the control module 150 from an input location 112 of the input module 110 notifying it that a trolley has been placed into that input location 112). The identification module 130 then sends the determined identification data for each tote disposed on that trolley to the control module 150.

Upon receipt of identification data for a tote the control module 150 may determine a target storage position 122 in the main support unit 120 for that tote. The control module 150 may also determine a route from that tote from the input location 112 at which it was received to the target storage position 122 in the main support unit 120. It will be appreciated that the route for each tote from an input location to the target storage position 122 in the main support unit 120 may be via one or more other storage positions 122 in the main support unit 120. For example, each tote may be moved sequentially through a plurality of storage positions 122 sharing a common inlet until disposed in the target storage position 122 (for example adjacent a common outlet at a pick face of the main support unit 120). Additionally or alternatively, the route for each tote from an input location to the target storage position 122 in the main support unit 120 may be via one or more buffer storage positions 162 a buffer support unit 160. It will be appreciated that the route for each tote may be subject to change upon receipt of additional totes into the system 100. That is to say, the system 100 may be dynamic and may, for example priorities totes according to criteria other than the order in which they are received.

The last step 230 is for the totes disposed on the main support unit 120 to be loaded in to a delivery van. Since the system 100 has placed the totes onto the main support unit 120 such that they are now grouped in a way that is optimized for delivering the totes to their corresponding customers, this efficiency of step is significantly improved. Each input location 112 is arranged to receive a mobile support unit supporting a plurality of items. It will be appreciated that the mobile support unit can take various different forms although is generally suitable for supporting a plurality of items 40. Generally, the mobile support unit 10 is of the form of a trolley having a body supported on a plurality of wheels. The items may take any desirable form but in some examples, the items may be of the form of a box, container or crate (for example a tote box). The body of the trolley may be generally of the form of a racking or shelving unit having a plurality of supports or shelves for supporting the items. It will be appreciated that such supports or shelves may define a support plane upon which a box or crate can be placed. It will be further appreciated that such supports or shelves may only extend over a portion of the support plane upon which a box or crate can be placed. For example, in some embodiments each shelf may comprise two parallel ledges, each extending along one of a pair of opposed edges of the support plane.

In general, the mobile support unit(s) and the item(s) supported thereby do not form part of the system 100. However, it will be appreciated that parts of the system 100 may be configured for a particular type or size of mobile support units and/or items.

An example mobile support unit 10 for use with the system 100 shown in FIG. 1 is shown in FIG. 3. The example mobile support unit 10 will be briefly described below with reference to FIG. 3. It is emphasised that the size, shape, configuration and item supporting capacity of the mobile support unit may differ from that of the example mobile support unit 10 shown in FIG. 3 (and that the mobile support units may be considered to not form part of the system 100). The example mobile support unit 10 is described along with the example embodiments to aid understanding of the system 100.

The example mobile support unit 10 is of the form of a trolley having a body 20 supported by four wheels 30 (only three are visible in the Figure). The body 20 of the trolley is generally of the form of a racking or shelving unit having a plurality of supports or shelves for supporting items 40. The body 20 comprises a generally rectangular base 22; each of the wheels 30 is attached to the base 22 proximate one or the four corners of the base 22. The body further comprises two end upright supports 24 and a central upright support 26. Each of the end upright supports 24 extends from an opposite side of the base 22 in a direction generally perpendicular to the base 22. The central support 26 is disposed between the two end upright supports 24 and extends in a direction generally perpendicular to the base 22. A plurality of ledges or flanges 28 are provided on each of the end upright supports 24. Said flanges 28 extend generally parallel to the base 22 (and generally perpendicular to the end upright supports 24) and towards the central support 26. The central support is also provided on each side with a plurality of ledges or flanges 28, which extend generally parallel to the base 22 (and generally perpendicular to the central support 26) and towards one of the end supports 24. The flanges 28 are provided in pairs such that each flange 28 on the central support 26 is disposed at substantially the same distance from the base 22 as a corresponding facing flange 28 on one of the end supports 24. In use, each such pair of corresponding flanges 28 is arranged to support two opposite sides of a tote box 40.

Each pair of corresponding flanges 28 may be considered to define a support plane upon which a box or crate can be placed. The items may take any desirable form but in some examples, the items may be of the form of a box, container or crate (for example a tote box 40).

In FIG. 3, eight pairs of corresponding flanges 28 are provided on the body 20 and each one is shown supporting a tote box 40. The eight pairs of corresponding flanges 28 are provided as two columns 60, 62 of support positions for items 40. Each column 60, 62 of support positions is defined between one of the two end upright supports 24 and the central upright support 26.

Optionally, one of the end upright supports 24 may be provided with one or more features such as, for example, a handle 50 that can be used by an operator.

In general, the mobile support unit(s) and the item(s) supported thereby may not form part of the system 100. However, it will be appreciated that parts of the system 100 may be configured for a particular type or size of mobile support units and/or items. In particular, any of: the input module 110, main support unit 120, identification module 130, automated apparatus 140, and control system 150 may be configured for a particular type or size of mobile support units and/or items. In addition, if present, the buffer support unit 160 and/or the return item input module 170 may be configured for a particular type or size of mobile support units and/or items. In some embodiments, some parts of the system 100 may be adjustable to allow them to be adapted for different types or sizes of mobile support units and/or items.

As discussed above, the control module 150 of the system 100 is operable to place totes onto the main support unit 120 such that they are now grouped in a way that is optimized for delivering the totes to their corresponding customers. In particular, the totes may be grouped in a way that improves the efficiency of loading them into a delivery van. It will be appreciated that embodiments may achieve this in various different ways, depending on the size and configuration of the delivery van. A non-limiting example of how this may be achieved is now discussed with reference to FIG. 4.

FIG. 4 shows a schematic representation of the storage positions 70 in a delivery van. The storage positions 70 are arranged as three dimensional array of positions.

It is emphasised that the arrangement of storage positions in the delivery van may differ from the example representation of the storage positions 70 in a delivery van shown in FIG. 4. The example representation of the storage positions 70 in a delivery van is described along with the example embodiments merely to aid understanding of the system 100.

The storage positions 70 are arranged as a three dimensional array of positions, which can be accessed from one side 72 of the three dimensional array of storage positions 70. The side 72 from which the three dimensional array of storage positions 70 can be accessed may be referred to as the front and may be adjacent a door of the delivery vehicle.

In this example, the storage positions 70 comprise racks having a depth suitable for accommodating three totes 40. It will be appreciated that different depths may alternatively be used and that the depth may be dependent on a volume of the delivery vehicle.

The side 72 from which the three dimensional array of storage positions 70 can be accessed comprises a two-dimensional array of positions that each act as an inlet and outlet for three storage positions for an item 40. In particular, the storage positions 70 comprises: a first two-dimensional array of positions 74 (which may be referred to as the back positions); a second two-dimensional array of positions 76 (which may be referred to as the middle positions); and a third two-dimensional array of positions 78 (which may be referred to as the front positions).

In this example, each of the first, second and third two-dimensional array of positions 74, 76, 78 has four rows 81, 82, 83, 84 and four columns 85, 86, 87, 88. It will be appreciated that different numbers of rows and columns may alternatively be used and that the numbers of rows and columns may be dependent on a volume of the delivery vehicle.

It will be appreciated that for any given row and column, a tote to be positioned in the back position 74 should be inserted first, into the front position 78. Subsequently, a second item 40 to be positioned in the middle position 76 is inserted into the same front storage position 78. As the second item is so inserted into the front position 78, the second item pushes the first item into the middle storage position 76. Finally, a third item 40 to be positioned in the front position 78 is inserted into the same front storage position 78. As the third item is so inserted into the front position 78, the third item pushes the second item into the middle storage position 76 and the first item into the back storage position 76.

The items 40 may be accessed by an operator or robot from a side of the main storage unit 120, and this side may be referred to as the “pick face”. The control module 150 may have arranged the items such that a block of rows and columns can be extracted together from the pick face and transferred to the positions 70 of a delivery van. For example, in one embodiment, an array of two columns of four rows may be removed from the pick face together using a robot or a suitable trolley. It will be appreciated any other combination of columns and/or rows may alternatively be removed from the pick face together using a robot or a suitable trolley.

A first array of two columns of four rows of totes 40 may be transferred from the main support unit 120 in this way, for example, into the left-hand pair of columns 85, 86 (eventually to be positioned in the back position 74). A second array of two columns of four rows of totes 40 to be positioned in into the middle position 76 of the left-hand pair of columns 85, 86 may subsequently be transferred from the main support unit 120.

This second array of totes may be retrieved from any 2×4 array of positions on the pick face (since they will be transferred to the delivery vehicle separately). However, in one example embodiment, they may be transferred from the same 2×4 array of positions on the pick face of the main support unit 120 as the first array of two columns of four rows of totes 40. For example, once the first array of two columns of four rows of totes 40 has been removed from an array of storage positions 122 of the main support unit 120 adjacent the pick face, the second array of two columns of four rows of totes 40 may be moved into the same array of storage positions 122 of the main support unit 120 adjacent the pick face. This movement may, for example, be under the action of gravity (for example, for embodiments wherein the main storage unit 120 comprise a racking system that is generally of the form of a FIFO racking system). Alternatively, this movement may be caused by the automated apparatus 140.

A third array of two columns of four rows of totes 40 to be positioned in into the front position 78 of the left-hand pair of columns 85, 86 may subsequently be transferred from the main support unit 120. Again, this second array of totes may be retrieved from any 2×4 array of positions on the pick face (since they will be transferred to the delivery vehicle separately). However, in one example embodiment, they may be transferred from the same 2×4 array of positions on the pick face of the main support unit 120 as the first and second arrays of two columns of four rows of totes 40.

In a similar way, fourth, fifth and sixth arrays of two columns of four rows of totes 40 may be transferred from the main support unit 120 into the right-hand pair of columns 87, 88. It will be appreciated that the fourth, fifth and sixth arrays of two columns of four rows of totes 40 may be transferred either in series with or in parallel with the first, second and third arrays two columns of four rows of totes 40.

According to some embodiments of the present invention, there are provided methods for receiving and sorting items. An example, of such a method 300 is now described with reference to FIG. 5.

The method 300 first comprises the step 310 of receiving a plurality of mobile support units 10, each supporting a plurality of items 40. Next, the method 300 comprises the step 320 of determining identification data from each item 40 supported by each of the plurality of mobile support units 10.

The method 300 further comprises the step 330 of determining an output storage position 122 for each of the plurality of items 40 from each of the plurality of mobile support units 10.

The method 300 further comprises the step 340 of using automated apparatus 140 to move each of the plurality of items 40 from each of the plurality of mobile support units 10 to its determined output storage position 122. The output storage position 122 of each item 40 is selected in dependence on the identification data determined from that item 40.

It will be appreciated that the method 300 may be implemented by the above-described system 100. The method 300 may comprise any of the functionality of the above-described system 100. The method 300 shown schematically in FIG. 5 may comprise any of the features of the system 100 shown in FIG. 1 and described above.

The various components of the system 100 are now explained in greater detail with reference to the remaining Figures. In particular, two example embodiments of systems of the form of the system 100 shown in FIG. 1 are now described. A first embodiment is described with reference to FIGS. 6A to 15. A second embodiment is described with reference to FIGS. 16 to 31E.

FIGS. 6A and 6B are two perspective views of a system 400 for receiving and sorting items according to a first embodiment of the present invention. The system 400 shown in FIGS. 6A and 6B is an embodiment of the system 100 shown in FIG. 1 and may comprise any of the feature of the system 100 shown in FIG. 1 described above.

The system 400 comprises two levels: a first level 402 and a second level 404. The input module 110 and the main support unit 120 are both provided on the first level 402. In this embodiment, the automated apparatus 140 is operable to move an item 40 supported by a mobile support unit 10 received by the input module 110 to one of the plurality of storage positions 122 of the main support unit 120 via the second level 404.

The second level 404 may be generally of the form of a mezzanine floor 404 above the first level 402.

Advantageously, this allows the input module 110 of the system 400 to be integrated with a shop floor (on the first level 402) whilst the bulk of the transportation of items 40 between the input module 110 and the main support unit 120 to be performed on the second level 404 (where it will not interfere with the shop floor). In the embodiment shown in FIGS. 6A and 6B, for ease of understanding, the input module 110 and the main storage unit 120 are in close proximity, with a portion of the second level 404 above the input module 110 being connected to a portion of the second level 404 above the main storage unit 120 being connected by a small pathway 406. However, it will be appreciated that in other embodiments, the pathway 406 may be significantly longer (and any desirable shape). In particular, in many embodiments, the input module 110 may be disposed on a shop floor and the main storage unit 120 may be disposed elsewhere (for example in close proximity a loading area for loading delivery vehicles).

In this embodiment, the automated apparatus 140 comprises: (a) unload apparatus 410 operable to remove items 40 supported by a mobile support unit 10 received by the input module 110; (b) load apparatus 420 operable to move items 40 to the main support unit 120; and (c) at least one transport robot 430 operable to remove items 40 supported by a supply apparatus and to deliver said items to a receiver apparatus.

As discussed further below, the unload apparatus 410 is operable to move items 40 from a mobile support unit 10 disposed on the first level 402 to a first location on the second level 404. That is, the unload apparatus 410 may be generally of the form of a lift. Items 40 are transferred from the unload apparatus 410 to an input buffer support unit 440 for subsequent collection by a transport robot 430 (which is operable to move the items 40 to a second location on the second level 404). The first location is adjacent an input of the input buffer support unit 440.

Similarly, as discussed further below, the load apparatus 420 is operable to move items 40 from a location on the second level 404 to the main support unit 120 disposed on the first level 402. That is, the load apparatus 420 may be generally of the form of a lift.

Items 40 are transferred to the load apparatus 420 from an output buffer support unit 450, having been previously deposited on the output buffer support unit 450 by a transport robot 430 (which is operable to move the items 40 on the second level 404).

The or each transport robot 430 is operable to move items 40 between two locations on the second level 404. The items 40 are transferred to the second level 404 by the unload apparatus 410 and are returned to the first level 402 by the load apparatus 420.

In addition to the input buffer support unit 440 and the output buffer support unit 450, the system 400 further comprises an intermediate buffer support unit 460. The intermediate buffer 460 comprises a plurality of intermediate buffer storage positions 462 suitable for supporting an item 40.

In this embodiment, each of the plurality of intermediate buffer storage positions 462 suitable for supporting an item 40 is provided with a common inlet and outlet. That is, the intermediate buffer storage positions 462 are generally of the form of a shelf or rack that items 40 can be placed onto (for example by a transport robot 430) from one side and subsequently removed from the same side (for example by a transport robot 430).

The shelf or rack may therefore have a depth suitable to accommodate only one item 40.

Each of the plurality of intermediate buffer storage positions 462 suitable for supporting an item 40 has a depth that is less than a depth of the items 40 to be received and sorted by the system 400 (for example a tote box 40). For example, some of the intermediate buffer storage positions 462 may have a depth that is greater than half a depth of the items 40 to be received and sorted by the system 400. Advantageously, this may simplify the functionality of automated apparatus (for example a transport robot 430) that is operable to place an item 40 in such an intermediate buffer storage position 462 and/or to remove an item 40 from such an intermediate buffer storage position 462.

In some embodiments, at least one of the plurality of intermediate buffer storage positions 462 may be provided with an actuator (not shown) operable to push an item 40 supported on by that intermediate buffer storage position 462 out of the common inlet and outlet. For example, a transport robot 430 may be operable to place an item in such an intermediate buffer storage position 462. For subsequent retrieval of the item, a transport robot 430 may be operable move adjacent to the intermediate buffer storage position 462 and the actuator may be used to push the item onto the transport robot 430.

It will be appreciated that the buffer support unit 160 shown schematically in FIG. 1 may comprise: the input buffer support unit 440, the output buffer support unit 450 and the intermediate buffer support unit 460.

The return item input module 170 is also disposed on the first level 404. In some embodiments, the return item input module 170 may be configured to receive a stack of items (for example a stack of empty totes). The automated apparatus 140 may further comprise a de-stacker arranged to receive a stack of return items from the return item input module and to output a plurality of individual return items. De-stackers for de-stacking a stack of totes are known and commercially available. In this embodiment, the automated apparatus 140 further comprises lift apparatus 470 operable to move return items received from the return item input module 170 to the second level 404.

The lift apparatus 470 may, for example, receive return items from a de-stacker.

The system 400 further comprises at least one return item buffer support unit comprising a plurality of return item buffer storage positions suitable for supporting a return item, as now discussed. The at least one return item buffer support unit may, for example, be disposed at the second level 404. Further, the automated apparatus 140 is operable to move a return item received by the return item input module 170 to a mobile support unit 10 received by the input module 110 via at least one of said plurality of return item buffer storage positions.

The system 400 comprises at least one output return item buffer support unit 480 comprising a plurality of output return item buffer storage positions 482 suitable for supporting a return item associated with the input module 110. In particular, the output return item buffer support unit 480 comprises a plurality of output return item buffer storage positions 482 suitable for supporting a return item and associated with one of the two input locations 112. The automated apparatus 140 is operable to move a return item supported by the at least one output return item buffer support to a mobile support unit 10 received at an associated input location 112, as will be discussed further below.

Although not shown in FIGS. 6A and 6B, in some embodiments an additional input return item buffer support unit is provided comprising a plurality of input return item buffer storage positions suitable for supporting a return item and associated with at the return item input module 170. For example, this buffer support unit may be provided on the second level 404 adjacent the lift apparatus 470. The lift apparatus 470 may be operable to move a return item received by the return item input module 170 to one of the plurality of input return item buffer storage positions. Once lifted to the second level 404 by lift apparatus 470, each return item may be moved through the system 400 by the of transport robot(s) 430. An input return item buffer support unit associated with the input module 170 allows items lifted to the second level 404 by the lift apparatus 470 to be temporarily stored for later retrieval by such a transport robot 430. Advantageously, this removes the need for a transport robot 430 to be waiting for return items as they arrive at the second level 404. Rather, the return items can be placed in the input return item buffer support unit and collected by the transport robots 430 when convenient. Advantageously, this reduces downtime of the transport robots 430, increasing the throughput of the system 400 for a given number of transport robots 430.

In the embodiment shown in FIGS. 6A and 6B, the input module comprises two input locations 112 (one visible in each of FIGS. 6A and 6B). Each input location 112 is arranged to receive a mobile support unit 10 supporting a plurality of items 40. It will be appreciated that in other embodiments, the input module 110 may comprise any number of input locations 112. In some embodiments, the input module 110 may comprise a plurality of input locations 112 distributed around a shop floor. For example, at least one input locations 112 may be provided in each aisle of the shop floor. The two input locations 112 in the embodiment of FIGS. 6A and 6B are generally back to back (accessible from opposite directions). Such an arrangement may, in use, be built into shelves of a shop floor. For example, the two input locations 112 in the embodiment of FIGS. 6A and 6B may, in use, provide input locations 112 accessible from two adjacent aisles of the shop floor. A plurality of such “back-to-back” arrangements may be provided on a shop floor. Alternatively, the input locations 112 may each be accessible from one aisle of the shop floor. Such an arrangement may allow for a portion of the second level 404 above the shop floor to be above and/or supported by the shelves separating two adjacent aisles of the shop floor. For example, each input location 112 and a pathway of the second level 404 that connects that input location 112 to a portion of the second level 404 that is not directly above the shop floor may be directly above and/or supported by the shelves separating two adjacent aisles of the shop floor.

The provision of an input module 110 comprising a plurality of input locations 112 advantageously provides a buffer for the input of mobile support units 10. For example, two or more mobile support units 10 can be provided to the input module 110 at substantially the same time and the automated apparatus 410, 420, 430 can move items 40 from each of these mobile support units 10 in parallel. This avoids having to wait for a first one of the mobile support units 10 to be unloaded before a second mobile support unit 10 can be received by the input module 110.

Each of the plurality of input locations 112 may comprise an identification sub-module (not shown) operable to determine identification data from each item 40 supported by a mobile support unit 10 received in that input location 112.

The or each submodule may, for example, comprise: an imaging system (for example a camera) operable to form an image of a visual marker on an item 40 supported at an input location 112; and a processor operable to determine the identification data from said image. For example, the imaging system may comprise a camera operable to from an image of a marker on the item. The processor may be operable to execute suitable recognition software to identify a code from the image. Alternatively, any suitable form of identification module may be used, using, for example, bar codes, QR codes or the like. One or more such identification submodules may be provided at the or each input location 112 and may be operable to determine the identification data for each item 40 supported by a mobile support unit 10 at that input location 112.

In this embodiment, each input location 112 of the input module 110 is provided with unload apparatus 410, an input buffer support unit 440 and output return item buffer support unit 480. This combination of input location 112, unload apparatus 410, input buffer support unit 440 and output return item buffer support unit 480 may be referred to as a turn-around station. The functionality of such a turn-around station is now discussed with reference to FIGS. 7A to 9C.

FIGS. 7A to 7E show an input location 112 of the input module 110 that is suitable for receiving a mobile support unit 10.

The input location 112 comprises an access door 114. The door is movably mounted to a wall structure 115 having an aperture (for example defined by a frame 116). To better allow other parts of the system 400 to be seen in the Figures the access door 114 and the wall structure 115 are transparent although, to better see where the door 114 is, an outline of the door 114 is shown as a dashed line. The access door 114 is movable between: an open position in which a mobile support unit 10 supporting a plurality of items 40 can be inserted into or removed from the input location (see FIG. 7C); and a closed position in which access to the input location 112 is restricted (see FIGS. 7A, 7B, 7D and 7E).

The input location 112 comprises an indicator 117 operable to display a status of the input location 112 (indicated schematically by a rectangle in the Figures). For example, the indicator 117 may be a visual indicator and may comprise a red light (indicating that the input location 112 is unavailable) and a green light (indicating that the input location 112 is available). Alternatively, the indicator 117 may comprise a display screen or the like operable to display information indicating whether or not that the input location 112 is available.

The input location 112 further comprises a user controllable actuator mechanism 118 (indicated schematically by a rectangle in the Figures). The user controllable actuator mechanism 118 is operable, in response to an input from a user, to move the door 114 from the closed position to the open position. For example, the user controllable actuator mechanism 118 may comprise a lock, for example a remote keyless lock, and the input from the user may be sent using a keyfob or access ID card of the like. Alternatively, the user controllable actuator mechanism 118 may comprise a keypad and the input from the user may be provided by inputting an access code.

The door 114 may be disposed in an open position when the input location 112 is available to allow mobile support unit 10 supporting a plurality of items 40 to be placed into the input location 112.

In this embodiment, the door 114 is disposed in a closed position (see FIG. 7A) until it is opened by a user (for example using the actuator mechanism 118), as now discussed. A user may move a mobile support unit 10 loaded with items 40 (for example tote boxes containing groceries) adjacent to the input location 112 (see FIG. 7B). The user may determine, for example from the indicator 117, whether or not that the input location 112 is available to receive the mobile support unit 10. If so, the user may use the actuator mechanism 118 to open the door 114 (see FIG. 7C). Once the door 114 is open, the user can push the mobile support unit 10 into the input location 112. Optionally, before pushing the mobile support unit 10 into the input location 112 the user may remove a previously processed mobile support unit 10 (supporting empty totes 40) from the input location 112. Once a mobile support unit 10 supporting a plurality of items 40 has been placed into the input location 112, the door 114 may be moved (for example under control of the control module 150) to a closed position (see FIG. 7D), preventing an operator from accessing the mobile support unit 10. Advantageously, such the access door 114 provides a safety feature since it can prevent operators from being harmed by the operation of the automated apparatus 140 (for example during the unloading of the items 40 from the mobile support unit 10).

Although in this embodiment the input locations 112 each comprise an access door 114, alternatively, in some embodiments, the input locations 112 may have no door. Rather, the input locations 112 and the mobile support units 10 may be arranged such that when the mobile support unit 10 is disposed in the input location 112, the input location 112 is inaccessible by a user. For example, the mobile support unit 10 may comprise a barrier or panel that may form a close fit with an aperture of the input location 112 (for example an aperture defined by frame 116) so as to close access to the input location 112. For such embodiments, the or each input location 112 may comprise an engagement mechanism that may be operable (for example under the control of the control module 150) to releasably engage a mobile support unit 10 when disposed in the input location 112 so as to releasably lock it in position. For example, one or more movable members may be provided which can move between an extended position and a retracted position. When in the extended position, the one or more movable members may engage a mobile support unit 10 disposed in the input location 112 so as to releasably lock it in position. When in the retracted position, the one or more movable members may disengage a mobile support unit 10 disposed in the input location 112 so as to allow it to be removed from the input location 112.

The input location 112 comprises a volume formed by two sides and an end wall (the end wall being opposite the aperture 116 and door 114). The volume, aperture 116 and door 114 may be sized suitably so as to aid the placement of a mobile support unit in an alignment position.

The input location 112 comprises associated unload apparatus 410 operable to remove items 40 supported by a mobile support unit 10 received by the input location 112, as now discussed with reference to FIGS. 7D to 8E.

In this embodiment, the automated apparatus 140 of FIG. 1 comprises an unload apparatus 410 associated with each of the plurality of input locations 112 of the input module 110 and which is operable to remove items 40 supported by a mobile support unit 10 received by the associated input location 112.

Each unload apparatus 410 is operable to move items 40 from a mobile support unit 10 disposed on the first level 402 to a first location on the second level 404.

In this embodiment, the unload apparatus 410 comprises a lift unit 411 comprising a main support structure 412 and two pairs of adjacent shelves 413a, 413b. The two pairs of adjacent shelves 413a, 413b are supported by the main support structure 412 and are suitable for supporting an item 40. In particular, the two pairs of adjacent shelves 413a, 413b are movably supported by the main support structure 412 such that they can move relative to the main support structure 412.

In this embodiment, the main support structure 412 comprises a first main support structure 412a and a second main support structure 412b.

In some embodiments, within each pair of adjacent shelves 413a, 413b the two adjacent shelves may be connected and may move together, relative to both the first main support structure 412a and the second main support structure 412b. For example, the first pair of adjacent shelves 413a may be connected together and the second pair of adjacent shelves 413b may be connected together. Advantageously, such embodiments may give better support for the totes 40 and may allow for increased speed of the unload apparatus 410.

In other embodiments, one shelf from each pair of adjacent shelves 413a, 413b may be supported by the first main support structure 412a (as a cantilever structure) and the other one shelf from each pair of adjacent shelves 413a, 413b may be supported by the second main support structure 412b (as a cantilever structure). For such embodiments, the two shelves supported by the first main support structure 412a may move independently of the two shelves supported by the second main support structure 412b. Advantageously, such embodiments may give increased flexibility to the unload apparatus 410.

The two pairs of adjacent shelves 413a, 413b are movable relative to the main support structure 412 in a first direction (indicated by arrow A) so as to be positionable adjacent a plurality of different items 40 supported by a mobile support unit 10 received by the input location 112. The first direction A is a direction in which separates the two levels 402, 404.

The unload apparatus 410 further comprises transfer apparatus operable to transfer items 40 to and from the two pairs of adjacent shelves 413a, 413b, as now discussed.

In this embodiment, the transfer apparatus comprises apparatus that is separate from the two pairs of adjacent shelves 413a, 413b and operable to push or pull items onto or off of the shelves 413a, 413b.

In particular, the transfer apparatus comprises a manipulator 414 disposed adjacent to the input location 112. The manipulator comprises a plurality of movable manipulators 415 that are operable to transfer items from a mobile support unit 10 disposed in the input location 112 and an adjacent position at which the shelves 413a, 413b are positionable. In particular, when a mobile support unit 10 supporting a plurality of items 40 is disposed in the input location 112, one of the linear actuators 415 is disposed adjacent each one of the items 40.

As shown in FIG. 7D, once the door 114 has been closed. One pair of adjacent shelves 413b is positioned adjacent to two items 40 supported by the mobile support unit 10 (in this case the top two tote boxes 40). Once this pair of adjacent shelves 413b is positioned adjacent to these two items 40, as shown in FIG. 7E, two of the actuators 415 are used to push the these two items 40 at least partially onto the pair of adjacent shelves 413b.

In addition, the transfer apparatus comprises apparatus (not shown) provided on the shelves 413a, 413b and operable to push or pull items 40 onto the shelves 413a, 413b or to assist in pushing or pulling items 40 onto the shelves 413a, 413b. In particular, each of the two pairs of shelves 413a, 413b comprises a conveyor module operable to move items on to or off of it. With such an arrangement, the conveyor can move an item 40 between the shelves 413a, 413b and an adjacent position. It will be appreciated that in order to move an item 40 the using such a conveyor the item 40 may be at least partially disposed on the conveyor. For example, the actuators 415 may be operable to move items 40 partially onto the shelves 413a, 413b. This may allow the conveyor apparatus to pull the item fully onto the shelves 413a, 413b. Control of the position of the items 40 on the shelves 413a, 413b may be achieved using any suitable sensors as will be apparent to the skilled person.

In alternative embodiments, the shelves 413a, 413b may comprise a movable members that are movable relative to shelves 413a, 413b and operable to releasably engage items 40. With such an arrangement, the movable members can releasable engage an item such that as it moves between the retracted and extended positions said member moves with it. In this way, the movable member can drag an item 40 between the shelves 413a, 413b and an adjacent position. It may be that such alternative embodiments do not comprise a manipulator 414.

Once the two items 40 adjacent to the top pair of adjacent shelves 413b in FIG. 7E have been fully transferred thereto, the other pair of adjacent shelves 413a may be positioned adjacent another two items 40 supported by the mobile support unit 10.

Optionally, this may be achieved by moving the two pairs of adjacent shelves 413a, 413b slightly relative to the main support structure 412. This may be because, in general, a (vertical) spacing between the two pairs of adjacent shelves 413a, 413b may be different to a (vertical) spacing between the supports of the mobile support unit 10.

Subsequently, the other two items 40 supported by the mobile support unit 10 are transferred to the other pair of adjacent shelves 413a (see FIG. 7F). Once items 40 are supported by both pairs of shelves 413a, 413b, the shelves 413a, 413b are moved up to the second level 404 (see FIGS. 7F and 8A).

At the second level 404 the items 40 supported by the lift unit 411 are transferred to the input buffer support unit 440 for subsequent collection by a transport robot 430. The first location may be adjacent an input of the input buffer support unit.

The input buffer support unit 440 comprises a plurality of input buffer storage positions 442 suitable for supporting an item 40 associated with at the input location 112. The unload apparatus 410 is operable to move an item 40 supported by a mobile support unit 10 received by the input location 112 to one of the plurality of input buffer storage positions 442.

An input buffer support unit 440 associated with at an input location 112 allows items unloaded from a mobile support unit 10 by an unload apparatus 410 to be temporarily stored for later retrieval by a transport robot 430. Advantageously, this removes the need for a transport robot 430 to be waiting for items 40 as they are unloaded. Rather, the items 40 can be unloaded to the input buffer support unit 440 and collected by the transport robots 430 when convenient. Advantageously, this reduces downtime of the transport robots 430, increasing the throughput of the system 400 for a given number of transport robots 430. Furthermore, this input buffer support unit 440 can allow greater freedom to optimize the movement of items 40 through the system 400 (and can, for example, allow some items 40 to be prioritized while other items 40 remain in the input buffer support unit 440 for longer).

The input buffer support unit 440 comprises a racking system that is generally of the form of a first in, first out (FIFO) racking system. In this embodiment, the input buffer storage positions 442 are provided in groups of three, each group of three input buffer storage positions 442 being provided with a common inlet and a separate common outlet. The input buffer support unit 440 is disposed such that the shelves 413a, 413b of the lift unit 411 are positionable adjacent the common inlets of the input buffer storage positions 442.

Each common inlet is disposed at a higher position than its associated commons outlet. Further, each common outlet is provided with a latch mechanism (not shown), the latch mechanism arrangeable in a closed configuration in which an item 40 disposed adjacent the outlet is prevented from passing through the common outlet; and an open position in which an item 40 disposed adjacent the common outlet is allowed to pass through the common outlet.

As shown in FIG. 8A, when items 40 are supported by both pairs of shelves 413a, 413b of the lift unit 411, the shelves 413a, 413b are moved so as that each one of the items is adjacent a common inlet of a set of input buffer storage positions 442 (see FIG. 8A). Once so disposed, the conveyor apparatus of the lift unit 411 is used to move the items from both pairs of shelves 413a, 413b of the lift unit 411 each into a common inlet of a set of input buffer storage positions 442 (see FIG. 8B). The items 40 then move under gravity towards a common outlet of the set of input buffer storage positions 442 (see FIGS. 8C and 8D).

As described above, the system 400 also comprises an output return item buffer support unit 480 comprising a plurality of output return item buffer storage positions 482 suitable for supporting a return item associated with the two input location 112 (shown in FIGS. 6A and 6B). In particular, the output return item buffer support unit 480 comprises a plurality of output return item buffer storage positions 482 suitable for supporting a return item and associated with one of the two input locations 112. The lift unit 411 is operable to move a return item supported by the at least one output return item buffer support unit 480 to a mobile support unit 10 received at an associated input location 112, as now discussed.

The output return item buffer support unit 480 comprises a racking system that is generally of the form of a first in, first out (FIFO) racking system. The structure of the output return item buffer support unit 480 is generally the same as that of the input buffer support unit 440, with the following exceptions. First the common inlets of the output return item buffer storage positions 482 are generally provided at the same height (relative to the second level 404) as the common outlets of the input buffer storage positions 442. This allows substantially the same transport robots 430 to remove items 40 from the common outlets of the input buffer storage positions 442 and to place items into the common inlets of the output return item buffer storage positions 482. Second, the output return item buffer support unit 480 is disposed such that the shelves 413a, 413b of the lift unit 411 are positionable adjacent the common outlets of the output return item buffer storage positions 482.

Once the items 40 that have been removed from the mobile support unit 10 disposed in the input location 112 have been transferred from lift unit to the input buffer support unit 440, the shelves 413a, 413b are moved so that each one is adjacent a common outlet of a set of output return item buffer storage positions 482 (see FIG. 8C).

Subsequently, a latch mechanism each of the common outlets adjacent the shelves 413a, 413b is then opened, allowing return items (empty tote boxes) to move onto the shelves 413a, 413b (see FIGS. 8D and 8E). The actuation of the latch mechanisms may be achieved in any convenient way, as would be understood by the skilled person. For example, the lift unit 411 may comprise actuators (mechanical, electronic, magnetic etc.) operable to actuate the latch mechanisms (for example under the control of the control module 150). Alternatively, the control module 150 may actuate the latch mechanisms directly (for example, upon receipt of a signal from the lift module 411 indicating that it is in place adjacent the common outlets. The movement of the return items (empty tote boxes) onto the shelves 413a, 413b may be assisted by the conveyor apparatus.

Once so disposed, the conveyor apparatus of the lift unit 411 is used to move the items from both pairs of shelves 413a, 413b of the lift unit 411 each into a common inlet of a set of input buffer storage positions 442 (see FIG. 8B). The items 40 then move under gravity towards a common outlet of the set of input buffer storage positions 442 (see FIGS. 8C and 8D).

Once return items 40 are supported by both pairs of shelves 413a, 413b, the shelves 413a, 413b are moved down to the first level 402 (see FIG. 9A). At the first level 402 the return items supported by the lift unit 411 are transferred to the mobile support unit 10 to replace the items 40 that have been unloaded to the input buffer support unit 440 (see FIGS. 9B and 9C).

As can be seen from FIG. 8E, another lift apparatus 411 associated with another input location 112 is also provided. The other lift apparatus 411 is operable move items to the input buffer support unit 440 from a mobile support unit 10 disposed in the other input location 112 and to move return items (empty tote boxes) from the output return item buffer support unit 480 to the mobile support unit 10 as described above.

The functionality of the transport robots 430 is now discussed with reference to FIGS. 10A to 10E.

Each transport robot 430 operable to remove items 40 supported by a supply apparatus and to deliver said items 40 to a receiver apparatus. Such transport robots 430 may transport items between any two apparatus within the system 400, generally on the same level of the system 400 (for example the second level 404). For example, the transport robots 430 may be operable to transport items 40 from the input buffer support unit 440 to the output buffer support unit 450. The transport robots 430 may be operable to transport such items 40 via any the buffer support unit of the system 400.

Each transport robot 430 comprises: a main body 431; and a drive mechanism (not shown) operable to move the main body 431 relative to a support substrate (for example the second level 404). The main body 431 is supported by a plurality of wheels 432. The drive mechanism may be operable to control said plurality of wheels 432 to move the main body 431 relative to a support substrate 404. As used here, control of the wheels 432 may include actuation of the wheels 432 (i.e. spinning the wheels 432 about their axes) and/or changing a direction of the wheels 432 (i.e. rotating the wheels 432 about an axis perpendicular to their axes). The drive mechanism may comprise: one or more motors; a power supply (such as a battery or the like); and an autonomous control system (which may control the one or more motors in response to signals received from the main control module 150 of the system 400).

In this embodiment, each transport robot 430 further comprises: two shelves 433, 434 supported by the main body 431 and suitable for supporting an item 40; and transfer apparatus operable to transfer items 40 to and from each shelf 433, 434. The transfer apparatus 430 may comprise apparatus provided on each shelf 433, 434 and operable to push or pull items 40 onto the shelf 433, 434 or to assist in pushing or pulling items 40 onto the shelf 433, 434. For example, each shelf 433, 434 may comprise a conveyor module operable to move items 40 on to or off of that shelf 433, 434.

With such an arrangement, the conveyor can move an item 40 between each shelf 433, 434 and an adjacent position. It will be appreciated that in order to move an item 40 the using such a conveyor it may be that the item may is partially disposed on the conveyor. For example, as discussed below, the item may partially fall from an input buffer storage positions 442 onto one of the shelves 433, 434, which may then allow the conveyor to engage with the item 40 and to drag it fully onto the shelf 433, 434.

Each transport robot 430 may further comprise a latch actuator (not shown) operable to transition the latch mechanism of another component of the system 400 (such as, for example, the input buffer support unit 440) between its closed and open configurations. Advantageously, this may allow the transport robot to operate the latch mechanism of other components of the system so as to extract items.

For example, upon arrival at another component of the system 400 (for example a buffer storage unit) the transport robot 430 may be disposed such that each shelf 433, 434 of the transport robot 430 is adjacent an outlet of said other component of the system 400. The transport robot 430 may then use its latch actuator to transition the latch mechanism of that component of the system 400 from its closed configuration to its open configuration, which may allow an item 40 to transition partially from the outlet of that component onto one of the shelves 433, 434 of the transport robot 430. A conveyor module of the transport robot may then pull the item fully onto the shelf 433, 434. The latch mechanism of the other component of the system 400 may automatically transition back from its open configuration to its closed configuration. Alternatively the latch actuator of the transport robot 430 may transition the latch mechanism of the other component of the system 400 back from its open configuration to its closed configuration.

It will be appreciated that as used here latch actuator is intended to cover anything that is operable to transition the latch mechanism of another component of the system between its closed and open configurations. For mechanical embodiments, the latch actuator may comprise an active actuator, which may be operable to move relative to the main body 431 of the transport robot 430 to actuate the latch mechanism. Alternatively, the latch actuator may comprise a passive actuator, which may comprise a protrusion from the main body 431 of the transport robot 430, and which can actuate the latch mechanism by controlling the transport robot 430 to drive the protrusion into the latch mechanism.

Functionality of the transfer robot 430 in use is now described with reference to FIGS. 10A to 11C.

Once the items 40 that have been placed into the input buffer support unit 440, a transport robot 430 may be moved (for example under control of the control module 150) so that each one of the shelves 433, 434 is adjacent a common outlet of a set of input buffer storage positions 442 (see FIGS. 10A and 10B).

Optionally, an extendable portion 433a, 434a of each shelf 433, 434 may be extended away from the main body 341.

Subsequently, a latch mechanism each of the common outlets adjacent the shelves 433, 434 is then opened, allowing items 40 in the adjacent input buffer storage positions 442 to move onto the shelves 433, 434 (see FIG. 10D). The actuation of the latch mechanisms may be achieved in any convenient way, as would be understood by the skilled person. For example, the transport robot 430 may comprise actuators (mechanical, electronic, magnetic etc.) operable to actuate the latch mechanisms (for example under the control of the control module 150). Alternatively, the control module 150 may actuate the latch mechanisms directly (for example, upon receipt of a signal from the transport robot 430 indicating that it is in place adjacent the common outlets of the input buffer support unit 440. The movement of the items 40 (tote boxes containing groceries) onto the shelves 433, 434 may be assisted by the conveyor apparatus and/or the extendable portion 433a, 434a of each shelf 433, 434.

Once the items 40 have been transferred from the input buffer support unit 440 to the transport robot 430, the transport robot 430 may be moved (for example under control of the control module 150) so that each one of the shelves 433, 434 is adjacent an output buffer storage position 452 (see FIG. 11A).

The output buffer support unit 450 comprises a racking system that is generally of the form of a first in, first out (FIFO) racking system. In this embodiment, each of the output buffer storage positions 452 is provided with an inlet 454 and an outlet 456. The output buffer support unit 450 is disposed such that the shelves 433, 434 of the transport robot are positionable adjacent the inlets 454 of two output buffer storage positions 452.

Each inlet 454 is disposed at a higher position than its associated outlet 456. Further, each outlet 456 is provided with a latch mechanism (not shown). The latch mechanism is arrangeable in a closed configuration in which an item 40 disposed adjacent the outlet 456 is prevented from passing through the outlet 456; and an open position in which an item 40 disposed adjacent the outlet 456 is allowed to pass through the outlet 456.

Once the transport robot 430 is disposed so that each one of the shelves 433, 434 is adjacent an output buffer storage position 452, the conveyor apparatus and/or the extendable portion 433a, 434a of each shelf 433, 434 may be used to move the items 40 from both of the shelves 433, 434 of the transport robot 430 each into an inlet 454 of an adjacent output buffer storage position 452 (see FIG. 11B). The items 40 then move under gravity towards an outlet 456 of the adjacent output buffer storage position 452 (see FIG. 11C).

In this embodiment, the main support unit 120 provided with load apparatus 420 and an output buffer support unit 450. The functionality of the main support unit 120 provided with load apparatus 420 and an output buffer support unit 450 is now discussed with reference to FIGS. 11A to 13B.

The load apparatus 420 is operable to move items 40 to the main support unit 120.

The load apparatus 420 is operable to move items 40 from a location on the second level 404 (for example an output buffer storage position 452) to the main support unit 120 disposed on the first level 402. That is, the load apparatus 420 is generally of the form of a lift.

The load apparatus 420 comprises: a main support 422; two shelves 424, 425 supported by the main support 422 and suitable for supporting an item 40. The load apparatus 420 further comprises transfer apparatus operable to transfer items 40 to and from the shelves 424, 425.

The transfer apparatus comprises apparatus provided on the shelves 424, 425 and operable to push or pull items 40 onto the shelves 424, 425 or to assist in pushing or pulling items 40 onto the shelf 424, 425. In particular, in this embodiment, each of the shelves 424, 425 comprises a conveyor module 426 operable to move items 40 on to or off of that shelf 424, 425. With such an arrangement, the conveyor 426 can move an item 40 between the shelf 424, 425 it is provided on and an adjacent position. It will be appreciated that in order to move an item 40 the using such a conveyor 426 the item 40 may be at least partially disposed on the conveyor 426. Each conveyor module 426 may comprise a belt or a cleated belt or the like.

Alternatively, in some other embodiments, each shelf 424, 425 may comprises a movable member. The movable member may be movable relative to its shelf 424, 425 between a retracted position in which the movable member overlies the shelf 424, 425 and an extended position wherein the movable member extends away from the shelf 424, 425 so as to overlie an adjacent position. The movable member may be further operable to releasably engage an item 40. With such an arrangement, the movable member can releasable engage an item 40 such that as it moves between the retracted and extended positions said member 40 moves with it. In this way, the movable member can drag an item 40 between the shelf 424, 425 and an adjacent position.

The shelves 424, 425 are movable relative to the main support 422 in a first direction (indicated by arrow B) so as to be positionable adjacent a plurality of different storage positions of the main support unit. The first direction B is a direction in which separates the two levels 402, 404 of the system 400.

The main support 422 is movable between at least a first position and a second position. For example, the main support 422 is movable in a direction that is generally perpendicular to the first direction B. In particular, in this embodiment, the main support 422 of the load apparatus 420 is movable in a direction that is generally parallel to two levels 402, 404. To achieve this, the main support 422 is in turn supported by a rail 428 (see FIGS. 6A and 6B) and is provided with a drive mechanism to move the main support along the rail 428. In alternative embodiments, the main support 422 may be supported directly on a substrate (for example the first level 402) via wheels or the like and may have a drive mechanism to control the wheels.

The output buffer support unit 450 is disposed such that the shelves 424, 425 of the load apparatus 420 are positionable adjacent the outlets 456 of the output buffer storage positions 452.

The load apparatus 420 is operable to move items 40 from the output buffer support unit 450 to the main support unit 120, as now discussed.

The shelves 424, 425 of the load apparatus 420 are moved relative to the main support 422 until one of the shelves 424 is adjacent an outlet 456 of an output buffer storage position 452 that is supporting an item 40 (see FIG. 11D). Subsequently, a latch mechanism of the outlet 456 of the adjacent output buffer storage position 452 is then opened, allowing the supported item 40 (a tote boxes containing groceries) to move onto the shelf 424 (see FIGS. 11E and 11F). The actuation of the latch mechanisms may be achieved in any convenient way, as would be understood by the skilled person. For example, the load apparatus 420 may comprise actuators (mechanical, electronic, magnetic etc.) operable to actuate the latch mechanisms (for example under the control of the control module 150). Alternatively, the control module 150 may actuate the latch mechanisms directly (for example, upon receipt of a signal from the load apparatus 420 indicating that one of the shelves 424, 425 is in place adjacent the outlet 456. The movement of the item 40 onto the shelf 424 may be assisted by the conveyor apparatus 426.

Subsequently, the shelves 424, 425 of the load apparatus 420 are moved relative to the main support 422 until the other one of the shelves 425 is adjacent an outlet 456 of another output buffer storage position 452 that is supporting an item 40 (see FIG. 11F). The item supported at the other output buffer storage position 452 is then transferred to the other one of the shelves 425 in a similar way.

Once items 40 are supported by both shelves 424, 425, the shelves 424, 425 are moved down to the first level 402 (see FIG. 12A). At the first level 402 the items 40 supported by the load apparatus 420 are transferred to the main support unit 120.

The main storage unit 120 is a one-way storage unit. That is, each of the plurality of storage positions 122 is provided with an inlet and a separate outlet. The load apparatus 420 is operable to move an item 40 to one of the plurality of storage positions 122 of the main support unit 120 via said inlet. The outlets may be accessible by an operator or a robot such that items 40 can be removed from the storage positions 122 via the outlets by such an operator or robot. For example, the main storage unit 120 may comprise racks. The load apparatus 420 is operable to insert items 40 into the racks from one side. The items 40 may subsequently be accessed by an operator or robot from an opposite side of the racks. The outlet side of the racks may be referred to as a “pick face”.

In this embodiment, the racks have a depth of five storage positions 122. That is, in this embodiment, the storage positions 122 are provided in groups of five, each group of five storage positions 122 being provided with a common inlet and a separate common outlet. It will be appreciated that in other embodiments, the racks may have any depth, for example a depth of any number of storage positions 122. For example, in some embodiments, the racks may have a depth of upto twelve storage positions 122. The main support unit 120 is disposed such that the shelves 424, 425 of the load apparatus 420 are positionable adjacent the common inlets of the storage positions 122.

Such an arrangement is advantageous as it provides additional storage positions 122 (that are not adjacent a common outlet) that provide a buffer for storage of items 40.

The system 400 may be operable to move items 40 into the common inlet, through the subset of storage positions 122 to the common outlet for retrieval by an operator (or a robot). The subset of storage positions 122 may be arranged in a line and may be referred to as a line or row of storage positions 122.

The main storage unit 120 comprises racks having a depth suitable for accommodating five items 40. A first item 40 may be inserted (by the load apparatus 420) into a common inlet of the racks to a first storage position of a subset of storage positions 122. Subsequently, a second item 40 may be inserted (by the load apparatus 420) into the same common inlet of the racks to the same first storage position of the subset of storage positions. The automated apparatus may continue to insert items into the common inlet until an item 40 is disposed at all of the storage positions of this subset of storage positions.

Once an item 40 is disposed in the storage positions 122 of this subset of storage positions that is closest to the common outlet, this item may be accessed by an operator or a robot from the “pick face”.

In this embodiment, the racks of the main support unit 120 are arranged so as to be gravity-fed. That is, the support shelves or rails for the items 40 are inclined such that an item 40 inserted into a common inlet falls or slides under the action of gravity to the common outlet. In use, each inlet is disposed at a higher position than its associated outlet. Further, each outlet of the main support unit 120 is provided with a latch mechanism, the latch mechanism arrangeable in a closed configuration in which an item 40 disposed adjacent the outlet is prevented from passing through the outlet; and an open position in which an item 40 disposed adjacent the outlet is allowed to pass through the outlet. Therefore, the main unit 120 comprises a racking system that is generally of the form of a first in, first out (FIFO) racking system. Advantageously, this allows items 40 to be accessed from the outlet (or common outlets) without having to wait until all of the storage positions 122 between the inlet and the outlet are occupied by items 40.

When items 40 are supported by both shelves 424, 425 of the load apparatus 420, the shelves 424, 425 are moved relative to the main support 422 until one of the shelves 424 is adjacent a common inlet 124 of a set of five storage positions 122 (see FIG. 12A). Once so disposed, the conveyor apparatus 426 of the shelf 424 is used to move the item 40 supported by the shelf 424 into the common inlet 124 of the set of adjacent storage positions 122 (see FIG. 12B). The items 40 then move under gravity towards a common outlet of the set of storage positions 122 (see FIG. 12D).

Subsequently, the shelves 424, 425 of the load apparatus 420 are moved so relative to the main support 422 until the other one of the shelves 425 is adjacent a common inlet 124 of a set of five storage positions 122 (see FIG. 12C). This set of five storage positions 122 may be the same set to which the item supported by shelf 424 was transferred. Alternatively, this set of five storage positions 122 (adjacent the other one of the shelves 425) may a different set to which the item supported by shelf 424 was transferred. The item 40 supported at the other one of the shelves 425 is then transferred to the adjacent inlet 124 for a set of storage positions 122 and then moves under gravity towards a common outlet of that set of storage positions 122 (see FIG. 12D).

FIGS. 13A and 13B both show the main support unit 120, the output buffer support unit 450 and the load apparatus 420 with all other components of the system 400 (including the second level 404) removed. As indicated in FIGS. 13A and 13B, different sections of the main support unit 120 may be provided for items to be kept at ambient temperature, chilled items and frozen items.

The functionality of the return item input module 170 and the lift apparatus 470 (operable to move return items received from the return item input module 170 to the second level 404) is now discussed with reference to FIGS. 14A to 14E.

Return items 40 received at the return item at an input location 172 move to the lift apparatus 470 via a conveyor 472 (see FIG. 14A). The conveyor 472 may be actuated (for example under the control of control module 150) or, alternatively, may be a gravity-fed system.

The lift apparatus 470 comprises: a main support 474; and two shelves 475, 476 supported by the main support 474 and suitable for supporting an item 40. The lift apparatus 470 further comprises transfer apparatus operable to transfer return items 40 to and from the shelves 475, 476. Although in this embodiment, the lift apparatus 470 comprises two shelves 475, 476 supported by the main support 474 other embodiments may comprise a different number of shelves. For example, in other embodiments the lift apparatus 470 may only comprises one shelf, which may result in a cost saving. Alternatively, in other embodiments the lift apparatus 470 may comprises more than two shelves, which may result in increased throughput.

The transfer apparatus may comprise apparatus provided on the shelves 475, 476 and operable to push or pull items 40 onto the shelves 475, 476 or to assist in pushing or pulling items 40 onto the shelf 475, 475. In particular, in this embodiment, each of the shelves 475, 476 comprises a shelf conveyor module operable to move items 40 on to or off of that shelf 475, 476. With such an arrangement, the shelf conveyor module can move an item 40 between the shelf 475, 476 it is provided on and an adjacent position. It will be appreciated that in order to move an item 40 the using such a shelf conveyor module the item 40 may be at least partially disposed on the shelf conveyor module.

Each shelf conveyor module may comprise a belt or a cleated belt or the like.

The shelves 475, 476 of the lift apparatus 470 are moved relative to the main support 474 until one of the shelves 476 is adjacent conveyor 472 (see FIG. 14A). A return item 40 received at the return item at an input location 172 moves along conveyor 472 and onto the shelf 476. The movement of the return item 40 onto the shelf 476 may be assisted by the conveyor apparatus on that shelf 476.

Subsequently, the shelves 475, 476 of the lift apparatus 470 are moved relative to the main support 474 until the other one of the shelves 475 is adjacent the conveyor 472 (see FIG. 14B). Another return item is then transferred from the conveyor 472 to the other one of the shelves 475 in a similar way (see FIG. 14C).

Once return items 40 are supported by both shelves 475, 476, the shelves 475, 476 are moved up to the second level 404 (see FIG. 14D). At the second level 404 the items 40 supported by the lift apparatus 470 are transferred to the output return item buffer support unit(s) 480 using the transport robots 430 (see FIGS. 14D and 14E).

In the shown embodiment. The return items are transferred directly from the lift apparatus 470 to the transport robots 430. However, in alternative embodiments an additional buffer unit (similar to the input buffer support unit 440) may be provided adjacent the lift apparatus 470 in the second level 404.

Although not shown in this embodiment, in some embodiments of the system 400, in addition to the intermediate buffer support unit 460, one or more alternative buffer support units may also be provided. In particular, in some embodiments, at least one of the plurality of intermediate buffer storage positions 462 suitable for supporting an item 40 may be provided with an inlet and a separate outlet. In use, the inlet may be disposed at a higher position than the associated outlet. The outlet may be provided with a latch mechanism arrangeable in a closed configuration in which an item disposed adjacent the outlet is prevented from passing through the outlet; and an open position in which an item disposed adjacent the outlet is allowed to pass through the outlet. That is, at least some of the intermediate buffer storage positions 462 may be provided in a racking system that is generally of the form of a first in, first out (FIFO) racking system. In particular, the inlet of these intermediate buffer storage positions 462 may be at a suitable height for an upper shelf 434 of the transport robots 430 to transfer items into the inlet. The outlet of these intermediate buffer storage positions 462 may be at a suitable height for a lower shelf 433 of the transport robots 430 to retrieve items from the outlet. Advantageously, such intermediate buffer storage positions allow a height of an item 40 to be changed, under the action of gravity from one height to another.

The system 400 may have application in an online grocery shopping system, as now discussed with reference to FIG. 15. FIG. 15 shows a flow diagram for a general process 500 for picking groceries and delivering them to customers. The process 500 shown in FIG. 15 is an embodiment of the process 200 shown in FIG. 2 and may comprise any of the feature of the process 200 shown in FIG. 2 and described above.

The process 500, comprises the three steps 210, 220, 230 of the process 200 shown in FIG. 2. However, the process 500 further comprises additional sub-steps, as now discussed.

The first step 210 is for order to be picked (by loading groceries into totes on a trolley) and then for the trolley loaded with totes containing products ordered by customers to be input into the system 400 shown in FIGS. 6A and 6B. This first step 210 involves the following sub-steps.

In particular, at step 510, an operator brings a trolley of totes to an available input location 112 of the input module 110. The availability of the input locations may be determined from the indicator 117 operable to display a status of the input location 112.

Once at the input location 112, at step 512, the operator may input an identification code of the like (for example using user controllable actuator mechanism 118). This may open the door 114, allowing access to the input location 112.

Once the door is open, if the input location 112 is empty, at step 514, the operator can insert the trolley loaded with the groceries he has just picked into the input location 112. Alternatively, the input location 112 may not be empty. Rather there may be another trolley in the input location 112 loaded with empty totes. In this case, at step 516, the operator removes the other trolley in the input location 112 loaded with empty totes (which can be used to pick some more groceries). Once the other trolley in the input location 112 loaded with empty totes has been removed, at step 514, the operator can insert the trolley loaded with the groceries he has just picked into the input location 112.

Finally, at step 518, the door 114 of that input location 112 is closed. This may be closed by the operator (for example using user controllable actuator mechanism 118).

Alternatively, the door 114 may be closed under control of the control module 150.

The next step 220 is for the system 100 to sort the totes, which involves the following sub-steps.

At step 520, the identification module 130 determines identification data for each tote disposed on that trolley. This may be in response to a sensor or the like at the input location 112 determining the presence of a trolley. Alternatively, this may be in response to a signal sent to the identification module 130 by the control module 150 (for example in response to a signal received by the control module 150 from an input location 112 of the input module 110 notifying it that a trolley has been placed into that input location 112). The identification module 130 then sends the determined identification data for each tote disposed on that trolley to the control module 150.

At step 521, the totes are unloaded from the trolley using the unload apparatus 410. In particular, the transfer apparatus is used to transfer items 40 from the trolley 10 to the two pairs of adjacent shelves 413a, 413b of the lift unit 411. This is achieved using the manipulator 414 disposed adjacent to the input location 112 and apparatus provided on the shelves 413a, 413b (for example a conveyor module or the like).

Once removed from the trolley, at step 522, the totes are lifted to the second level 404 using lift unit 411.

Once at the second level, at step 523, the totes 40 are transferred to the input buffer support unit 440 for subsequent collection by a transport robot 430.

It will be appreciated that steps 521, 522 and 523 may be repeated until all of the totes have been transferred from the trolley 10 at the input location 112 to the input buffer support unit 440.

From the input buffer support unit 440, at step 524, the totes 40 may be transferred directly to the output buffer support unit 450 using the transport robots 430.

Alternatively, at step 525, one or more of the totes 40 may be transferred from the input buffer support unit 440 to the intermediate buffer support unit 460. Optionally, at step 526, one or more special items (which may not be stored on the main shop floor) may be added to one or more of the totes 40 while they are disposed at the intermediate buffer support unit 460. Subsequently, totes 40 at the intermediate buffer support unit 460 may be transferred to the output buffer support unit 450 using the transport robots 430.

At step 527, totes 40 are transferred from the output buffer support unit 450 (on the second level 404) to the main support unit 120 (on the first level 402) using the load apparatus 420.

The last step 230 is for the totes disposed on the main support unit 120 to be loaded in to a delivery van, which involves the following sub-steps.

First, at step 530, an operator (for example a driver) removes totes 40 from the pick-face of the main support unit 120 using a multi-tote picker.

The multi-tote picker may comprise a manual or automated trolley (for example a robot) operable to remove a plurality of totes from a block of adjacent storage positions 122.

This may comprise opening a latch mechanism of the outlets of the storage positions 122, the items 40 supported at those positions to move onto the multi-tote picker. The actuation of the latch mechanisms may be achieved in any convenient way, as would be understood by the skilled person. For example, the multi-tote picker may comprise actuators (mechanical, electronic, magnetic etc.) operable to actuate the latch mechanisms (for example under the control of the control module 150). Alternatively, the control module 150 may actuate the latch mechanisms directly (for example, upon receipt of a signal from the multi-tote picker indicating that it is in place adjacent the outlets of the storage positions 122. The multi-tote picker may comprise apparatus arranged to assist movement of the items 40 onto the multi-tote picker.

Next, at step 532, an operator (for example a driver) transfers the totes 40 from the multi-tote picker to a delivery van.

Throughout FIGS. 16 to 31E, unless stated to the contrary, a consistent right-handed set of Cartesian axes will be used. The system 600 may be provided supported by a support substrate (for example a floor) that is parallel to the x-y plane of the Figures. A direction perpendicular to the support substrate or floor is the z-direction in the Figures. In the following, unless stated to the contrary, the distance of an element in the z-direction from a support substrate may be referred to as the height of that element. Furthermore, any reference to higher, upper, above or the like is intended to mean farther from the support substrate; and any reference to lower, below or the like is intended to mean closer to the support substrate.

FIG. 16 is a schematic representation of a system 600 for receiving and sorting items according to a second embodiment of the present invention. The system 600 shown in FIG. 16 is an embodiment of the system 100 shown in FIG. 1 and may comprise any of the features of the system 100 shown in FIG. 1 described above.

In this embodiment, the automated apparatus 140 comprises: a first automated device 610; a second automated device 620; and, optionally, a return item transport system 650. In this embodiment, the functionality of the unload apparatus; the load apparatus; and the transport robot are provided by the second automated device 620. The first automated device 610 is operable to collect mobile storage units 10 from input locations 112 and move them to a transferring position 612 for unloading (and, optionally, for re-loading with return items such as empty tote boxes). This embodiment of the system 600 may be appropriate for lower volumes or lower throughputs of items (for example totes containing groceries) and/or for arrangements wherein there is no room on the shop floor for input locations 112.

As discussed further below, the second automated device 620 is operable to remove items 40 supported by a mobile support unit 10 at the transferring position 612 and to move them to the main support unit 120.

The input module 110 comprises a plurality of input locations 112. As with the system 100 of FIG. 1, each of the plurality of input locations 112 is arranged to receive a mobile support unit supporting a plurality of items. Each of the plurality of input locations 112 comprises an identification submodule 132 operable to determine identification data from each item supported by a mobile support unit received in that input location 112. The identification submodules 132 form part of the identification module 130 shown in FIG. 1.

As with the system 100 of FIG. 1, the main support unit 120 comprises a plurality of storage positions 122. Each of the plurality of storage positions 122 is suitable for supporting an item.

The first automated device 610 is operable to move a mobile support unit 10 between each of the plurality of input locations 112 of the input module 110 and a transferring position 612.

The second automated device 620 is movable between at least a first position 622 (see FIG. 16) and a plurality of second positions 624. The first position 622 is adjacent to the transferring position 612. Each one of the plurality of second positions 624 is adjacent to at least one of plurality of the storage positions 122 of the main support unit 120. The second automated device 620 is configured to move items to or remove items from an adjacent support. For example, when the second automated device 620 is disposed in the first position 622 (adjacent to the transferring position 612) the second automated device 620 may be operable to remove items from a mobile support unit 10 disposed in the transferring position 612. Furthermore, when the second automated device 620 is disposed in one of the plurality of second positions 624 (adjacent to at least one of plurality of the storage positions 122 of the main support unit 120) the second automated device 620 may be operable to move items to one of said at least one storage positions 122 of the main support unit 120.

In some embodiments, the second automated device 620 may be positionable in a plurality of first positions 622 (for example two first positions 622), each of the plurality of first positions 622 being adjacent to the transferring position 612.

The control module 150 is configured to receive identification data 152 from the identification submodule 132 of each of the plurality of input locations 112. The control module 150 is further configured to control the first and second automated devices 610, 620 to move a plurality of items from the input module 110 each to a different one of the plurality of storage positions 122 of the main support unit 120. To achieve this, the control module 150 may be operable to send a first control signal 154 to the first automated device 610 and may be operable to send a second control signal 156 to the second automated device 620. In particular, as will be described in further detail below, the control module 150 is configured such that the storage position 122 of each item is selected in dependence on the identification data 152 determined from that item.

Optionally, in some embodiments, the system 600 may further comprise a manipulator 630 disposed adjacent to the transferring position 612. The manipulator 630 may comprise a plurality of movable manipulators that are be operable to transfer items between the second automated device 620 and a mobile support unit 10 disposed in the transferring position 612 when the second automated device 620 is disposed in the first position 622 (adjacent to the transferring position 612). The functionality of the manipulator 630 is similar to that of the manipulator 414 of the system 400 shown in FIGS. 6A and 6B. The control module 150 may be configured to control the manipulator 630 to move a plurality of items from the transferring position 612 to and/or from the second automated device 620. Such control may be affected by sending a control signal 158 from the control module 150 to the manipulator 630.

The system 600 shown in FIG. 16 is advantageous, as now discussed. The provision of the first and second automated devices 610, 620 provides an automated system for moving items received at the input module 110 to the main support unit 120. The first automated device 610 can move a mobile support unit from one of the input locations 112 to the transferring position 612. The second automated device 620 can move to the first position 622 adjacent the transferring position 612 and retrieve an item from the mobile support unit 10. Subsequently, the second automated device 620 can be moved to one of the plurality of second positions 624 adjacent one or more of the storage positions 122 of the main support unit 120. While in this second position 624, the second automated device 620 can be used to move the item to an adjacent storage position 122. The second automated device 620 can then return to the first position 622, retrieve another item from the mobile support unit and move it to a different storage position 122 in the main support unit 120. This process can be repeated several times.

As with the system 100 of FIG. 1, since the storage position 122 of each item 40 is selected in dependence on the identification data 152 determined from that item 40, advantageously, the items 40 can be sorted according to the identification data. For example, it may be desirable to group items in a plurality of different groups (each group may, for example, relate to a different customer and/or a different delivery van). For this purpose, the identification data 152 may include a group identifier and the storage position 122 of each item may be selected in dependence on the group identifier for that item. As discussed above, items 40 with the same group identifier may, for example, be placed in adjacent storage positions 122 in the main support unit 120.

The provision of an input module 110 comprising a plurality of input locations 112 advantageously provides a buffer for the input of mobile support units 10. For example, two or more mobile support units 10 can be provided to the input module 110 at substantially the same time and the first automated device 610 can move each of these mobile support units into the transferring position 612 in turn. This avoids having to wait for a first one of the mobile support units 10 to be unpacked before a second mobile support unit 10 can be received by the input module 110.

In some embodiments, the main storage unit 120 is a one-way storage unit. For example, each of the plurality of storage positions 122 may be provided with an inlet and a separate outlet. The plurality of second positions 624 of the second automated device 620 may be adjacent the inlet of one or more of the storage positions 122 of the main support unit 120. The second automated device 620 may be operable to move items 40 to an adjacent storage position 122 via its inlet. The outlets may be accessible by an operator (or a robot) such that items 40 can be removed from the storage positions 122 via the outlets by such an operator or robot. In some embodiments, a subset of storage positions 122 may share a common inlet and a common outlet. The system 600 may be operable to move items into the common inlet, through the subset of storage positions 122 for collection out of the common outlet. The subset of storage positions 122 may be arranged in a line and may be referred to as a line or row of storage positions 122.

In some embodiments, the system 600 may comprise a return system 640. The return system 640 may comprise at least one return item storage position 660 for supporting a return item. The second automated device 620 may be movable to a return position 626 adjacent the return item storage position 660.

The control module 150 may be configured to control the second automated device 620 to move a plurality of return items 40 from a return item storage location 660 to the mobile support unit 10 whilst the mobile support unit 10 is in the transferring position 612. The control module 150 may be configured to control the second automated device 620 so as to replace each item 40 that is moved to a storage position 122 with a return item 40 from a return item storage position 660.

The return system 640 may further comprise the return item input position 172 and the return item transport system 650. The return item transport system 650 may be operable to transport return items 40 from the return item input position 172 to the return item storage position 660. The return item transport system 650 may be at least partially gravity-fed. Alternatively or in addition, the return item transport system 650 may comprise a third automated device (which third automated device may form part of the automated apparatus 140 of FIG. 1).

The control module 150 may be configured to control the return item transport system 650 to move a plurality of return items from return item input position 172 to the return item storage position 660. Such control may be affected by sending a control signal 159 from the control module 150 to the return item transport system 650.

The various components of the system 600 are now explained in greater detail with reference to FIGS. 17 to 31E.

FIGS. 17 and 18 are schematic plan and perspective views of parts of the system 600 for receiving and sorting items shown in FIG. 16. FIG. 19 is an enlarged perspective view of the input module 110 of the system 600 shown in FIGS. 17 and 18. FIG. 20 is an enlarged perspective view of an empty input location 112 of the input module 110 of the system 600 shown in FIGS. 17 and 18.

In the embodiment shown in FIGS. 17, 18 and 19, the input module 110 comprises nine input locations 112.

In FIGS. 17 and 18, all of the input locations 112 are shown with an example mobile support unit 10 received therein and another example mobile support unit 10 is shown in the transferring position 612. However, it will be appreciated that, in use, when one mobile support unit 10 is disposed in the transferring position 612 at least one of the input locations 112 may be empty (for example an input location 112 from which the mobile support unit 10 disposed in the transferring position 612 came).

Each of the input locations 112 may be considered to provide a parking bay or port for a mobile support unit 10 supporting a plurality of items. In use, a plurality of tote boxes 40 may be supported on the mobile support unit 10 (as shown in FIG. 3) and an operator may pick goods for a number of different customer orders and place them in the tote boxes 40. Once all of the desired items have been placed in the tote boxes 40, the operator can push the mobile support unit 10 into one of the input locations 112. The system 600 can then transfer the tote boxes 40 to appropriate storage positions 122 using the first and second automated devices 610, 620.

In general, each input location 112 may comprise an alignment structure arranged to aid the placement of a mobile support unit 10 in an alignment position. Alternatively or in addition, each input location 112 may comprise a guide structure, which may be arranged to help guide a mobile support unit 10 to an alignment position.

As can be seen most clearly in FIG. 20, each input location 112 comprises: two side structures 680 and a base structure 682.

The two side structures 680 are each generally of the form of a wall or fence and define between them a volume for receipt of a mobile support unit 10.

Each side structure 680 comprises a plurality of generally parallel guide bars 686 supported at each end by a support 688. The supports 688 are generally vertical and may be attached to a floor of the like in any convenient manner. The guide bars 686 are generally horizontal. The guide bars 686 are shaped such that a volume defined between them is smaller in a central region than at each end of the input location 112.

For example, each guide bar may have two side portions that are supported by the supports 688 and which extend at least partially towards the opposite side structure 680. The two side portions are connected by a central portion that extends generally parallel to the opposite side structure 680. Advantageously, the central regions may constrain the mobile support unit 10 in an alignment position while the side portions help the insertion of the mobile support unit 10 into the input location 112 from either side.

Although the side structures 680 are of the form of fence structures, in alternative embodiments the side structures 680 may be of the form of continuous walls.

Guide bars 686 for the side structures 680 for two adjacent input locations 112 may share one or more common supports 688.

The base structure 682 is of the form of two pairs of guide rails 684. Each pair of guide rails 684 is arranged for receipt of two wheels 30 of a mobile support unit 10.

Each of the pairs of guide rails 684 comprises an inner rail 690 and an outer rail 692. As shown in FIG. 20, in some embodiments the inner rails 692 may be linked by a connecting rail 694. The inner rails 690 and the connecting rail 694 may define a space for receipt of the first automated device 610. The connecting rail 694 may provide a physical stop to prevent first automated device 610 from exiting the system 600.

Each pair of guide rails 684 is shaped such that a distance between the inner rail 690 and the outer rail 692 is smaller in a central region than at each end of the input location 112. For example, each pair of guide rails 684 may have a central region in which the inner and outer rails 690, 692 are substantially parallel and two tapered or flared end portions. Advantageously, the central regions of the pairs of guide rails 684 may constrain the mobile support unit 10 in an alignment position while the tapered or flared end portions help the insertion of the mobile support unit 10 into the input location 112 from either side.

In some embodiments, a physical stop (not shown) may be provided at the end of each pair of guide rails 684. In use, an operator could push a trolley 10 into the input location 112 until the front wheels contact such these physical stops. It will be appreciated that for such embodiments, the first robot 610 would have to lift the trolley 10 high enough to clear the physical stops in order to move it to the transferring position 612.

Each of the plurality of input locations 112 comprises an identification submodule 132 operable to determine identification data from each item 40 supported by a mobile support unit 10 received in that input location 112. In this embodiment, as shown in FIGS. 21A and 21B, the identification submodule 132 comprises a plurality of sensors 700 supported by the side structures 680.

In this embodiment, the sensors 700 are attached to the guide bars 686 of the side structures 680 via sensor support bars 702. In particular, the identification submodule 132 comprises four sensor support bars 702. Each sensor support bar 702 supports two sensors 700. Each of the sensors 700 is positioned such that it is adjacent an identification mark 42 of one of the tote boxes 40 on the mobile support unit 10 when disposed in the input location 112.

As shown schematically in FIG. 21B, the sensor is operable to scan 704 or image the identification mark 42 so as to read or otherwise determine identification data from an adjacent item 40.

In general, each of the sensors 700 may comprise an imaging system and a processor. The imaging system may be operable to form an image of a visual marker on an item 40 supported by a mobile support unit 10 received in the input location 112. For example, the imaging system may comprise a camera operable to from an image of a marker 42 on the item 40. The processor may be operable to determine the identification data from said image. The processor may be operable to execute suitable recognition software to identify a code from the image. The processor may be integrated with the imaging system or, alternatively, may be remote from the imaging system. A single processor may be shared by a plurality of sensors 700. The processor may, for example, form part of the control module 150.

Alternatively, any suitable form of identification submodule may be used, using, for example, bar codes, QR codes or the like.

FIG. 22 shows an embodiment of a first automated device 610. In general, the first automated device 610 comprises a movable body 614 and a height adjustment mechanism for adjusting a height of said body 614. The body 614 is provided with a plurality of protrusions 616 from a surface of the body 614 which in use forms an upper surface of the body. The protrusions 616 provide contact points for contacting a mobile support unit 10 (for example a base 22 of the mobile support unit 10).

The first automated device 610 may further comprise: a drive mechanism (not shown) operable to move the movable body 614 relative to a support substrate (for example the floor). The movable body 614 is supported by a plurality of wheels (not shown). The drive mechanism may be operable to control said plurality of wheels to move the movable body 614 relative to a support substrate. As used here, control of the wheels may include actuation of the wheels (i.e. spinning the wheels about their axes) and/or changing a direction of the wheels (i.e. rotating the wheels about an axis perpendicular to their axes). The drive mechanism may comprise: one or more motors; a power supply (such as a battery or the like); and an autonomous control system (which may control the one or more motors in response to signals received from the main control module 150 of the system 600).

Such a first automated device 610 may be operable to move beneath a mobile support unit 10, engage the mobile support unit 10 from below and then move the mobile support unit 10 to another location, as discussed below with reference to FIGS. 9A, 9B and 11. The first automated device 610 either lift the mobile support unit 10 from below or, alternatively, releasably engage with it so that the mobile support unit 10 is towed or dragged along with the first automated device 610 (but still supported by its own wheels).

As shown in FIGS. 23A and 23B, the first automated device 610 has suitable dimensions to allow it to be received below base 22 of the mobile support unit 10, between the wheels 30. Once so positioned, the first automated device 610 is operable to releasably engage (and, optionally, lift) the mobile support unit 10 from below and then move the mobile support unit 10 to another location.

FIG. 24 shows an embodiment of a second automated device 620.

The second automated device 620 comprises a main body 710. The main body 710 comprises a base portion 712 and two support rails 714. In use, the base portion 712 may be disposed on a support substrate (for example a floor or the like) that is parallel to the x-y plane of FIG. 24. The support rails 714 extend from the base 712 generally in a direction perpendicular to the support substrate or floor (i.e. the z-direction in FIG. 24). The main body 710 is movable between at least the first position 622 (adjacent to the transferring position 612, see FIG. 16) and the plurality of second positions 624 (adjacent to at least one of plurality of the storage positions 122, see FIG. 16). In particular, in order to achieve this, the main body 710 is movable in the x-direction in FIG. 24.

The second automated device 620 further comprises a lifting module 720. The lifting module 720 is movably supported by the two support rails 714. In particular, the lifting module 720 is operable to move generally along the two support rails 714, in the z-direction in FIG. 24. In the following, unless stated to the contrary, the distance of an element in the z-direction from the surface of the base portion 712 that contacts the support substrate may be referred to as the height of that element. Furthermore, any reference to higher, upper, above or the like is intended to mean farther from the surface of the base portion 712 that contacts the support substrate; and any reference to lower, below or the like is intended to mean closer to the surface of the base portion 712 that contacts the support substrate.

The lifting module 720 comprises at least one conveyor module 722. In this embodiment, the lifting module 720 comprises two conveyor modules 722. The two conveyor modules 722 are provided at different, non-overlapping positions in a direction parallel to the support rails 714. That is, in FIG. 24, the two conveyor modules 722 are provided at different z-positions or heights (one above the other).

Each conveyor module 722 comprises a movable member 724 and a shelf 726. The movable member 724 and the shelf 726 are both supported by the lifting module 720. The movable member 724 and the shelf 726 of the same conveyor module 722 may be referred to as corresponding. The movable member 724 of each conveyor module 722 is disposed farther from the base portion 712 than its corresponding shelf 726.

Therefore, in use, the movable member 724 is disposed generally above its corresponding shelf 726.

Each shelf 726 is suitable for supporting an item (for example a tote box 40). Each moveable member 724 is of the form of an extendable self that is supported by the lifting module 720 and can extend from the lifting module 720 in either direction in the y-direction.

In particular, each moveable member 724 is moveable between a retracted position and at least one extended position. When disposed in the retracted position, the movable member 724 is disposed at substantially the same position in the y-direction as its corresponding shelf 726. That is, in the retracted position, the moveable member substantially overlies its corresponding shelf 726. When disposed in an extended position, the movable member 724 extends away from its corresponding shelf 726 in the y-direction. In particular, when disposed in an extended position, the movable member 724 may extend away from its corresponding shelf 726 in the y-direction by a sufficient distance such that it can substantially overlie an item (for example a tote box 40) disposed adjacent the second automated device 620.

Each moveable member 724 is generally of the form of an extendable, nestable, collapsible, or telescopic arm or panel that is supported by the lifting module 720 and can extend from the lifting module 720 in either direction in the y-direction (to two different extended positions).

In FIG. 24, the moveable member 724 of the upper conveyor module 722 (i.e. the conveyor module 722 farthest from the base portion 712) is shown in a retracted position. In FIG. 24, the moveable member 724 of the lower conveyor module 722 (i.e. the conveyor module 722 closest to the base portion 712) is shown in an extended position.

When disposed in an extended position, the movable member 724 may extend away from its corresponding shelf 726 in the y-direction such that it substantially overlies an item (for example a tote box 40) disposed on another support adjacent the second automated device 620. This other support may comprise a mobile support unit disposed in the transferring position 612 and/or the main support unit 120.

Each movable member 724 comprises an engagement mechanism or latch mechanism that is arranged to allow the movable member to releasably engage an item (for example a tote box 40) disposed below the movable member 724. For example, each movable member 724 may comprise one or more retractable projections which extend generally downwards (i.e. in the negative z-direction in FIG. 24). With such retractable protrusions in a retracted position, the movable member 724 can be moved (generally on the y-direction) until it is disposed above a tote box 40. Once the movable member 724 is disposed directly above the tote box 40 the retractable projections can be extended such that they partially extend into the tote box. Subsequently, when the movable member 724 is moved in the y-direction, it will drag the tote box 40 with it.

In this way, the moveable member 724 can be used to move items from its corresponding shelf 726 to an adjacent support, or from an adjacent support to its corresponding shelf 726. Therefore, each movable member 724 is movable relative to the main body 710 and is configured to move items to or remove items from an adjacent support (in either direction in the y-direction).

In this embodiment, each shelf 726 is of the form of a roller shelf, comprising a plurality of rollers aligned generally in the x-direction. The plurality of rollers help to drag a tote box 40 to or from the shelf 726 in the y-direction. Generally, the plurality of rollers are aligned in a direction generally perpendicular to a movement direction of the moveable member 724.

In general, the main body 710 of the second automated device 620 is movable in the plane of a support substrate (for example a floor or the like) on which the main body 710 is disposed (i.e. the x-y plane of FIG. 24). The movement of the main body 710 of the second automated device 620 (for example in the x-y plane) may be linear, rectilinear or curved. In general, the lifting module 720 is movable perpendicular to the plane of a support substrate (for example a floor or the like) on which the main body 710 is disposed (i.e. in the z-direction in FIG. 24). In general, the moveable members 724 are movable in a direction generally perpendicular to the movement direction of the lifting module 720. For example, the moveable members 724 are moveable in a direction that is also parallel to a plane of the support rails 714. In FIG. 24, the support rails lie in a plane parallel to the y-z plane and the movable members 724 are movable in the y-direction.

In use, the second automated device 620 can move generally in the x direction between the first position 622 and a plurality of second positions 624.

Each one of the plurality of second positions 624 is adjacent to a plurality of the storage positions 122 of the main support unit 120. When the second automated device 620 is disposed in each one of the plurality of second positions 624, the lifting module 720 can move generally along the two support rails 714 (in the z-direction in FIG. 24) so as to position the movable members 724 adjacent a plurality of different storage positions 122 adjacent the main body 710. Therefore, the movable members 724 are movable relative to the main body 710 so as to be positionable adjacent a plurality of different storage positions 122 adjacent the main body 710.

Each movable member 724 is operable to move both: vertically (i.e. in the z-direction), so as to be at a suitable height for moving an item; and horizontally (for example in the y-direction), to move an item to or from the main body 710 of the second automated device 620.

The main support unit 120 comprises two racking units 123, 124, each comprising a plurality of storage positions 122. In this embodiment, the two racking units 123, 124 are separated by an aisle 125. In use, the second automated device 620 moves along the aisle 125 so as to be positionable in the plurality of second positions 624 that are adjacent to the storage positions 122 of the main support unit 120.

In this embodiment, the main storage unit 120 is a one-way storage unit. In particular, both of the two racking units 123, 124 are one-way storage units. For example, each of the plurality of storage positions 122 is provided with an inlet and a separate outlet. In this example, all of the inlets are adjacent the aisle 125. Therefore, the plurality of second positions 624 of the second automated device 620 are adjacent the inlet of each of the storage positions 122 of the main support unit 120. As will be discussed further below with reference to FIGS. 31A to 31E, the outlets of the storage positions 122 can be accessible by an operator such that items can be removed from the storage positions 122 via the outlets by such an operator.

Each of the racking units 123, 124 comprises a plurality of wall structures 126. Each pair of adjacent wall structures 126 define between them a volume 127, which defines a set of the storage positions 122. As can be seen most clearly in FIG. 19, each wall structure 126 comprises a plurality of uprights supports 128 that are aligned to form the wall structure 126. The upright supports 128 are generally vertical and may extend from the floor. On each side of each wall structure that faces an adjacent wall structure 126, a plurality of ledges or flanges 129 are provided. Said flanges 129 extend generally perpendicular to the upright supports 128. The flanges 129 on each side of the volume 127 defined between each pair of adjacent wall structures 126 are provided in pairs disposed at substantially the same height. In use, each such pair of corresponding flanges 129 is arranged to support two opposite sides of a tote box 40.

Each pair of corresponding flanges 129 may be considered to define a support plane upon which a box or crate can be placed. The items may take any desirable form but in some examples, the items may be of the form of a box, container or crate (for example a tote box 40).

Between each pair of adjacent flanges 129 (which are at different heights) on a given wall structure 126, there is defined a row of storage positions 122. As can be seen most clearly in FIG. 4, in this embodiment, within each volume 127, five rows of storage positions 122 are defined (at different heights). The number of storage positions 122 in each such row of storage positions 122 is dependent on a depth of the row of storage positions (and a depth of length of the items 40 to be stored). It will be appreciated that as used here, the depth of a row of storage positions 122 is defined by a dimension of the wall structures 126 (in the y-direction in the Figures).

In this embodiment, each such row of storage positions 122 share a common inlet and a common outlet. The system 600 may be operable to move items into the common inlet, through the row of storage positions 122 and out of the common outlet.

In general, each such row of storage positions 122 may have any convenient depth. In this embodiment, a first one of the racking units 123 has a depth of three tote boxes 40 or three storage positions 122; and a second one of the racking units 124 has a depth of two tote boxes 40 or three storage positions 122.

In FIG. 17, the second automated device 620 is disposed in the first position 622 that is adjacent to the transferring position 612. Also shown in FIG. 17 is one example second position 624 of the second automated device 620 (indicated by dotted line). The position 628 of the lifting module 720 of the second automated device 620 when the second automated device 620 is disposed in this example second position 624 is also shown.

When the second automated device 620 is disposed in this example second position 624, the lifting module 720 of the second automated device 620 is adjacent one of the volumes 127 defined between a pair of adjacent wall structures 126 in the first racking unit 123 and is adjacent one of the volumes 127 defined between a pair of adjacent wall structures 126 in the second racking unit 124.

The functionality of the system 600, and methods which can be implemented by the system 600 (for example under the control of the control module 150), are now discussed.

Upon receipt of a mobile support unit 10 at an input location 112, identification data may be determined for each item 40 supported by that mobile support unit 10 by one of the identification submodules 132. Once determined, the identification data is transmitted to the control module 150.

The control module 150 may be configured to control the first automated device 610 to move a mobile support unit 10 from one of the input locations 112 to the transferring position 612. In order to achieve this, the first automated device 610 is moved until it is disposed under a mobile support unit 10 in an input location 112. The first automated device 610 then releasably engages (and, optionally, lifts) the mobile support unit 10 and moves with the mobile support unit 10 to the transferring position 612. This is shown rather schematically in FIG. 25 by arrow 730.

Once a mobile support unit 10 is disposed in the transferring position 612, the control module 150 may be configured to control the second automated device 620 to move a plurality of items 40 from the mobile support unit 10 each to a different one of the plurality of storage positions 122 of the main support unit 120. This is shown rather schematically in FIG. 25 by arrow 732 and will now be described with reference to FIGS. 26A to 29B.

To achieve this, the second automated device 620 is moved to a first position 622 in which the lifting module 720 is adjacent a support of the mobile support unit 10 upon which an item 40 is disposed. In particular, in the first position 622 the lifting module 720 is at substantially the same x position as a support of the mobile support unit 10 upon which an item 40 is disposed. It will be appreciated that this embodiment is adapted for the example mobile support unit 10 shown and which has two columns of support positions for items 40 (offset from each other in the x-direction). It will therefore be further appreciated that in this embodiment, the second automated device 620 is positionable in two different first positions 622, each of the plurality of first positions 622 being adjacent to the transferring position 612. In a first one of the first positions 622 the lifting module 720 is adjacent one column of supports of the mobile support unit 10 at the transferring position 612 and in a second one of the first positions 622, the lifting module 720 is adjacent the other column of supports of the mobile support unit 10 at the transferring position 612.

FIG. 26A shows the second automated device 620 in one first position 622 with the lifting module 720 positioned such that the upper shelf 726 is at substantially the same height as an upper support of the mobile support unit 10 upon which an item 40 is disposed.

As shown in FIG. 26B, once in this position, the corresponding movable member 724 is extended into an extended position above an item 40 supported by the mobile support unit 10. Once in the extended position, an engagement mechanism or latch mechanism of the movable member 724 is actuated to releasably engage the item 40 disposed below the movable member 724.

Subsequently, as shown in FIGS. 26C and 26D, the movable member 724 is moved (in the y-direction) back to the retracted position (see FIG. 26D), dragging the tote box 40 with it onto the corresponding shelf 726.

In this embodiment, the system 600 further comprises a manipulator 630 disposed adjacent to the transferring position 612. The manipulator 630 comprises a plurality of movable manipulators 632 that are be operable to transfer items 40 between the second automated device 620 and a mobile support unit 10 disposed in the transferring position 612 (when the second automated device 620 is disposed in the first position 622, adjacent to the transferring position 612).

Each of the plurality of movable manipulators 632 of the manipulator 630 is aligned with one of the items 40 supported by a mobile support unit 10 when disposed in the transferring position 612. Each of the plurality of movable manipulators 632 of the manipulator 630 is movable generally in the y-direction, for example between a retracted position and an extended position.

In FIG. 27A, the plurality of movable manipulators 632 of the manipulator 630 are each disposed in the retracted position. FIG. 27A shows the second automated device 620 in one first position 622 with the lifting module 720 positioned such that the lower shelf 726 is at substantially the same height as a lower support of the mobile support unit 10 upon which an item 40 is disposed.

As shown in FIG. 27B, once in this position, one of the movable manipulators 632 of the manipulator 630 which is adjacent the item 40 disposed on the lower support of the mobile support unit 10 is moved to an extended position. As this movable manipulator 632 of the manipulator 630 moves to the extended position it pushes the tote box 40 onto the adjacent shelf 726.

In some embodiments, the movable manipulators 632 of the manipulator 630 may each comprise an engagement mechanism to allow it to releasably engage a tote box 40.

This would allow the movable manipulators 632 of the manipulator 630 to also drag items (for example empty tote boxes 40) from the second automated device 620 to the mobile support unit 10.

The movable manipulators 632 of the manipulator 630 may be used to move items 40 to or from supports of a mobile support unit 10 when disposed in the transferring position 612 if there is insufficient clearance for one of the movable members 724 of the second automated device 620 to be inserted above the item 40. This may be the case, for example for items other than the item disposed on an uppermost support of the mobile support unit 10.

Once items have been transferred from a mobile support unit 10 to the second automated device 620, the control module 150 is operable to control the second automated device 620 to transfer them to storage positions 122 of the main support unit 120. This is now described with reference to FIGS. 28A to 29B.

FIGS. 28A to 28C show sequential steps in the transfer of an item 40 from the second automated device 620 to a storage position 122 of the main support unit 120.

FIG. 28A shows the second automated device 620 in a second position 624 with the lifting module 720 positioned such that the upper shelf 726 is at substantially the same height as a support flange 129 of a target support position 122. On the upper shelf 726 is disposed an item 40 to be transferred and furthermore, the corresponding movable member 724 (which is in a retracted position) is engaged with said item 40 to be transferred. In FIG. 28A, another item 40 is already disposed in the target support position 122.

As shown in FIGS. 28B and 28C, once in this position, the corresponding movable member 724 is extended into an extended position, dragging the item 40 engaged therewith onto the target support position 122 (see FIG. 28C). The other item 40 that was already disposed in the target support position 122 is pushed to an adjacent support position 122.

FIGS. 29A to 29B show schematically how a movable member(s) 724 of the second automated device 620 can be used to move an item 40 from one storage position 122 of the main support unit 120 to another.

It may be useful for the control module 150 to control the second automated device 620 to move an item 40 from one storage position 122 of the main support unit 120 to another (for example to push it adjacent to an outlet of those storage positions 122 for easier extraction by an operator).

FIG. 29A shows the second automated device 620 in a second position 624 with the lifting module 720 positioned such that the lower movable member 724 is at the same height as part of an adjacent item disposed in a support position 122. The lower movable member 724 which is in a retracted position and the corresponding shelf 726 is empty.

As shown in FIG. 29B, once in this position, the corresponding movable member 724 can extended into an extended position pushing the adjacent item into an adjacent support position 122.

In this embodiment, since the main storage unit 120 has a depth greater than a single item 40, as already discussed, the control module 150 is operable to control the second automated device 620 to move an items 40 sequentially through a plurality of storage positions 122 from an inlet surface of main storage unit 120 (adjacent the second automated device 620) to an outlet surface (or pick face) of the main support unit 120 for subsequent retrieval from the pick face by an operator. As discussed above, the sequencing or ordering of the items between the inlet surface and the pick face may be chosen so that the number of delivery vans that can be simultaneously loaded with items from the main storage unit 120 is maximized for a given depth of the main storage unit 120.

Furthermore, in order to achieve a desired sequencing or ordering of the items between the inlet surface and the pick face the control module 150 may be operable to control the second automated device 620 to temporarily place one or more items 40 in a storage position 122 adjacent the second automated device 620. Once another item that is to be retrieved from the same location on the pick face but earlier than the temporarily stored item 40 has been inserted into the correct inlet storage position 122, the temporarily stored item 40 may be retrieved from the temporary storage position 122 adjacent the second automated device 620 and placed into the correct inlet storage position 122. Advantageously, this may give the system 600 greater flexibility and may help to achieve a desired sequencing or ordering of the items between the inlet surface and the pick face.

The return system 640 is now discussed with reference to FIGS. 17, 18 and 30A-30G.

In this embodiment, the return system 640 comprises the return item storage position 660 for supporting a return item 40. The second automated device 620 is movable to a return position 626 adjacent the return item storage position 660. As can be seen, for example, in FIGS. 17 and 18, the return item storage position 660 is provided above a set of the storage positions 122 of main support unit 120 in the first racking unit 123. Therefore, in this embodiment, the return position 626 coincides with one of the second positions 624. Once the second automated device 620 is disposed in the return position 626 adjacent the return item storage position 660, the lifting module 720 can be used to position one of the shelves 726 adjacent the return item storage position 660. Once so disposed, the corresponding movable member 724 can be used to pull a return item (for example an empty tote box 40) onto the shelf 726.

The return system 640 further comprises a return item input position 172. The return item input position 172 is disposed at an end of the main storage unit 120 that is distal to the input module 110. As can be seen in FIGS. 17, 18 and 30A, the return item input position 172 comprises a conveyor 642 upon which stacks 644 of empty tote boxes 40 can be placed by an operator (see FIG. 30A). The conveyor 644 may be active or passive (for example gravity-fed).

The return system 640 further comprises the return item transport system 650 (see FIG. 16), as now discussed. The return item transport system 650 is operable to transport return items 40 from the return item input position 172 to the return position 660.

The return item transport system comprises 650: a second lifting module 651 and a third automated device 652.

The second lifting module 651 comprises a support frame 653 and platform 654. The platform 654 is movably supported by the support frame 653 and is operable to move relative to the support frame 653 in the z-direction.

The third automated device 651 comprises a support frame 655 and a movable member 656. The movable member 656 is movably supported by the support frame 655 and is movable relative to the support frame 655 between a first, picking position and a second, dropping position. In this embodiment, the movable member 656 is movable generally in the x-direction. When disposed in the first, picking position, the movable member 656 is disposed generally above the platform 654 of the second lifting module 651. When disposed in the second, dropping position, the movable member 656 is disposed generally above a gravity fed roller conveyor 658.

The movable member 656 comprises an extendable portion 657. The extendable portion 657 is moveable relative to a portion of the movable member 656 that is connected to the support frame 655 between a retracted position and an extended position. In particular, the extendable portion 657 is moveable relative to the portion of the movable member 656 that is connected to the support frame 655 in a direction generally perpendicular to a movement direction of the movable member 656 relative to the support frame 655 (i.e. the z-direction).

The extendable portion 657 of the movable member 656 is arranged to be partially received in an interior of a tote box 40 (for example, when the extendable portion 657 of the movable member 656 is disposed in the extended position).

The extendable portion 657 of the movable member 656 comprises an engagement mechanism or latch mechanism that is arranged to allow the extendable portion 657 of the movable member 656 to releasably engage an item (for example a tote box 40) disposed below the extendable portion 657. For example, the extendable portion 657 of the movable member 656 is may comprise one or more retractable projections which extend generally in the x-y plane. With such retractable protrusions in a retracted position, the extendable portion 657 of the movable member 656 can be moved (generally in the z-direction) until it is partially disposed within in interior of a tote box 40. Once in this position, the retractable projections can be extended such that they engage with part of the tote box 40. Subsequently, when the extendable portion 657 of the movable member 656 is moved to the retracted position, it will lift the empty tote box 40 with it.

In FIG. 30C, the movable member 656 is shown in the first, picking position and the extendable portion 657 of the movable member 656 is shown in an extended position.

In this embodiment, the support frames 653 and 655 of the second lifting module 651 and the third automated device 652 respectively are integrally formed. The second lifting module 651 and the third automated device 652 together may be considered to be a single automated device.

The operation of this embodiment of return system 640 is now discussed with reference to FIGS. 30A-30G.

First, an operator can place stacks 644 of empty tote boxes 40 on the conveyor 642 at the return item input position 172 (see FIG. 30A). The stacks 644 of empty tote boxes 40 move along the conveyor 642 to one end at which is disposed the second lifting module 651. Optionally, a commercially available de-stacker (not shown) may be arranged between the return item input position 172 and the second lifting module 651.

Such a de-stacker may be arranged to receive stacks 644 of return items from the return item input position 172 and to output a plurality of individual return items. In such embodiments, the second lifting module 651 may, for example, receive return items from a de-stacker. In an alternative embodiment, if the empty totes are not provided in a stack (or if a destacker it provided to unstack them), second lifting module 651 may be replaced with a lift apparatus of similar to the lift apparatus 470 described above with reference to the system 400 shown in FIGS. 6A to 15.

As shown in FIG. 30B, the second lifting module 651 can be used to lift a stack 644 of empty tote boxes 40 (or individual empty tote boxes 40) until it is disposed below the third automated device 652. This is achieved by moving the platform 654 (which supports the stack 644 of empty tote boxes 40) upwards relative to the support frame 653 (i.e. in the z-direction).

The movable member 656 of the third automated device 651 is disposed in the first, picking position (see FIG. 30B). Whilst in this first, picking position, the extendable portion 657 of the movable member 656 is moved (relative to a portion of the movable member 656 that is connected to the support frame 655) from a retracted position to an extended position (see FIGS. 30B and 30C).

Once in the extended position, the extendable portion 657 of the movable member 656 is partially disposed in a top tote box 40 of the stack 644 of empty tote boxes (see FIG. 30C).

An engagement mechanism of the extendable portion 657 of the movable member 656 releasably engages the top tote box 40 of the stack 644 of empty tote boxes.

Subsequently, as shown in FIG. 30D, the extendable portion 657 of the movable member 656 is moved to the retracted position, lifting the top tote box 40 of the stack 644 of empty tote boxes with it.

Whilst still in the retracted position, the movable member 656 is moved relative to the support frame 655 between the first, picking position and a second, dropping position (see FIGS. 30D and 30E). When disposed in the second, dropping position (see FIG. 30E), the movable member 656 is disposed generally above the gravity fed roller conveyor 658.

Once in the second, dropping position, as shown in FIG. 30F, the extendable portion 657 of the movable member 656 is moved from the retracted position to an extended position, lowering the top tote box 40 of the stack 644 of empty tote boxes with it until it contacts (or is in close proximity to) the gravity fed roller conveyor 658.

Finally, the engagement mechanism of the extendable portion 657 of the movable member 656 releases the top tote box 40 of the stack 644 of empty tote boxes such that it is supported by the gravity fed roller conveyor 658. Subsequently, as shown in FIG. 30G, the extendable portion 657 of the movable member 656 is moved to the retracted position, leaving the top tote box 40 of the stack 644 of empty tote boxes supported by the gravity fed roller conveyor 658. Once the extendable portion 657 of the movable member 656 has moved to the retracted position the tote box 40 can fall under gravity along the roller conveyor 658 to the return location 660 (shown in FIGS. 17 and 18).

The control module 150 may be configured to control the second automated device 620 to move a plurality of return items 40 from a return location 660 to the mobile support unit 10 whilst the mobile support unit 10 is in the transferring position 612. The control module 150 may be configured to control the second automated device 620 so as to replace each item 40 that is moved to a storage position 122 with a return item 40 (for example an empty tote box) from a return position 660.

Once all of the items 40 on a mobile support unit 10 have been moved from the mobile support unit 10 to the main storage unit 120 (and have been replaced by empty items), the control module 150 is further configured to control the first automated device 610 to move the mobile support unit 10 from the transferring position 612 to one of the input locations 112. From there, the mobile support unit 10 (loaded with empty tote boxes 40) can be retrieved by an operator to perform a subsequent picking task.

In general, the mobile support unit(s) and the item(s) supported thereby may not form part of the system 600. However, it will be appreciated that parts of the system 600 may be configured for a particular type or size of mobile support units and/or items. In particular, the input locations 112, identification submodules 132, control system 150; first automated device 610 and the second automated device 620 may be configured for a particular type or size of mobile support units and/or items. In some embodiments, some parts of the system 600 may be adjustable to allow them to be adapted for different types or sizes of mobile support units and/or items. For example, the positions of the sensors 700 of the identification submodules 132 may be adjustable.

Once the items 40 have been stored in the main support unit 120, they can be accessed by a user or operator and transported to a delivery vehicle. The items may be accessed from an outlet side of each row of storage positions 122 of the two racking units 123, 124. The outlet sides of the rows of storage positions 122 are on a side of each of the two racking units 123, 124 that is distal the second positions 622 of the second automated device 620. These outlet sides of the two racking units 123, 124 may be referred to as pick faces.

In some embodiments, the removal of items from the pick face(s) is achieved using a novel multi-tote picker according to an embodiment of the present invention, as now discussed with reference to FIGS. 31A-31E.

Referring to FIGS. 31A-31E, the multi-tote picker 800 comprises a body supported by four wheels 810.

The body comprises a base 820 attached to the four wheels 810. The base 820 comprises three generally coplanar elongate members 822, 824, 826 that are arranged to form a square U-shaped base 820.

The body further comprises an end support 830 extending from a central elongate member 626 of the base 820. The end support 830 lies generally in a plane and extends generally perpendicular to the base 820. The end support 830 may be considered to form one upright side of the multi-tote picker 800.

The body further comprises a plurality of support protrusions extending from and generally perpendicular to the end support 830. In particular, the body comprises five sets of protrusions 840, 842, 844, 846, 848. The protrusions within each set of protrusions are at substantially the same distance from the base 820 and protrusions from different sets of protrusions are at different distances from the base 820.

Each set of protrusions 840, 842, 844, 846, 848 comprises two end protrusions 850, 852 and at least one central protrusion 854 disposed between the two end protrusions 850, 852. The central protrusion 854 comprises a recess for receipt of one of the wall structures 126 of the racking units 123, 124. The central protrusion 854 may, for example, comprise two separate protrusions spaced apart so as to define the recess for receipt of one of the wall structures 126 of the racking units 123, 124 therebetween.

The body of the multi-tote picker 800 is movable (in the z-direction) relative to the wheels 810. For example, the multi-tote picker 800 may be provided with a lifting mechanism operable to move the body of the multi-tote picker 800 away from the wheels 810. The multi-tote picker 800 may be movable between an insertion configuration and a lifting configuration. In the insertion configuration, the body may be disposed closer to the wheels 810 than it is when in the lifting configuration. The multi-tote picker 800 may be provided with an actuation mechanism to allow a user to actuate the lifting mechanism and so move the body of the multi-tote picker 800 relative to the wheels 810 (for example between the insertion configuration and the lifting configuration).

In use, the multi-tote picker 800 is initially disposed in the insertion configuration (or if not, an actuation mechanism is used to place the multi-tote picker 800 in the insertion configuration). The multi-tote picker 800 is moved (for example manually) until it is generally aligned with two adjacent volumes 127 defined between pairs of adjacent wall structures 126 of one of the racking units 123, 124. In particular, one of the end protrusions 850 and half of the central protrusion 854 from each set of protrusions 840, 842, 844, 846, 848 is aligned with a volume 127 defined by a pair of adjacent wall structures 126 of the racking unit 123, 124. Furthermore, the other end protrusion 852 and the other half of the central protrusion 854 from each set of protrusions 840, 842, 844, 846, 848 is aligned with an adjacent volume 127. This is shown in FIG. 31A.

The multi-tote picker 800 is then moved (for example manually) towards the racking unit 123, 124, as shown in FIG. 31B. In particular, the multi-tote picker 800 is moved such that the wall structure 126 between the two adjacent volumes 127 that the multi-tote picker 800 is aligned with and is received in the recess of the central protrusion 854 of each set of protrusions 840, 842, 844, 846, 848. Each of the end protrusions 850, 852 and each half of each of the central protrusions is received in a volume defined between a tote box 40 in a support position 122 and the uprights 128 of one of the wall structures 126. Each set of protrusions 840, 842, 844, 846, 848 is at a z-position that is below a rim of a tote box in a support position 122 and above a flange 129 supporting that tote box.

As shown in FIG. 31C, the body of the multi-tote picker 800 is then moved upwards relative to the wheels 810 so as to be disposed in the lifting configuration. This may be achieved using a lifting mechanism operable to move the body of the multi-tote picker 800 away from the wheels 810. In turn, this may be achieved using an actuation mechanism, for example by pressing a button 860 (see FIG. 31B).

As the multi-tote picker 800 is moved into the lifting configuration, each set of protrusions 840, 842, 844, 846, 848 moves upwards such that they each engage the rim of a tote box in a support position 122 and lift said tote box from a flange 129 that is supporting it.

As shown in FIG. 31D, while the multi-tote picker 800 is still disposed in the lifting configuration (supporting the tote boxes) the multi-tote picker 800 may be wheeled out from the racking unit 123, 124 to another location. For example, as shown in FIG. 31E, the multi-tote picker 800 may be wheeled such that it is adjacent a delivery vehicle 870. While the multi-tote picker 800 is adjacent a delivery vehicle 870 the tote boxes may be transferred to a racking unit 872 or the like within the delivery vehicle, for example by manually pushing each tot box onto an adjacent space within said racking unit 872.

In general, the system 600 may be provided with at least one multi-tote picker 800 of the type described above.

The above-described systems 100, 400, 600 are particularly advantageous for use in an online grocery shopping system, as now discussed.

Typically, an online grocery order may comprise a large number of different goods, which may be stored in different locations (for example different aisles of a grocery shop). To fulfil such grocery orders, all of the items in the order need to be collected, in general, from a range of different locations. Collecting goods from a range of different locations may be time consuming in that it takes time for an operator to travel to the different locations (such as different locations within a warehouse, or shop floor).

In order to improve the efficiency of the picking process a plurality of different grocery orders may each be divided into a plurality of different categories wherein the goods in each given category are stored in close proximity. For example, one category may be toiletries (which may all be stored in a single aisle of a shop) and another category may be tinned foods (which may all be stored in another aisle of the shop) and so on. One or more operators may each pick items from a single category for a plurality of different customers.

For example, an operator may collect a mobile support unit 10 supporting a plurality of (for example 8) empty tote boxes 40. Each tote box 40 may be provided with a label bearing an identification mark 42. This identification information may identify which order the tote box relates to, which box number this is in the order and so on. The operator may have access to a list of goods which should be placed in each tote box 40. Each of the empty tote boxes 40 supported by the mobile support unit 10 may relate to a different order (for example for a different customer). The operator can then collect goods and place them in the tote boxes 40. Once all of the goods for each box 40 have been collected, the operator can place the mobile support unit 10 in one of the input locations 112 of the input module 110.

Since the storage position 122 of each item is selected in dependence on the identification data 152 determined from that item, advantageously, the items can be sorted according to the identification data. For example, it may be desirable to group items in a plurality of different groups (each group may, for example, relate to a different customer and/or a different delivery van). For this purpose, the identification data 152 may include a group identifier and the storage position 122 of each item may be selected in dependence on the group identifier for that item. Items with the same group identifier may, for example, be placed in adjacent storage positions 122 in the main support unit 120.

Since the control module 150 is configured such that the storage position 122 of each item is selected such that the items are sorted or grouped according to the identification data 152 in dependence on the identification data determined from that item 40, all of the separate tote boxes 40 which belong to the same order can be grouped together.

In particular, in the embodiment of the system 600 shown in FIGS. 16 to 31E, the control module 150 is configured to control the first and second automated devices 610, 620 such that the items 40 are sorted or grouped in storage positions 122 adjacent an outlet of said storage positions 122. In this way, for example, a group of items 40 sharing common identification data may be positioned such that they can be transferred together to a transport vehicle, for example as described above with reference to FIGS. 31A to 31E.

As explained above, in some embodiments, a plurality of storage positions 122 are provided with a common inlet and outlet. For such embodiments, it will be appreciated that the control module 150 is operable to control the second automated device 620 to move each item 40 successively through the plurality of storage positions 122 until it is disposed in a desired storage position 122 adjacent to the outlet. It is this desired storage position 122 adjacent to the outlet that is determined in dependence on the identification data determined from that item 40.

The sorting and/or grouping of items by the systems 100, 400, 600 is in contrast to known automated storage and retrieval systems (ASRS) wherein each item may be stored in any suitable vacant storage position for later individual retrieval. Furthermore, the subsequent retrieval from an ASRS typically uses the same common access (i.e. no separate inlet and outlet are typically provided for the storage positions) and the same automated system as was used to store the item. In contrast, the systems 100, 400, 600 described above allow for items to be grouped together such that all items in a given group can be retrieved easily in a group (for example to be loaded onto the same delivery van).

Although two embodiments of systems 400, 600 of the form of the system 100 shown in FIG. 1 are described above, it will be appreciated that various other systems may also be embodiments of the system 100 shown in FIG. 1. For example, such other embodiments may use different components to those of the example systems 400, 600 described above.

It will be further appreciated that the first example system 400 is described with reference to FIGS. 6A to 15 may comprise any of the components described above with reference to the second example system 600 described with reference to FIGS. 16 to 31E. Similarly, it will be appreciated that the second example system 600 described with reference to FIGS. 16 to 31E may comprise any of the components described above with reference to the first example system 400 is described with reference to FIGS. 6A to 15. For example, the unpack apparatus 410 and/or pack apparatus 420 and/or the pack apparatus 420 of the system 400 shown in FIGS. 6A to 15 may comprise any of the features of the second automated device 620 of the system 600 shown in FIGS. 16 to 31E and vice versa.

In the first example system 400, described with reference to FIGS. 6A to 15, the main unit 120 comprises a racking system that is inclined and is generally of the form of a first in, first out (FIFO) racking system. In a modification, the main unit 120 may comprise a first portion (proximate the inlet side) that is, in use, generally horizontal and a second portion (proximate the outlet side) that is inclined and is generally of the form of a first in, first out (FIFO) racking system. For example, the first portion may be sized to accommodate one item (for example a tote 40). Furthermore, the pack apparatus 420 of the system 400 shown in FIGS. 6A to 15 may be provided with movable members similar to the moveable members 724 described above with reference to the second automated device 620 of the system 600 shown in FIGS. 16 to 31E. With such a modification, totes 40 can be temporarily stored in the first portion before being pushed into the second portion. Advantageously, this temporary storage may give more flexibility and may help in achieving a correct sequencing and ordering of the totes for extraction, for example by a delivery van driver. Furthermore, with such an arrangement, the functionality of the unpack apparatus 410 and/or the pack apparatus 420 of the system 400 shown in FIGS. 6A to 15 may be more similar to that of the second automated device 620 of the system 600, allowing for these submodules to be more interchangeable.

As explained above, some embodiments of the invention relate to the system 100 of FIG. 1 (and the associated method of FIG. 2), and their example embodiments described above. Some other embodiments of the invention relate to one or more components (either alone or in combination) of the system 100 of FIG. 1 (and the associated method of FIG. 2), and their example embodiments described above.

For example, another embodiment of the invention relates to an input location 112 of the system 400 shown in FIGS. 6A to 15. Optionally, this embodiment may further comprise an associated unpack apparatus 410 as described above. Optionally, this embodiment may further comprise an associated input buffer support unit 440 as described above. Optionally, this embodiment may further comprise an associated output return item buffer support unit 480 as described above.

For example, another embodiment of the invention relates to the main support unit 120 of the system 400 shown in FIGS. 6A to 15. Optionally, this embodiment may further comprise an associated pack apparatus 420 as described above. Optionally, this embodiment may further comprise an associated output buffer support unit 450 as described above.

For example, another embodiment of the invention relates to the second automated device 620 of the system 600 shown in FIGS. 16 to 31E.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

1. A system for receiving and sorting items, the system comprising:
an input module comprising at least one input location arranged to receive a mobile support unit supporting a plurality of items;
an identification module operable to determine identification data from each item supported by a mobile support unit received by the input module;
a main support unit comprising a plurality of storage positions, each of the plurality of storage positions being suitable for supporting an item;
automated apparatus operable to move an item supported by a mobile support unit received by the input module to one of the plurality of storage positions of the main support unit; and
a control module configured to receive the identification data from the identification module for a plurality of mobile support units received by the input module and to control the automated apparatus to move a plurality of items from each of the plurality of mobile support units received by the input module each to one of the plurality of storage positions of the main support unit;
wherein the control module is configured such that the storage position of each item is selected in dependence on the identification data determined from that item.

2. The system of claim 1 wherein the control module is configured such that the storage position of each item is selected such that the items are sorted or grouped according to the identification data in dependence on the identification data determined from that item.

3. The system of claim 1 wherein the plurality of storage positions comprises a plurality of different subsets of storage positions and wherein the control module is configured such that the subset of storage positions from which the storage position of each item is selected to be is selected in dependence on the identification data determined for that item.

4. The system of claim 1 wherein the identification data includes at least one group identifier and wherein the control module is configured such that the storage position of each item is selected in dependence on the group identifier determined from that item.

5. (canceled)

6. The system of claim 1 wherein the system comprises at least two levels, wherein the input module is provided on a first level and wherein the automated apparatus is operable to move an item supported by a mobile support unit received by the input module to one of the plurality of storage positions of the main support unit via a second level.

7. The system of claim 1 wherein each of the plurality of storage positions is provided with an inlet and a separate outlet and wherein the automated apparatus is operable to move an item to one of the plurality of storage positions of the main support unit via said inlet.

8. (canceled)

9. (canceled)

10. (canceled)

11. The system of claim 1 wherein the identification module comprises at least one identification submodule, the or each submodule comprising:
an imaging system operable to form an image of a visual marker on an item supported at an identification location; and
a processor operable to determine the identification data from said image.

12. The system of claim 1 wherein the input module comprises a plurality of input locations, each of the plurality of input locations being arranged to receive a mobile support unit supporting a plurality of items.

13. (canceled)

14. (canceled)

15. (canceled)

16. (canceled)

17. (canceled)

18. (canceled)

19. (canceled)

20. The system of claim 1 further comprising at least one buffer support unit comprising a plurality of buffer storage positions suitable for supporting an item and wherein the automated apparatus operable to move an item supported by a mobile support unit received by the input module to one of the plurality of storage positions of the main support unit via at least one of said plurality of buffer storage positions.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. The system of claim 1 wherein the automated apparatus comprises at least one unload apparatus operable to remove items supported by a mobile support unit received by the input module.

33. (canceled)

34. (canceled)

35. (canceled)

36. (canceled)

37. (canceled)

38. (canceled)

39. (canceled)

40. (canceled)

41. The system of claim 1 wherein the automated apparatus comprises at least one load apparatus operable to move items to the main support unit.

42. (canceled)

43. (canceled)

44. (canceled)

45. (canceled)

46. (canceled)

47. (canceled)

48. The system of claim 1 wherein the automated apparatus comprises at least one transport robot operable to remove items supported by a supply apparatus and to deliver said items to a receiver apparatus.

49. (canceled)

50. (canceled)

51. (canceled)

52. (canceled)

53. (canceled)

54. (canceled)

55. (canceled)

56. (canceled)

57. The system of claim 1, further comprising a return item input module arranged to receive at least one return item and wherein the automated apparatus is further operable to move a return item received by the return item input module to a mobile support unit received by the input module.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. A method for receiving and sorting items, the method comprising:
receiving a plurality of mobile support units, each supporting a plurality of items;
determining identification data from each item supported by each of the plurality of mobile support units;
determining an output storage position for each of the plurality of items from each of the plurality of mobile support units; and
using automated apparatus to move each of the plurality of items from each of the plurality of mobile support units to its determined output storage position;
wherein the determined output storage position of each item is selected in dependence on the identification data determined from that item.

71. The method of claim 70 wherein the output storage position of each item is selected such that the items are sorted or grouped according to the identification data in dependence on the identification data determined from that item.

72. The method of claim 70 wherein the plurality of output storage positions comprises a plurality of different subsets of output storage positions and wherein the subset of output storage positions from which the determined output storage position for each of the plurality of items from each of the plurality of mobile support units is selected, is selected in dependence on the identification data determined for that item.

73. The method of claim 70 wherein the identification data includes at least one group identifier and wherein the output storage position of each item is selected in dependence on the group identifier determined from that item.

74. (canceled)

75. The method of claim 70 wherein determining identification data from each item supported by each of the plurality of mobile support units comprises:
determining a unique identifier from each item; and
determining the identification data for each item from lookup data using the unique identifier determined from it.

76. (canceled)

77. The method of claim 70 wherein using automated apparatus to move each of the plurality of items from each of the plurality of mobile support units to its determined output storage position comprises:
moving at least some of the items from a mobile support unit to at least one intermediate storage position; and
subsequently moving those items from their at least one intermediate storage position to their output storage positions.

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. An automated apparatus comprising at least one load apparatus operable to move items to a main support unit.

113. (canceled)

114. (canceled)

115. (canceled)

116. (canceled)

117. (canceled)

118. (canceled)
